(19) United States
(12) Patent Application Publication
(10) Pub. No.: US 2011/0282476 A1
(43) Pub. Date: Nov. 17, 2011

(54) SYSTEMS AND METHODS OF ON DEMAND MANUFACTURING OF CUSTOMIZED PRODUCTS

(75) Inventors: Darrin G. Hegemier, San Diego, CA (US); Darryl R. Kuhn, San Diego, CA (US); David M. Peace, San Diego, CA (US); Frank M. Tyneski, San Diego, CA (US)

(73) Assignee: SKINIT, INC., San Diego, CA (US)

(21) Appl. No.: 13/103,997

(22) Filed: May 9, 2011

Related U.S. Application Data
(60) Provisional application No. 61/332,745, filed on May 7, 2010.
(60) Provisional application No. 61/448,074, filed on Mar. 1, 2011.

(51) Int. Cl. G06F 19/00; G06Q 30/00

(52) U.S. Cl. 700/100; 705/26.5

(57) ABSTRACT

Systems and methods are described herein relating to managing an on-demand manufacturing supply chain personalization process. In some embodiments, the management system and method is described in order to manufacturing customized products according to image and customization data with images applied to parts using a post mold image application process. In other embodiments, customized products are defined by electronic orders that specify product manufacturing data including imagery to be applied to the products. In other embodiments, manufacturing methods are described in which an original equipment manufacturer (OEM) or an original design manufacturer (ODM) leverages use of an on demand customizing entity in the manufacturing supply chain. In other embodiments, customized products are described in which imagery spans across multiple components of the products. In other embodiments, re-usable tracking devices and scheduling processes based on filtered options are additionally described. Some embodiments combine one of more of these mentioned embodiments.

This application claims the benefit of U.S. Provisional Application No. 61/332,745, filed May 7, 2010 and claims the benefit of U.S. Provisional Application No. 61/448,074, filed Mar. 1, 2011, both of which are incorporated herein by reference.

### BACKGROUND OF THE INVENTION

1. Field of the Invention

The present invention relates generally to the manufacturing of products, and more specifically to the manufacturing of customized products.

2. Discussion of the Related Art

There is a growing interest in ways to customize or personalize consumer products that are normally similar in appearance to give the product an appearance that is more unique to the user or consumer. Removable adhesive backed stickers can be printed with a custom design and adhered to a consumer product to give it a more personal appearance. Another solution is to manufacture consumer products to include a unique appearance. However, according to known supply chain manufacturing processes, companies seeking to manufacture custom products are forced to manufacture products according to forecasts. That is, due to the lead times required to produce products having a unique appearance, companies must manufacture products according to a forecast of what custom appearance will be likely to be commercially relevant six to nine months or more in the future. This makes it difficult to manufacture custom appearance products that will be commercially relevant in the future without bearing the risk of carrying custom inventory for which there is no demand.

### SUMMARY OF THE INVENTION

A system and corresponding automated method for managing an on-demand manufacturing supply chain personalization process is provided, the system comprising: a computer system having one or more processors and one or more memory devices including executable program code configured to be executed by the one or more processors, wherein upon execution by the one or more processors, the executable program code being configured to: receive an electronic order for one or more customized parts configured to be at least a part of one or more customized products, the electronic order including image and customization data specifying imagery to be applied to one or more blank parts to create the one or more customized parts; verify availability of enough blank parts in inventory to satisfy the electronic order; determine that the electronic order can be completed; schedule a post mold image application process with one or more image application devices available for use, the image application devices comprising at least one post mold decoration direct to surface printing device; provide an image file to the at least one post mold direct to surface printing device, the image file defining at least a portion of the imagery to be applied to the one or more blank parts; receive an indication that the imagery has been applied to the one or more blank parts resulting in the one or more customized parts; and receive input indicating that the one or more customized parts meet an inspection quality standard.

In another embodiment, a method of manufacturing products comprises: receiving, at an original design manufacturer (ODM), an electronic order from an original equipment manufacturer (OEM) for one or more customized products forecast to have commercial demand, the customized products having imagery applied thereto to create a custom appearance of the customized products, wherein the ODM assembles the customized products for the OEM; receiving, at an on demand customizer (ODC), the electronic order; maintaining at the ODC an inventory of blank parts received by direction of the ODM; applying the imagery to one or more blank parts using a post mold image application process to create one or more customized parts, the one or more customized parts configured to be at least a part of the one or more customized products; delivering the one or more customized parts to the ODM; assembling, by the ODM, the one or more customized products from the one or more customized parts; and delivering the one or more customized products to fulfill the electronic order.

In another embodiment, a customized product comprises: a first component having a first image layer applied to a surface of the first component, the first image layer comprising a first image; and a second component having a second image layer applied to a surface of the second component, the second image layer comprising a second image; wherein the first component and the second component are separate physical components that are in a fixed relationship with respect to each other when assembled into the customized product; and wherein the first image and the second image cooperate to form a third image, the third image spanning across at least a portion of the first component and the second component.

In another embodiment, a method for use during manufacturing comprises: applying a first optically readable code to a first part to be tracked through a plurality of manufacturing processes in a manufacturing facility, the first optically readable code representing a first unique identifier stored in a database; non-permanently affixing a non-optically readable tracking device to the first part; associating the non-optically readable tracking device with the first unique identifier; reading the non-optically readable tracking device at each of a plurality of locations in the manufacturing facility in order to track the first part as it progresses through the plurality of manufacturing processes; removing the non-optically readable tracking device from the first part; and reusing the non-optically readable tracking device by non-permanently affixing the non-optically readable tracking device to a second part to be tracked through the plurality of manufacturing processes in the manufacturing facility.

In another embodiment, a part assembly to be tracked through a plurality of manufacturing processes in a manufacturing facility, the part assembly comprising: a part to which the plurality of manufacturing processes will be performed; an optically readable code affixed to a portion of the part, the optically readable code representing a unique identifier stored in a database; and a non-optically readable tracking device non-permanently affixed to another portion of the part, wherein the unique identifier is written to the non-optically readable tracking device such that when non-optically read, the non-optically readable tracking device provides the unique identifier, wherein the non-optically readable tracking device is configured to be removal from the part when the plurality of manufacturing processes are completed.

In another embodiment, a system and corresponding automated method for managing manufacturing of customized products are provided, the system comprising: a computer system having one or more processors and one or more memory devices including executable program code configured to be executed by the one or more processors, wherein upon execution by the one or more processors, the executable program code being configured to: receive one or more orders for customized parts to be manufactured from blank parts through execution of a plurality of manufacturing processes, wherein each order identifies one or more customized parts each having a plurality of customization options to result from execution of one or more of the plurality of manufacturing processes; and for each respective manufacturing process, the executable program code is configured to: determine which of the customization options have been previously executed for a given part; determine one or more filtered customization options available at the respective manufacturing process for the given part based on the customization options having been previously executed by one or more prior manufacturing processes and based on customization options corresponding to the one or more orders that have not yet been executed; receive a selection of a filtered customization option to be executed by the respective manufacturing process from the worker; receive an indication that the respective manufacturing process has been executed for the given part; and use a set of criteria to provide a list of next locations to which the given part may be sent.

In another embodiment, a system and corresponding automated method for managing an on-demand manufacturing supply chain personalization process are provided, and system comprising: a computer system having one or more processors and one or more memory devices including executable program code configured to be executed by the one or more processors, wherein upon execution by the one or more processors, the executable program code being configured to: receive an electronic order for one or more customized products, the electronic order including product manufacturing data that defines elements combined to fabricate a product and including imagery to be applied to at least a portion of the product to create the one or more customized products; verify availability of raw materials needed to manufacture the one or more customized products in inventory to satisfy the electronic order; determine that the electronic order can be completed; schedule one or more manufacturing processes in accordance with the product manufacturing data, wherein one or more manufacturing processes includes an image application process configured to apply at least a portion of the imagery to at least one prefabricated component of the customized product; provide an image file to at least one image application device configured to implement the image application process, the image file defining at least a portion of the imagery to be applied to the at least one prefabricated part; receive an indication that the imagery has been applied to the at least one prefabricated part; and receive input indicating that the at least one prefabricated part meets an inspection quality standard.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is an illustration of an in box model of an on-demand personalization process in accordance with one embodiment of the invention.

FIG. 2 is an illustration of an out of box model of an on-demand personalization process in accordance with another embodiment of the invention.

FIG. 3 is a diagram illustrating various entities and the flow of orders and parts in one embodiment of an in box model for on-demand personalization in accordance with several embodiments.

FIG. 4 is a flowchart providing the steps involved for an in box model of an on-demand personalization process in accordance with one embodiment.

FIG. 5 is a flowchart providing steps involved for an in box model for an on-demand personalization process from the perspective of an on-demand customizer in accordance with several embodiments.

FIG. 6A is a diagram illustrating various entities involved in an on-demand personalization process and their relationship to a management platform of an on-demand customizer in accordance with several embodiments.

FIG. 6B is another diagram illustrating various entities involved in an on-demand personalization process and their relationship to a management platform of an on-demand customizer in accordance with several embodiments.

FIG. 6C is a further diagram illustrating various entities involved in an on-demand personalization process and their relationship to a management platform of an on-demand customizer in accordance with several embodiments.

FIG. 7 is a flowchart providing the steps involved in an on-demand personalization process as performed by the on-demand management platform of the on-demand customizer in accordance with several embodiments.

FIG. 8 is a flowchart illustrating the steps performed by the end customer in an on-demand personalization process in accordance with several embodiments.

FIG. 9 is a flowchart illustrating the steps performed by the original design manufacturer (ODM) in an on-demand personalization process in accordance with several embodiments.

FIG. 10 is an illustration showing the selection of image application devices and their location relative to original design manufacturers in accordance with several embodiments.

FIG. 11 is an exemplary physical and functional layout diagram of an image application facility for use with an in box on-demand personalization or customization process in accordance with several embodiments.

FIG. 12 is a flowchart illustrating one embodiment of the steps involved in a part receiving process, such as performed within the image application facility of FIG. 11.

FIG. 13 is a flowchart illustrating one embodiment of the steps involved in an order entry process, such as performed within the image application facility of FIG. 11.

FIG. 14 is a flowchart illustrating one embodiment of the steps involved in a batch production schedule process, such as performed within the image application facility of FIG. 11.

FIG. 15 is a flowchart illustrating one embodiment of the steps involved in an inventory or work in progress dispatch process, such as performed within the image application facility of FIG. 11.

FIG. 16 is a flowchart illustrating one embodiment of the steps involved in a base paint process, such as performed within the image application facility of FIG. 11.

FIG. 17 is a flowchart illustrating one embodiment of the steps involved in a direct surface print process, such as performed within the image application facility of FIG. 11.

FIG. 18 is a flowchart illustrating one embodiment of the steps involved in a finish coat process, such as performed within the image application facility of FIG. 11.

FIG. 19 is a flowchart illustrating one embodiment of the steps involved in a color inspection process, such as performed within the image application facility of FIG. 11.

FIGS. 20 and 21 are flowcharts illustrating one embodiment of the steps involved in a packout process, such as performed within the image application facility of FIG. 11.

FIG. 22 is a flowchart illustrating one embodiment of the steps involved in a delivery process, such as performed within the image application facility of FIG. 11.

FIG. 23 is a flowchart illustrating one embodiment of the steps involved in a raster image processor workflow process, such as performed within the image application facility of FIG. 11.

FIG. 24 is a diagram illustrating various layers of an image specification file that may be received with an order for customized parts in accordance with one embodiment.

FIG. 25 is a flowchart illustrating one embodiment of the steps involved in uploading a design or image for application to blank parts in accordance with one embodiment.

FIG. 26 is a flowchart illustrating one embodiment of the steps performed in enrolling a device to be personalized and customized in accordance with one embodiment.

FIG. 27 is a diagram illustrating various selectable features that may be specified by an end-user when placing an order for customized parts in accordance with one embodiment.

FIG. 28 is an illustration of a layering diagram of imagery applied to a substrate in accordance with several embodiments.

FIG. 29 is an illustration of a layering diagram of imagery applied to a second surface of a substrate in accordance with several embodiments.

FIG. 30 is an illustration of image layers separately configurable to define an image to be applied on-demand to a keyboard for a computer device in accordance with one embodiment.

FIG. 31 is an exemplary notebook style computer including a keyboard customized with an image comprising color, text and including a photograph in accordance with one embodiment.

FIG. 32 is an exemplary notebook style computer including a keyboard customized with an image comprising color, text and including design artwork in accordance with another embodiment.

FIG. 33 is an exemplary notebook style computer including a keyboard customized with an image comprising color, text and including patterned design artwork in accordance with another embodiment.

FIG. 34 is an illustration providing customization options for a key layer of an image to be applied to a keyboard of a notebook style computer in accordance with one embodiment.

FIGS. 35-39 are exemplary notebook style computers including an “A cover” customized with an image comprising one or more of color, text and design artwork in accordance with several embodiments.

FIG. 40 is an exemplary notebook style computer case including a bottom shell and a top shell customized with imagery in accordance with another embodiment.

FIG. 41 is an exemplary mobile phone in which a portion of its housing is customized with imagery in accordance with another embodiment.

FIG. 42 is an exemplary mobile phone in which a battery cover is customized with imagery in accordance with another embodiment.

FIG. 43 is an exemplary case for a notebook style computer, a portion of the case being customized with imagery in accordance with another embodiment.

FIG. 44 is an exemplary chair in which a fabric portion is customized with imagery in accordance with another embodiment.

FIG. 45 is an exemplary washing machine appliance including a front panel which is customized with imagery in accordance with another embodiment.

FIG. 46 is an exemplary automobile in which one or more body panels are customized with imagery in accordance with another embodiment.

FIG. 47 is a diagram illustrating an example computing system in which various embodiments may be implemented.

FIG. 48 is an exemplary notebook style computer including a keyboard and surrounding tray portion customized with an image comprising color and including design artwork in accordance with another embodiment.

FIG. 49 is another exemplary physical and functional layout diagram of an image application facility for use with an in box on-demand personalization or other customization process in accordance with several embodiments.

FIG. 50 is a flowchart illustrating one embodiment of the steps involved in a part receiving process, such as performed within the image application facility of FIG. 49.

FIG. 51 is a flowchart illustrating one embodiment of the steps involved in an incoming quality control process, such as performed within the image application facility of FIG. 49.

FIG. 52 is a flowchart illustrating one embodiment of the steps involved in a material review board (MRB) process, such as performed within the image application facility of FIG. 49.

FIG. 53 is a flowchart illustrating one embodiment of the steps involved in a warehouse process, such as performed within the image application facility of FIG. 49.

FIG. 54 is a flowchart illustrating one embodiment of the steps involved in a job start process, such as performed within the image application facility of FIG. 49.

FIG. 55 is a flowchart illustrating one embodiment of the steps involved in a consume raw material process, such as performed within the image application facility of FIG. 49.

FIG. 56 is a flowchart illustrating one embodiment of the steps involved in a basecoat loading process, such as performed within the image application facility of FIG. 49.

FIG. 57 is a flowchart illustrating one embodiment of the steps involved in a basecoat unloading process, such as performed within the image application facility of FIG. 49.

FIG. 58 is a flowchart illustrating one embodiment of the steps involved in racking and inspection processes, such as performed within the image application facility of FIG. 49.

FIG. 59 is a flowchart illustrating one embodiment of the steps involved in a direct surface print process, such as performed within the image application facility of FIG. 49.

FIG. 60 is a flowchart illustrating one embodiment of the steps involved in a finish coat process, such as performed within the image application facility of FIG. 49.

FIG. 61 is a flowchart illustrating one embodiment of the steps involved in secondary operations and keyboard testing processes, such as performed within the image application facility of FIG. 49.

FIG. 62 is a flowchart illustrating one embodiment of the steps involved in a final inspection process, such as performed within the image application facility of FIG. 49.

FIG. 63 is a flowchart illustrating one embodiment of the steps involved in a packout process, such as performed within the image application facility of FIG. 49.

FIG. 64 is a flowchart illustrating one embodiment of the steps involved in a shipping preparation process, such as performed within the image application facility of FIG. 49.

FIG. 65 is a flowchart illustrating one embodiment of the steps involved in a delivery process, such as performed within the image application facility of FIG. 49.

FIGS. 66 and 67 are diagrams illustrating methods of managing the manufacturing of customized products using dynamic flow filtering in accordance with some embodiments.

FIG. 68 is a flowchart illustrating one embodiment of the steps involved in managing the manufacturing of customized products using dynamic flow filtering such as that illustrated in FIGS. 66 and 67.

FIGS. 69 and 70 illustrate embodiments of methods of tracking parts within one or more manufacturing facilities, such as may be performed within the exemplary image application facility of FIG. 49.

FIG. 71 is one embodiment of a part having an optically readable identifier and a removably and non-permanently affixed non-optically readable tracking device, such as a radio frequency identification (RFID) device, in accordance with some embodiments.

FIG. 72A is one embodiment of a mechanism to removably and non-permanently affix a non-optically readable tracking device to a part.

FIG. 72B is another embodiment of a mechanism to removably and non-permanently affix a non-optically readable tracking device to a part.

FIG. 73 is a flowchart illustrating the steps performed in managing an on-demand manufacturing supply chain personalization process in accordance with some embodiments.

FIG. 74 is another flowchart illustrating the steps performed in managing an on-demand manufacturing supply chain personalization process in accordance with some embodiments.

FIG. 75 is a side view of the layers and image cooperation between different components of a customized product in accordance with several embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Several embodiments provide methods and systems for providing for customization or personalization of a product or device. In some embodiments, the methods and systems provide this personalization or customization in an on-demand manner such that devices can be customized as needed for the intended purpose without the need to forecast and carry inventory anticipating demand for the specific customization. Accordingly, in several embodiments, an end customer can select and customize imagery to be applied to a device/product or an accessory to the device/product in order to personalize or customize the device/product for the purposes and preferences of the end customer. In some embodiments, images may be selected from available images and designs, licensed artwork (e.g., Disney, NFL, artwork, etc.), or uploaded by users from user computers or computing devices, smart phones or uploaded from other image services, websites, social media sites and players, etc. In some embodiments, the end customer may be one or more of an individual, an organization, an agency, a company, a retailer, a distributor, an original equipment manufacturer (OEM), an original design manufacturer (ODM). The device or the accessory of the device may be for the use of the end customer or other purpose, such as for distribution or commercial sale. The imagery to be applied for customization may take a variety of forms. For example, in some embodiments, the imagery includes one or more of the following components: color elements, text, size and font elements, language and regional options, photographic elements, graphic images and designs, artwork elements, transparency, identification elements such as asset tags and readable codes, logo elements, material choice elements, and coating and surface treatments. The devices to be customized can be any physical object, preferably an object that may be commercially purchased by consumers. Devices, portions of devices, accessories for devices and/or their surfaces whether plastic, metal, glass, ceramic, fabric or other material that may be customized include, but are not limited to: consumer electronic devices (mobile handsets, notebook computers, netbook computers, keyboards, tablets, touch screen computing devices, servers, digital music players, etc.) and accessories, electronic and non-electronic medical devices, household products (kitchen appliances, switch plates, tile, ceramics, etc.), tools (cordless drills, saws, tool boxes, etc.), health and beauty products (containers, makeup cases, compacts, hair dryers, curling irons, etc.), automobiles, parts and accessories, jewelry, media cases, sporting equipment, fishing equipment and lures, luggage, apparel, street signage, advertising and bill boards, and furnishings. In some embodiments, such devices are relatively non-unique in appearance relative to other commercially available devices from the same and other manufacturers. For example, in the case of consumer electronics devices, such as netbook computers, most products are relatively comparable in the technical ability of the computer within certain product price ranges. That is, there is little from the functional feature set of the product to distinguish one manufacturer's products from another. Additionally, there is a growing trend and desire for consumers to want to personalize purchased products to “make them their own”. Thus, for manufacturers and retailers, products are differentiated by the degree of personalization that a customer has in the design of the product or in the post purchase decoration of the product, and these entities will have a commercial advantage. Methods and systems according to several embodiments allow customers to apply imagery to the product/device, a portion of the product/device and/or an accessory to the product/device to achieve customization or personalization. Due to the on-demand nature of several embodiments, customization can be offered to take advantage of current trends or events with the need to forecast the consumer popularity of the trend or event with the normal manufacturing design cycle. In some embodiments, the devices, parts thereof or accessories therefor may be customized for use by consumers, retailers, distributors and other commercial and non-commercial entities, and/or governmental entities such as local, regional and/or national entities.

In different embodiments, customized imagery may be applied in a variety of ways. For example, imagery may be applied or printed to a pressure sensitive film (e.g., a skin) or an adhesive material to be applied to the product, a portion of the product or to an accessory. For example, this adhesive material is printed with the desired imagery and then permanently or removably applied to the product. In one example, the material is applied to a cellular telephone or to the lid or cover of a notebook computer, or to a portion of the product, such as a battery door of the cellular telephone, and/or to an accessory such as a hard case or shell for the cellular telephone or a snap on lid cover and/or base for a notebook computer. In other embodiments, the imagery is directly painted, printed, transferred or etched on a surface of the product, portion of the product and/or an accessory of the product. Depending on the embodiment, the image is solvent or UV painted, thermal or solvent printed, laser printed, UV inkjet printed, transferred via dye sublimation via a transfer media, pad printed or silk screened directly to a surface of product, a portion of the product or an accessory for the product. In some embodiments, surface treatments are optionally applied, such as chemical film treatments or other treatments to modify the surface energy to promote good adhesion between adjacent layers. Example surface treatments to modify surface energy, e.g., to alter or raise dyne levels to ensure good adhesion between paint and/or print layers, include plasma treatment (atmospheric and flame plasma treatments), corona treatment, and chemical plasma treatments. Direct to substrate printing may be accomplished using post mold decoration or in mold decoration techniques. In on-demand embodiments, post mold decoration is preferred due to shorter lead times in the printing process. For example, in-mold decoration films are well suited for producing large quantities of a single design on a part, such that changing a design to be printed requires additional tooling and set up charges with subsequent down time. Thus, in mold decoration often requires forecast volumes in advance. Thus, in some embodiments using post mold decoration, an infinite number of different images and designs or customization options can be printed next to one another and in succession (even on the same image application device) without tear down, set-up or additional tooling.

In embodiments which employ customization in an on-demand manner, manufacturers can quickly manufacture and make available for commercial sale small special edition or limited edition runs of products to take advantage of current events and interests, promotions and advertising for upcoming events and interests, etc. This allows the manufacturer to adapt to a shape shifting marketplace. Since limited numbers of products can be produced, there is less risk of carrying excess inventory of commercially undesirable products.

In several embodiments, an on-demand software management platform is provided that manages the customization process. In some embodiments, the management platform is installed and executed on computing devices of a particular company, or may be stored and executed on servers in an ASP model (i.e., a peer-to-peer hosted solution) providing network access to remote users to interact with the management system. In some embodiments, the management platform generally performs at least one or more of the following functions: provide an interactive image selection and customization tool for customers to upload and/or select then customize imagery for use in customization of one or more products or devices; store and maintain a library of licensed and pre-formatted or pre-approved imagery and selection options; provide an image selection file format to end customers that allows for easy editing and selection of image options; receiving and evaluating purchase orders from a variety of customer types for customized products, parts, accessories, adhesive materials, etc.; scheduling and monitoring in real-time the image application process coordinating a variety of application devices (such as painters, printers, coaters, curing devices, layer applicators, and so on) in order to meet the on-demand nature of customer orders; monitoring and directing inventory and part flow through the image application facility; and coordinating with enterprise resource planning systems of other entities in a manufacturing supply chain.

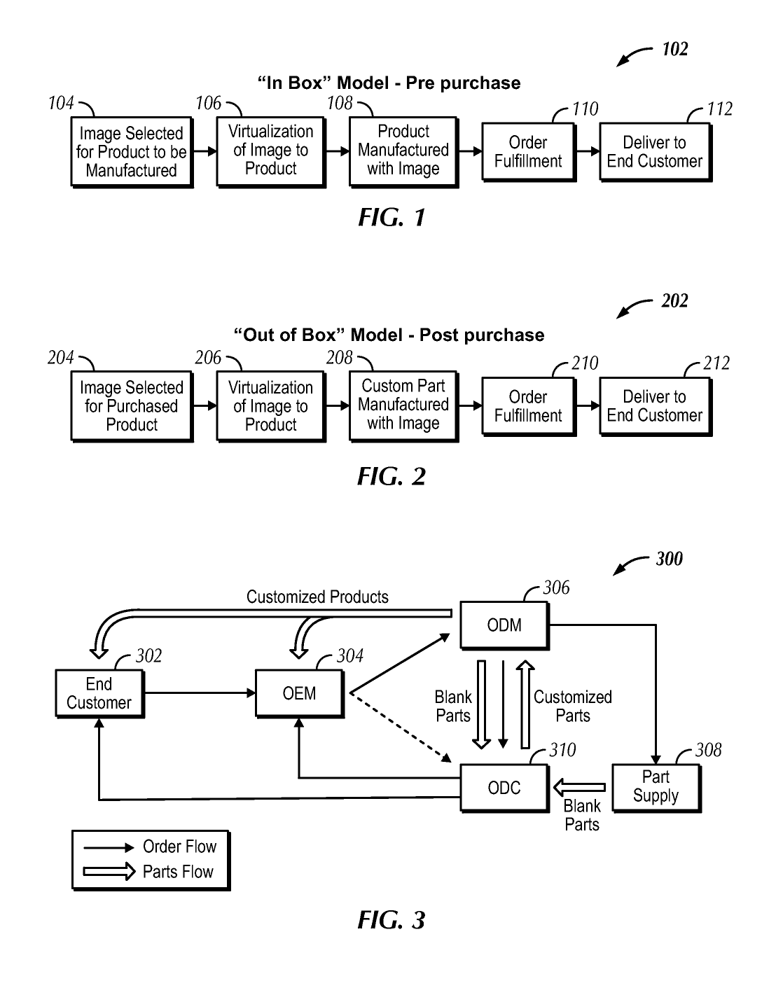

Referring first to FIG. 1, an illustration is shown of an “in box” model 102 of an on-demand personalization process in accordance with one embodiment of the invention. According to the in box model, customization of the product or device, portion thereof and/or accessory therefor occurs prior to the customer's purchase, e.g., during manufacturing, and in some embodiments, provides a manufacturing supply chain solution. Thus, the in box model is also referred to as the pre-purchase model. According to this model, an image/s (imagery) is selected for a particular device or product to be manufactured, portion thereof and/or accessory therefor (Step 104). Since the imagery can be highly customized and selectable in some embodiments, the image or imagery can also be referred to as variable image data. When referring to image or images as used herein, the image may include one or more of color, text, font, photographic, artwork, patterns, language and regional options, identification elements such as asset tags and readable codes, logo elements, material choice elements, and coating and surface treatments. The image is then virtualized to the device (Step 106). For example, an interactive graphical user interface is provided (e.g., delivered to the user via a computer network) that allows one to visualize the device with the image applied thereto. Once the image and parameters are set for the proper virtualization, the product, portion thereof and/or accessory therefor is then manufactured with the image applied thereto according at least to any of the techniques described herein (Step 108). Again, the image may be applied to the product, a portion of the product or an accessory or attachment to the product. Further, the image may take the form of direct surface paint/print or a pressure sensitive film applied to the product, a portion thereof or an accessory to the product. Next, the order for the customized product/device is fulfilled (Step 110). For example, the custom product, component or accessory is completed and verified to comply with the image customization as ordered. Then, the customized or personalized product is delivered to the end customer (Step 112).

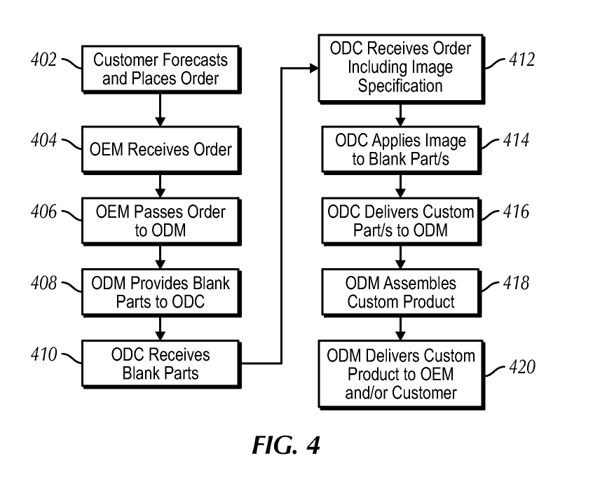

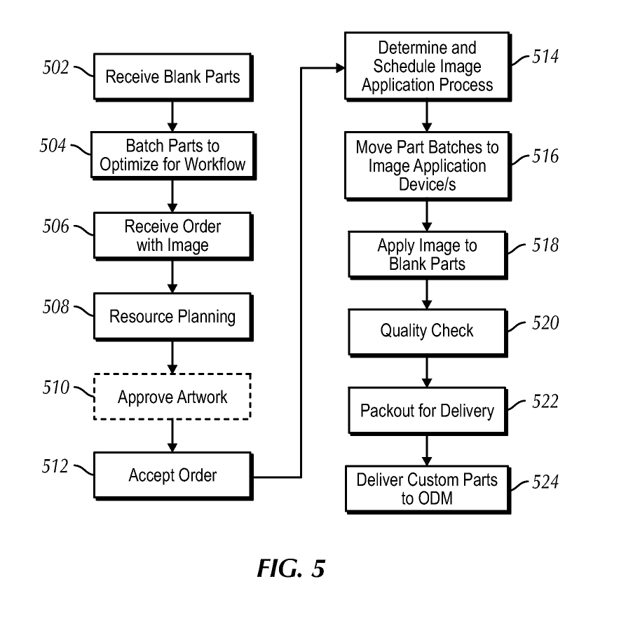

In some embodiments, the end customer is one or more of a retailer, a distributor, an OEM, an ODM, an individual consumer, etc. For example, the in box model may be applicable is several portions of the manufacturing supply chain. In one embodiment, the process occurs within the OEM-ODM manufacturing supply chain. For example, the OEM is asked to produce a customized product for a retailer, where the OEM uses the ODM to manufacture and assemble the customized product. In some embodiments, the ODM works together with another manufacturing entity referred to herein as an on demand customizer (ODC) to produce the customized product or device. One embodiment of a diagram and associated process is illustrated in FIGS. 3 and 4, for example. In some embodiments, the ODM internally includes the ODC functionality. Furthermore, the in box model may apply in an OEM distribution supply chain where customized products produced by ODM are distributed to their final destination using an OEM distribution supply chain or a third party distribution supply chain.

When done in an-demand manner, in some embodiments, customers such as retailers and OEMs can more quickly order and bring to market products that are personalized without the need to forecast demand for a given personalization several months into the future. That is, in some embodiments, the in box model may be used to produce custom products in a matter of days as opposed to months. This enables a retailer or OEM to manufacture and sell custom products corresponding to special runs or limited-edition designs at a time when this personalization is currently predicted to be marketable. In some cases, there is less risk associated with forecasting errors due to reduction in the time needed to create customized or personalized products. Thus, in some embodiments, “the order is the forecast” or there is no forecast for finished goods, turning the typical supply chain upside down. It is noted that in some embodiments, some forecasting may be needed to determine raw material requirements (e.g., to determine if there is availability of paint, ink, fixtures, image application device capacity), although forecasting is not needed for customized designs of products if raw materials are available. Conventional materials requirements planning (MRP) wisdom states that committing resources early leads to waste when plans change. However, in some embodiments, no resources are committed until an order is placed. This allows a party to mitigate any negative effects of plan changes. Thus, some embodiments reduce the cost of finished good forecast-to-order changes to practically zero. In contrast, longer lead times are required in a conventional approach such that the decoration process will begin well in advance to meet the deliverable dates. Such conventional approaches are susceptible to a high cost of plan changes and are slower to react to current market trends and events. Further, since customized products can be produced quickly based on current demand, in some cases the retailer or OEM carries less risk of carrying unwanted inventory. This is because products can be made in a turnaround time of days as opposed to months to reflect current demand. In this way, the retailer, distributor or OEM can react more quickly to an ever-changing market place and take advantage of current trends and customer interests. By way of example, the recently released movie Avatar from Twentieth Century Fox Film Corporation was a tremendous commercial success. In a traditional process, during the height of the movie's success, a retailer would have to forecast that there would be a continued consumer interest in commercial products customized with one or more of colors, artwork, symbols, and/or design elements specific to the movie. Such forecasts may appear accurate at the time made, but in today's shifting marketplace, this forecast may no longer be accurate in the 3 to 4 months in which the traditional design cycle would normally be complete for products made by an OEM. In contrast, in some embodiments of the in box model, OEMs and ODMs can function together with an on demand customizer ODC to reduce lead times to matter of days. In one embodiment, an ODC provides customized components or parts to be assembled or adhered to or affixed to an otherwise generic product to create personalized customized product. In many cases, the turn around for the ODC to produce customized products is only limited by the process and capacity. For example, in cases such as those described herein for example, an ODC can customize pre-manufactured parts within 24 hours for delivery to an ODM for final assembly, and in other cases within 15 hours, within 10 hours, or other time period. In some embodiments, at least some of the ordered customized parts may be ready for delivery within 6-10 hours of receipt of the order. By way of example, upon direction from an OEM, the ODC can customize pre-manufactured blank (un-customized) keyboards or keypads, “A covers”, etc. for notebook or notebook computers to include color, language, imagery and/or designs to reflect the movie Avatar. These customized parts are then delivered (e.g., to the ODM) for assembly into a final and customized product delivered to an OEM and/or retailer. In this way, customized products may be available for sale while the consumer interest in a particular design or customization is known to be high as opposed to forecasted to be high. That is, customized products can be produced to take advantage of current events. Conceivably, a Vivian Tam fashion show may occur one week and the following week, retailers are able to offer a limited run, special edition of Vivian Tam customized products, such as notebook or network computers, personalized with designs reflecting the Vivian Tam fashion show and/or Vivian Tam designs.

In the case of notebook and network computers, margins are very low and it is therefore important to properly forecast the need for specific color and regional languages needed in keyboard components. Color and keyboard language/regionalization are traditionally very difficult to forecast several months ahead of time. In some embodiments, the in box model is used to manufacture parts for such devices and in an on-demand manner. In an example of keyboard language and regionalization, an OEM or an ODM is not required to carry an inventory of keyboards in different languages. The in box model is used on-demand apply the appropriate color and/or language to keypads as orders from different regions are received from retailers. While keypads and keyboards are specifically discussed by way of this example, it is understood that other parts or portions of devices, products, portions thereof, and/or accessories for products or devices may be customized in on-demand manner in order to provide customized personalized products in days as opposed to months.

Referring next to FIG. 2, an illustration is shown of “out of box” model 202 of an on-demand personalization process in accordance with another embodiment of the invention. Thus, the out of box model is also referred to as the post-purchase model. According to the out of box model, customization of the product or device occurs at the point-of-sale or after the customer's initial purchase. According to this model, the customer selects an image or imagery for a purchased (or to be purchased) product or device (Step 204). The selected imagery may include one or more of color, text, font, photographic, artwork and material choice elements, and other options described herein. The image is then virtualized to the product (Step 206). For example, an interactive graphical user interface, such as a web-based interface, is provided that allows one to visualize the product with the image applied thereto. Once the image and parameters are set for the proper virtualization, a custom component or accessory is manufactured with the imagery applied thereto according at least to any of the techniques described herein (Step 208). Again, the image may be applied to the product, a portion of the product or an accessory or attachment (for example, a shell) to the product. Further, the image may take the form of a pressure sensitive film or material applied to the product, a portion thereof or an accessory to the product. Alternatively, the image may be directly painted/printed to a surface of a portion of the product or accessory for the product, e.g., a lid cover for a netbook computer, a battery door or shell for a cellular telephone. Next, the order for the customized component is fulfilled (Step 210). For example, the custom part or accessory is completed and verified to comply with the image customization as ordered. Then, the customized or personalized component is delivered to the end customer (Step 212).

The out of box model 202 may be applicable in several business applications. In one embodiment, the process occurs within a web portal or website allowing individual consumers to purchase customized components such as device shells, pressure sensitive film and/or covers. An example of such a portal for use in ordering customized adhesive covers or skins is commercially available at www.skinit.com. Such websites may be run by a customization or personalization company, such as Skinit, Inc. or maybe a partner site hosted by a particular vendor of products. The out of box model is also applicable in the retail supply chain. For example, the retailer may allow a consumer purchasing a product at the point-of-sale to specify desired customization, where the retailer has the proper image application devices to apply the image to the device or accessory at the point-of-sale. For example, a user could select custom imagery to apply to the device at the point of purchase, and printing devices located within the retailer then apply the image to the device, portion of the device, or accessory to the device. This model may also be applicable through a website or other portal hosted by the retailer providing the user the same level of customization making an online purchase. The out of box model is also applicable in a regional manufacturing application where a consumer has purchased a product and would like to personalize the product after the point-of-sale. The consumer may be provided an interface via a website or a kiosk located at or near a retailer or shopping mall, for example. In some embodiments, while providing several locations for the customer to order the desired customization, the out of box model is primarily intended for small orders, as few as one single item to be customized by a single consumer. On the other hand, the inbox model 102 referred to in FIG. 1 is in most embodiments, intended to apply to customized orders for devices in greater quantities than a single device and for distribution and/or commercial sale by another commercial entity. For example in some cases, a commercial retailer, such as Best Buy, could place an order for several hundred to one million custom notebook or notebook computers reflecting a currently forecast desirable customization.

In either model, the devices may be any device electronic or otherwise, that may be commercially sold or otherwise that consumers may desire to personalize. In either model, the customer is able to select imagery to apply to the product or device. The imagery may be selected from a design library of brands, licensed designs, patterns, and artwork, for example. The imagery may further include customer uploaded image data, such as photographs, logos, identification data, tags, logos, codes, advertisements, and/or other artwork. The imagery may include one or more of color, text, size, font, language, regional information, artwork, photographic, transparency, and pattern elements. In some embodiments, the user may mix and match multiple images and design options, creating an image mashup according to the user's tastes. In some embodiments, a flash-based user interface is provided by web server to a user through a network. Furthermore, in either model, the customer is able to determine what product, device, portion of product or device, and/or accessory to product or device the customer would like to apply the image to. Additionally according to either model, the customer may optionally select the method of application, for example direct to surface or substrate painting/printing or printing to pressure sensitive film or adhesive material.

In either model, in some embodiments, a software management platform, or on-demand platform, is provided that performs any of the functions described herein. An example of an on-demand platform primarily suited for the out of box model is described in U.S. patent application Ser. No. 11/935,382, filed Nov. 5, 2007 and entitled “Order Fulfillment and Content Management Systems and Methods”, published as US Publication No. 2008/0154750, which is incorporated herein by reference. While many embodiments described herein are primarily directed to the out of box model, one or more elements of the on-demand platform may also be applicable in the inbox model. Examples of pressure sensitive film, adhesive covers or adhesive materials to be applied to devices, products, portions thereof and/or accessories to products or devices are described in: U.S. patent application Ser. No. 11/726,960, filed Mar. 23, 2007 and entitled “Adhesive Cover for Consumer Devices”, published as US Publication No. 2008/0233326; and U.S. patent application Ser. No. 11/759,600, filed Jun. 7, 2007 and entitled “Fishing Lures and Adhesive Cover for Same”, published as US Publication No. 2008/0104880, both of which are incorporated herein by reference. An example of an interactive interface allowing a user to create a virtual design, for example, in creating imagery for application to products, portions thereof, accessories to products such as covers, shells and/or adhesive skins or materials in both the inbox and out of box models, is described in U.S. patent application Ser. No. 12/267,527, filed Nov. 7, 2008 and entitled “Customizing Print Content”, published as US Publication No. 2009/0122329, which is incorporated herein by reference. An example of a path creation utility for use within an interactive image editor useful to allow a user to create customized image content by overlaying one or more images upon one or more background images to create or define a selected portion of the image content is described in U.S. patent application Ser. No. 12/684,781, filed Jan. 8, 2010 and entitled “Path Creation Utility for Image Editor”, which is incorporated herein by reference. One or more of the processes and systems described in one of more of these patent documents may be applied in one or more embodiments of processes implementing various inbox models and/or out of box models such as those described herein.

Referring next to FIG. 3, a diagram 300 is shown illustrating various entities and the flow of orders and parts in one embodiment of an out of box model for on-demand personalization in accordance with several embodiments. This diagram illustrates the relationship between an end customer 302, an OEM 304, an ODM 306, the ODM's parts supplier/s 308, and an on-demand customizer (ODC) 310. While referring to FIG. 3, concurrent reference is made to FIG. 4, which is a flowchart of the steps involved in an out of box model of an on-demand personalization process in accordance with one embodiment.

Initially, an end customer 302 forecasts a need for a customized product and places an order with an OEM 304 (Step 402). In one example, electronics retailer forecasts a need for a limited run of 100,000 netbook computers personalized with variable image data including a specific color, keyboard language and region. In one form, the order is driven through an agency purchase order (APO) application interfacing with the resource planning and logistics application of the OEM 304. Next, the OEM 304 receives the order (Step 404) and passes it to the ODM 306 (Step 406), who in turn passes the order to the on-demand customizer (ODC) manufacturing entity. Alternatively, the OEM 304 sends the order to both the ODM 306 and the ODC 310, for example, using a resource planning and logistics or enterprise resource planning (ERP) application. The ODM 306 ensures that un-customized or blank parts are provided to the ODC 310 (Step 410), for example, by shipping or previously having shipped blank or un-customized parts to the ODC 310 or by coordinating with parts suppliers 308 to supply or ship blank or un-customized parts to the ODC 310. The blank parts may be delivered to the ODC 310 from the ODM 306 and/or the ODM's parts suppliers 308. In preferred form, the ODC is provided blank parts from the ODM on a consignment basis. Minimum and maximum numbers of blank parts are maintained at the ODM. The ODC 310 receives the order from the OEM 304 and/or the ODM 306 (Step 412), the order including an image specification or image and customization data specifying the image data to be applied to the blank parts. In some embodiments, the image and customization data includes one or more image files, and/or one or more references to, pointers to and/or links to one or more image files within a local or remote database, other storage medium or remote website. In some embodiments, the order is received in the format specified by the ODC 310 to ensure prompt handling and processing by the ODC 310. For example, as indicated by arrows from the ODC 310 to the end customer 302 and/or the OEM 304 in FIG. 3, in some embodiments, the ODC 310 provides an interactive user interface allowing the customer and/or the OEM 304 to select desired image content from the content library and/or upload image content into the ODC library. In some embodiments, the imagery to be applied to a given component will be selected by an end customer from a pre-established catalog of OEM 304 approved imagery, e.g., pre-approved image and customization data. The image content contained in the library may include data about color information, text information language information, layout information, license design and/or artwork and other image customization parameters such as described herein. In one form, the image and customization data of the received order includes a configuration file in a standard format that specifies all possible design parameters of imagery to be applied to the blank components, the file corresponding to a specific virtual stock keeping unit (SKU) of the ODC 310. In one embodiment, the configuration file is a layer based image file, each layer editable by the customer to define different characteristics of the custom imagery. In one embodiment, the configuration file is a .PSD file made standard by Adobe Systems Incorporated. It is understood that any number if acceptable file formats may be used; however, a PSD file is widely used and editable by a number of widely available pixel-based editing and vector-based editing software products, such as ADOBE ILLUSTRATOR, ADOBE PHOTOSHOP, INKSPACE, CORELDRAW, etc. Other example configuration file formats of some embodiments include Adobe Illustrator (AI), encapsulated PostScript (EPS), portable document format (PDF), tagged image file format (TIFF), Windows™ Media Format (WMF), scalable vector graphics (SVG). In some embodiments, the configuration file includes one or more image files or contains a pointer or reference to one or more image files, such as JPEGs, GIFs, PDFs, PNGs, TIFFs. In some embodiments, the configuration file includes a proprietary format and application (web or otherwise) to work with other files. For example, in one embodiment, a markup language (e.g., XML, PPML, FXG, XAML, etc.) file is provided which contains layering data and references or points to one or more image files, such as JPEGs, GIFs, PDFs, PNGs, TIFFs, etc. Examples of such embodiments are described, for example, in U.S. patent application Ser. No. 12/267,527, filed Nov. 7, 2008 and entitled “Customizing Print Content”, published as US Publication No. 2009/0122329, which is incorporated herein by reference. It is understood that these example file formats, markup languages, image files, etc. are not meant to be exhaustive of all possible choices and merely providing non-limiting examples.

In accordance with the order, the ODC 310 applies the image content to the blank parts (Step 414) in an on-demand fashion. The image content may be applied in a variety of ways including, but not limited to, painting, in mold printing and/or post-mold decoration using printing techniques, such as LaserJet printing, UV curable ink printing, pad printing, silk screen printing or any other thermoplastic or thermoset coating techniques that can function to apply one or more of a primer, basecoat, topcoat and so on in combination with any ink layers or any other techniques known in the art or otherwise described herein. In one embodiment, direct to surface printing devices using Laser printing and/or UV curable printing technologies provided by Teckwin International of Shanghai, China, are used in a post-mold decoration process at least in part to apply the custom image. In some embodiments, surface treatments are optionally applied, such as chemical film treatments or plasma treatments, e.g., to modify (e.g., raise or lower) dyne levels to ensure good adhesion between paint and/or print layers. In some embodiments, any coating technologies used in the image application process may be matched to the substrate technology to ensure good performance. By way of examples and not limited to these examples: temperature sensitive substrates like PC/ABS (PolyCarbonate/Acrylonitrile-butadiene-styrene), Synthetic leather, Microfiber, and so on may be used with a low temperature curing (<60 C) UV, moisture, or polyurethane coating; a metallic substrate like Stainless Steel, Magnesium, Aluminum, may be used with a high temperature cure product like Acrylic/Melamine; and glass substrates may be used with an alkoxysilane condensation material.

Next, the printed or customized parts are collected, inventoried and delivered to the ODM 306 (Step 416). The ODM 306 then assembles a custom product or device (Step 418) and delivers a custom product or device to the OEM 304 and/or the end customer 302 (Step 420). In other embodiments, the custom product is assembled by the ODC 310 or other party. In accordance with several embodiments, this approach in on-demand manufacturing of customized products allows for product turnaround times in the manufacturing cycle on the order of days as opposed to months. Again this leads to reduced dependency on forecasts and less risk of carrying inventory for an end customer 302 such as a retailer or distributor or an OEM 304.

Referring next to FIG. 5, a flowchart is shown for the steps involved for an in box model for an on-demand personalization process from the perspective of an on-demand customizer in accordance with several embodiments. As an initial step, in accordance with one embodiment, the ODC 310 receives blank parts (Step 502). In one embodiment, the blank parts are received from an ODM 306 and/or the ODM's parts supplier 308. The inventory of blank components or parts is managed to be within minimum and maximum levels designated by the ODM. In another embodiment, the blank parts are received from inventory at the ODC. For example, the blank parts have been previously received from the ODM or parts supplier and are located in the ODC's inventory and are pulled from this inventory. As described herein, the blank parts may be any component or portion of the product/device, or accessory to product. For example in the case of customized netbook or notebook computers, the blank parts may be keyboards, keypads, shells, bezels, lids, covers, mice, panels, doors, etc. In accordance with one or more embodiment described herein, blank parts to be customized may be rigid, semi-rigid and/or flexible depending on the substrate.

Batches of the received blank parts are created in preparation for received orders (Step 504). In one embodiment, the received blank parts are preassembled into batches for use in the image application process in anticipation of received orders. In some embodiments, the parts are batched in a manner optimized for workflow within an image application facility. For example, in one embodiment, the blank parts are preassembled and sorted into bar coded batches and placed on trays of a movable cart, each part including a fixture or holding structure that may be needed to properly position and register the blank parts within an image applicator device. The preassembled and batched blank parts are then moved to inventory pending a received order. In other embodiments, the parts are sorted or grouped into the batches without necessarily requiring any preassembly.

Next, an order for customized image application to the blank parts is received (Step 506), for example, from an ODM 306 and/or an OEM 304. The ODC 310 then performs resource planning in order to determine if the order can be met (Step 508). For example, in some embodiments, the ODC 310 determines one or more of whether there is a proper availability of blank parts, whether there is sufficient availability of image application devices, and whether the order can be met from the delivery location relative to the location of the available image application facilities. In some cases, any artwork or imagery uploaded or included with the order may require approval for content and/or technical details (e.g., determine if the image meet a minimum resolution) (Step 510). In many instances, the imagery to be applied to a given component will be selected from a pre-established content library of approved imagery or, in some embodiments, a pre-established catalog of OEM approved imagery. However in other instances, depending on the embodiment, imagery may be created by the end customer 302, or licensed to the end customer 302 and uploaded as part of the order. In this case, at least some level of image artwork approval may be required to meet established artwork and/or image criteria. If it is determined that the order can be met, the order is then accepted (Step 512) and a communication is sent back to the ODM 306 and/or the OEM 304 signaling the order will be initiated.

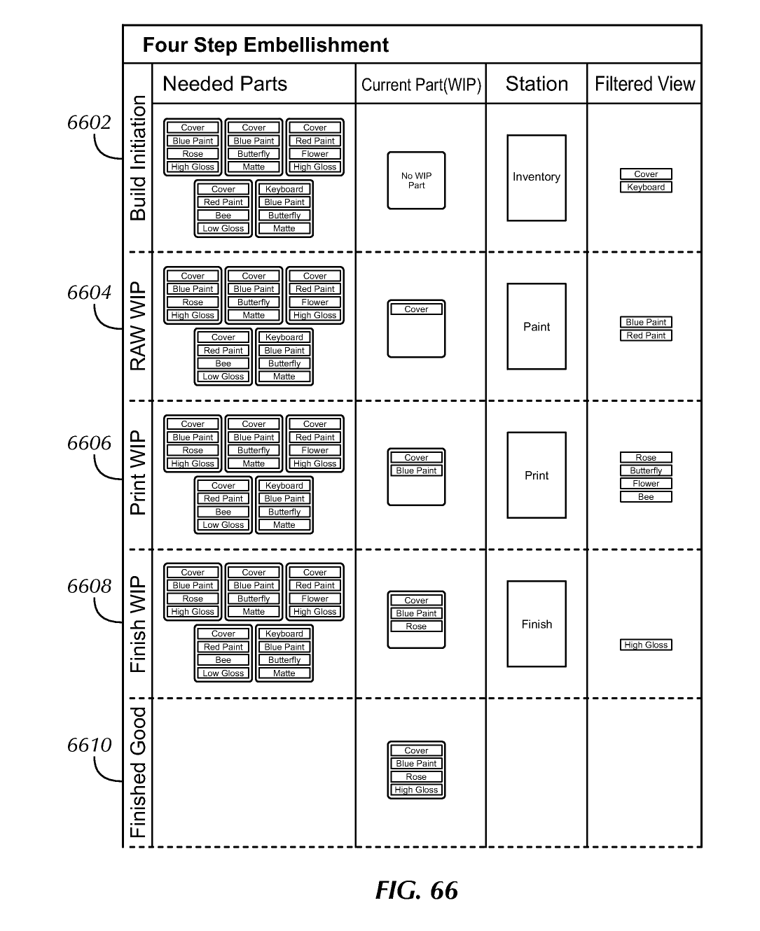

The ODC 310 then determines and schedules the image application process (Step 514) taking into consideration at least one or more of the following: the specific types of image application devices needed to fulfill the order; the availability and location of the image application devices; and the availability and location of batched blank parts in inventory; and the location of the delivery destination once the order has been completed. In some embodiments, a software management platform of the ODC 310 performs this scheduling function. In some embodiments, an entire sequence of the image application process is scheduled, whereas in other embodiments, only a portion of the image application is initially scheduled to allow for flexible scheduling of follow up steps in the image application process using dynamic filtering (e.g., such as described in the embodiments of FIGS. 66-68). Signaling is sent instructing workers and/or machinery to move the batched blank parts to the image application devices (Step 516) to cause the image or imagery to be applied to the blank parts, e.g., by painting, printing, coating, etc. (Step 518). The ODC 310 then does a quality check to verify accuracy the application process and to discard parts not meeting quality specifications (Step 520). Batched printed or customized parts are then packed out for delivery, e.g., to the ODM 306 (Step 522). In other case, the customized parts may be delivered to another entity such as an OEM 304, retailer, distributor, individual, etc. The customized parts are then shipped or delivered (e.g., to the ODM 306) (Step 524) for final assembly before delivery to the OEM 304 and/or the end customer 302.

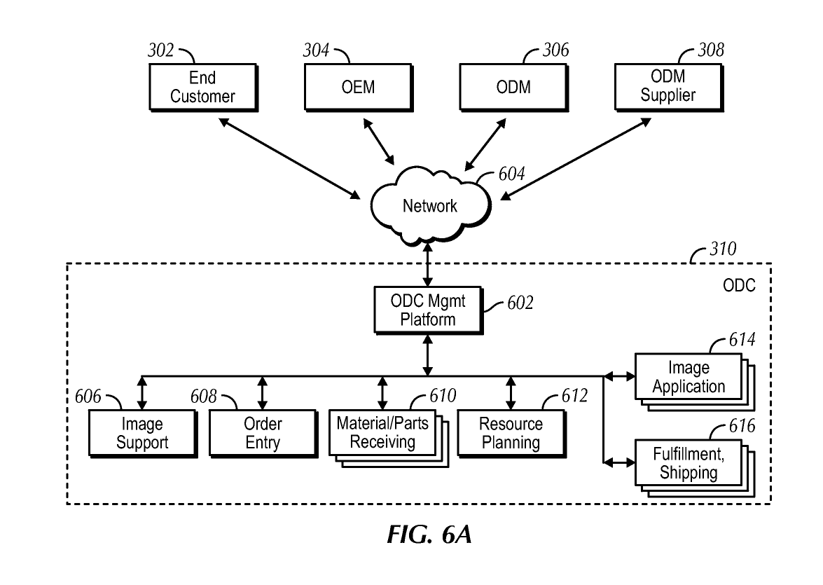

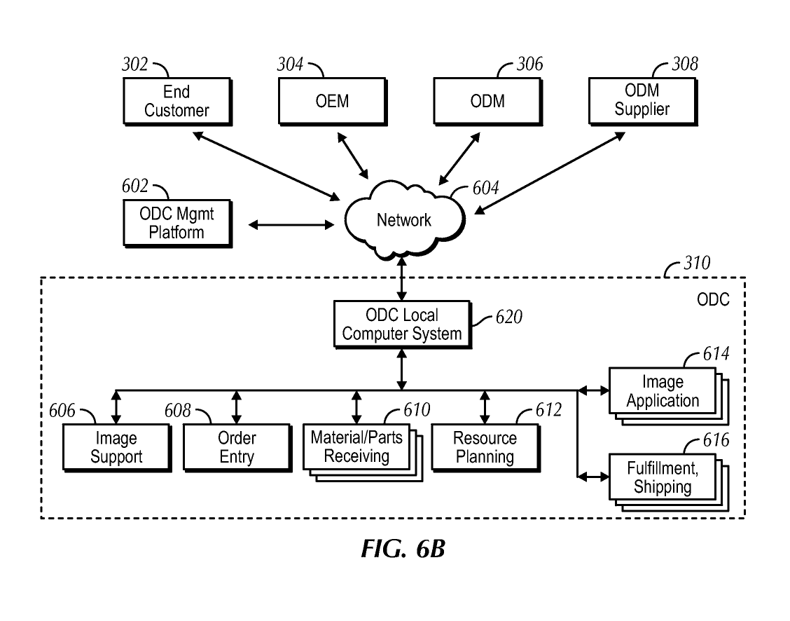

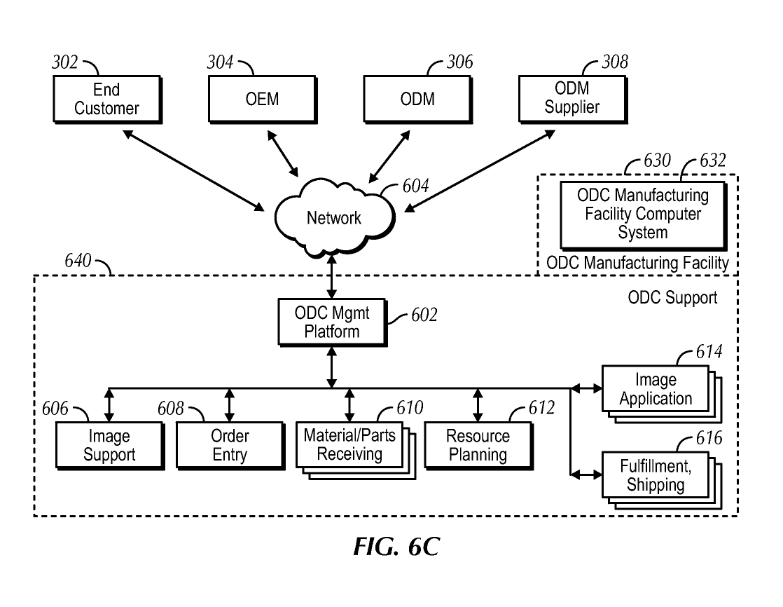

Referring next to FIG. 6A, a diagram illustrates the various entities involved in an on-demand personalization process and their relationship to a management platform of the on-demand customizer in accordance with several embodiments. In several embodiments, the manufacturing solution of the on-demand process is managed at least in part by a management platform 602 of the on-demand customizer 310. In one embodiment, this management platform 602 as the ability to variously interface with one or more of the end customer 302, the OEM 304, the ODM 306, and one or more ODM parts suppliers 308 via a network 604, such as an Internet, intranet or other wide or local area network. For example, in some cases, the management platform 602 provides an end customer with an interactive interface allowing the end customer to select, upload, edit and define variable image content to be applied to blank parts of the product. In some embodiments, the management platform 602 interfaces with resource planning and logistics software or applications, enterprise resource planning (ERP) software, or other inventory management software. For example, the management platform 602 may receive orders and or requests for status or updates from the OEM 304 and/or ODM 306. Internal to the ODC 310, in one embodiment, the management platform 602 provides image and image content support (e.g., image support functionality 606) including storage and maintenance of a library of content and available customization options, e.g., stored in a database or memory implemented in the image support and managed by the management platform. In one embodiment, the management platform 602 also provides order entry support (e.g., order entry functionality 608), for example, providing an interactive interface allowing customers and/or OEMs to place orders for parts including custom imagery. In one embodiment, the management platform 602 further supports the processing, batching, and inventory of materials (e.g., materials/parts receiving functionality 610) such as received blank parts. These materials may be received from multiple sources and batched and inventoried to one or more locations. In one embodiment, the management platform 602 further supports resource planning (e.g., resource planning functionality 612) within the abilities of the ODC 310. For example, this may include an assessment of existing priorities and orders in process and the ability of the ODC to complete orders as received. This may further include the ability to properly plan and schedule the application of images using different image application devices in one or more locations based on device availability, job priority and/or location. In one embodiment, the management platform 602 additionally supports and manages the image application process (e.g., image application functionality 614). For example, this may include prompting workers or signaling machines to move batched parts to specific image application machines, such as painters and/or printers. This may further include managing the detection of errors or defects in the image application process. Further, in one embodiment, the management platform 602 supports fulfillment of the order inventory of completed batches and shipping of completed batches back to the ODM 306 (fulfillment, shipping functionality 616).

In some embodiments, the management platform is implemented at one or more servers or computers of the ODC 310 and various interfaces are provided to one or more of the end customer 302, OEM 304, ODM 306 and/or ODM suppliers 308 via the network 604. For example, the management platform 602 is hosted by the ODC 310 and remote access is provided to the remote parties, for example, to set up and define image templates, place orders, monitor status of orders, etc. In some embodiments, at least some functionality of the management platform 602 may be installed and executed on the local computers of one or more of the end customer 302, OEM 304, ODM 306 and/or ODM suppliers 308. In other embodiments, the management platform 602 is hosted by the ODC's computers and/or servers, which can provide some executable code to the remote computers of one or more of the end customer 302, OEM 304, ODM 306, ODM suppliers 308 and/or other parties such as distributors, this executable code executed on the remote computers, but not installed or stored on the remote computers. For example, the executable code provided to the remote computers may include one or more Flash-based programs, javascript or other code executable within a web browser.

In some embodiments, such as illustrated in FIG. 6B, the management system 602 is itself hosted and executed at one or more computers or servers at a separate location than the on demand customization facility 310 or facilities. In such case, the management system 602 couples to a local computer system 620 of the ODC 310. In this embodiment, the management system 602 may include one or more of the image support functionality 606, order entry functionality 608, materials/part receiving functionality 610, resource planning functionality 612, image application functionality 614 and fulfillment and shipping functionality 616; whereas the local computer system 620 includes one or more of the remaining ones of the image support functionality 606, order entry functionality 608, materials/part receiving functionality 610, resource planning functionality 612, image application functionality 614 and fulfillment and shipping functionality 616. That is, one or more of the various support functionalities of the management platform 602 may be provided at one or both of a remote location or at the local computer system 620.

In other embodiments, such as illustrated in FIG. 6C, the management platform 602 and one or more of the image support functionality 606, order entry functionality 608, materials/part receiving functionality 610, resource planning functionality 612, image application functionality 614 and fulfillment and shipping functionality 616 are implemented as functional ODC support 640 that is separate from a physical location of the actual ODC manufacturing facility 630 that includes the hardware to customize products. For example, the management system 602 including one or more of the image support functionality 606, order entry functionality 608, materials/part receiving functionality 610, resource planning functionality 612, image application functionality 614 and fulfillment and shipping functionality 616 couples to and directs a computer system 632 of the ODC manufacturing facility 630 via the network 602.

In some embodiments, the ODC management platform 602 is implemented as software and/or firmware or other executable program code stored in one or more memory devices (for example, computer readable mediums) in one or more computer devices or server machines including one or more processors. This software, firmware and/or executable program code when executed shall provide at least one or more of the functions described herein. In some embodiments, functionality is automated whereas other functionalities require worker, manager and/or other human input or triggering, often at the prompting of automated functionality.

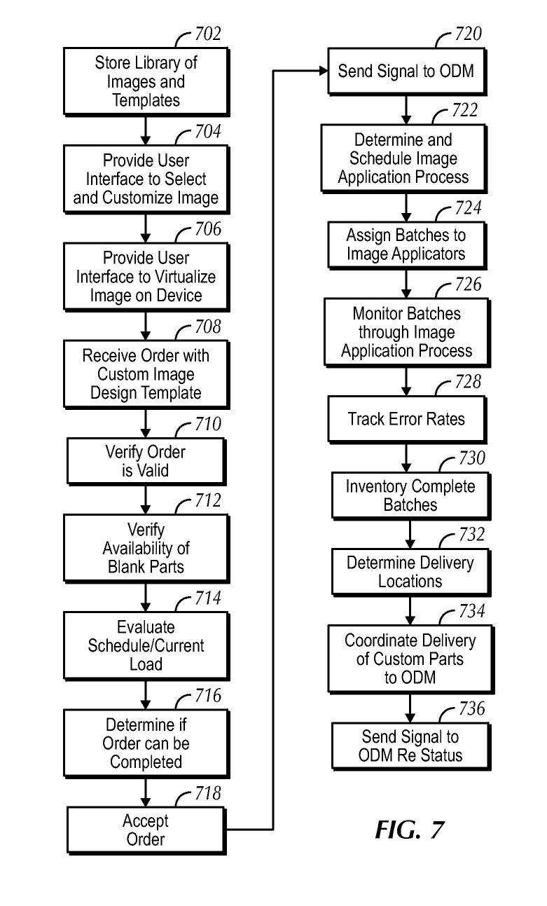

Referring next to FIG. 7, a flowchart illustrates the steps involved in an on-demand personalization process as performed by the on-demand management platform such of the on-demand customizer as described herein in accordance with several embodiments. In one embodiment, the management platform of the ODC performs one or more of these steps. In another embodiment, at least some of the functionality of the management platform is implemented within an ODM and/or an OEM.

Initially, the management platform stores and maintains a library of images and customization templates (e.g., which are pre-approved by the end customer, ODC, ODM, and/or EOM) (Step 702). For example, the management platform 602 maintains or has access to a database or other memory storing images and/or templates. As described herein, this library includes predesigned and licensed, or uploaded image content and image data defining one or more of: color, text, size, font, language and regional options, artwork, photographic images, patterns, transparency, identification elements such as asset tags and readable codes, logo elements, material choice elements, and coating and surface treatments, each selectable from a plurality of options. In one embodiment, each combination of selectable options defines a unique virtual SKU of the ODC. Next, the management platform provides an interactive interface allowing an end customer to select and customize variable image data for application onto the part to be personalized or customized (Step 704). Next, or in concurrence, the management platform provides an interactive interface to allow the end customer to virtualize the selected image data onto the part and/or the device (Step 706). In one embodiment, this allows an end user to visualize the part and/or device with the image data and design parameters as specified.

Next, an order is received that includes image and customization data specifying imagery to be applied to blank parts (Step 708). In one form, this image and customization data takes the form of a file specifying all selectable options as described above. In one form, the file takes the form of a layer based file, such as a PSD file, including fields defining various layers of the image content to be applied to the blank parts. In another form, the image and customization data includes one or more image files or pointers or links to one or more image files for use in customizing the blank parts. In another form, the image and customization data includes a pointer or reference to a pre-approved virtual SKU or other pre-approved and configured set of image and customization data available for selection from a catalog or library. One advantage of embodiments using a PSD file is that it may be edited by a number of different software applications, such as ADOBE ILLUSTRATOR. Additionally, in some embodiments, the order specifies a quantity of blank parts to be customized and a date for which the order is to be completed.

Next, the order is verified as valid order (Step 710), for example, that the order is received in the proper format to ensure on-demand image application or corresponds to a pre-approved virtual SKU or template already stored in an image library. Order verification may be important in embodiments where image application turnaround time is desired to occur within hours as opposed to days or months. Availability of blank parts in inventory is verified (Step 712). For example, the number of parts to be ordered is compared to the number of batched and preassembled parts in inventory and available for images to be applied thereto. Next, the management platform evaluates current and/or pending image application jobs and current orders being fulfilled or waiting to be fulfilled and prioritizes and projects the ability of the ODC to complete the order in the time specified (Step 714). Given these and other factors, the management platform determines if the order can be completed in the specified time (Step 716). If this is the case, the order is accepted (Step 718) and signaling is sent to the ODM and/or the OEM (Step 720). In one embodiment, the signal is sent using EDI interface to the ODM resource planning application.

Once the order has been accepted, the management platform determines appropriate schedule to implement the image application process (Step 722), such as described in any of the ways described herein or otherwise. In some embodiments, this scheduling includes determining which image application devices are to be used for which batches of blank parts where the image application devices may be resident in one or more different physical locations. This further includes assessing the availability and current job priority of image application devices, and if need be, reprioritizing existing jobs and tasks currently being implemented by one or more image application devices. Next, the system assigns batches of blank parts to specific image applicators including painters and/or printers (Step 724). In some embodiments, the platform ensures that the proper image application devices are provided with the proper files to drive the device. For example, in one embodiment, the platform provides a raster image processor (RIP) file to a direct to surface printer that specifies the exact imagery to print. Next, the management platform monitors the batches of blank parts as they undergo the image application process (Step 726). In a preferred form, batched blank parts are separately identified, for example, using barcode or other identifying indicia, for use in tracking batches through the image application process. In some embodiments, image application devices include painting devices that apply a base paint layer, LaserJet or UV curable ink printers to apply imagery in one or more colors on top of the base paint layer, and coating devices to apply a clear coat of desired hardness and finishing or other finishing layer as specified by the order. In some embodiments, surface treatments, such as chemical film treatments are applied to the substrate of the blank part depending on the substrate material prior to painting or printing. In some embodiments, treatments, such as plasma treatments are applied to various layers to ensure good adhesion of various layers. In one embodiment, the management platform coordinates and schedules the movement of the batched parts through the factory by machine or human to one or more of image application devices. In some embodiments, this process is entirely automated while in other embodiments user input is required. For example, workers may be required to scan batch barcodes before and after use of a particular image application device in order to allow the management platform to track and monitor the order completion.

The management platform tracks defects and error rates and coordinates disposal or separation of defective parts (Step 728). Completed batches are inventoried and readied for delivery (Step 730). The management platform then determines and/or assigns delivery locations for each batch of completed customized parts (Step 732). Delivery of the customized parts is instructed and/or monitored by the management platform so that the customized parts are delivered to the proper ODM within the time specified by the order (Step 734). As customized parts are delivered to the ODM, signaling is sent to the ODM indicating the order is complete and a delivery is in progress (Step 736). In other embodiments, the customized parts are delivered to other entities, such as the OEM, distributor or end customer.

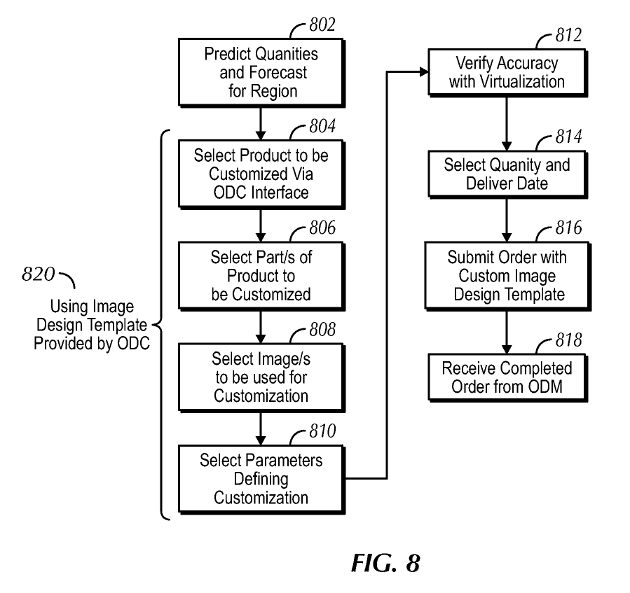

Referring next to FIG. 8, a flowchart illustrates the steps performed by the end customer in an on-demand personalization process in accordance with several embodiments. As an initial stage of an on-demand customized manufacturing process, the end customer predicts the quantities of products and types of products for the region where the products are to be sold (Step 802). As part of forecasting current consumer demand, an end customer selects a product to be customized (Step 804). This election may be made, for example, using an interactive interface provided by the ODC. In one example the end customer selects a netbook or notebook computer. Next, the end customer selects one or more parts of the product to be customized (Step 806). In one example, the customer selects a lid cover, a front panel and/or a keyboard for the computer. Again, in one example, this election may be made using the interactive interface provided by the ODC.

Next, the end-user selects variable image content and/or imagery to be used to customize the parts of the product (Step 808). For example, in one embodiment the user may select a color scheme, photographic or other graphic imagery specific to an item of current consumer interest, such as relating to the movie Avatar mentioned above. Additionally, the user may select keyboard language options specific to the intended retail region as part of the variable image data to be applied to the parts, in this case a keyboard. Additionally, the user may select an asset tag or other identifying information, code, logo or company branding to include in the imagery to be applied to the part. In one embodiment, this election may also be made by the end customer using the interactive interface provided by the ODC. Next, in customer defines all parameters to complete definition of the customization to be obtained (Step 810). This may include, specific color choices, image transparency, size, orientation, etc. In some embodiments, the selection is made using the interactive interface provided by the ODC.

The steps provided thus far may be implemented in a variety of ways. In one embodiment, the order information is in a purchase order format of the retailer and/or the OEM, via a web interface or other interactive interface that allows customer selection of customization options, for example. In one example, the end user is provided an editable template that will allow the user to make all selections (Step 820). In one case, the template is in the form of any of the file formats described herein, such as a layer-based editable format, where each layer defines editable or selectable options, such as an editable PSD file mentioned herein. In some embodiments, a template in PSD file format is provided for each product containing parts to be customized.

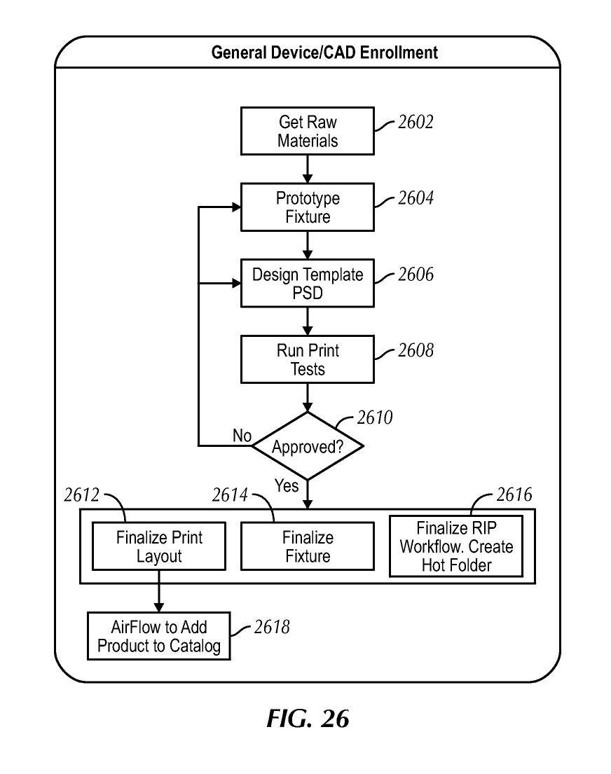

In some embodiments, the end customer is not provided with an editable design template, but is alternatively provided a catalog of OEM pre-approved and configured combinations of all customizable parameters including image/s, colors, language, etc, for a given product. For example, an OEM has already gone through the process of editing design templates, such as described above, and the edited design templates are then saved and published as virtual SKUs in a catalog available for the end customer's selection. In this way, the OEM can control the available customization options available to the end customer and the end customer is not required knowledge of how to use and edit the design templates. Thus, the ODM performs the steps involving the use of the design template 9 (see also, FIG. 26 and its corresponding description).

In some embodiments, the end customer is provided with the ability to verify the accuracy of the desired customization through virtualization of the product or part with the image applied thereto (Step 812). In one embodiment, this ability is provided by the interactive application of the ODC. In one form, an example of such an interactive interface is described in U.S. patent application Ser. No. 12/267,527, filed Nov. 7, 2008 and entitled “Customizing Print Content”, published as US Publication No. 2009/0122329, which is incorporated herein by reference. In one embodiment, this virtualization allows a customer to visualize the appearance of the product and/or part with the image customization applied in a three dimensional matter, for example, including the ability to rotate the device or product for viewing at a variety of angles. In other embodiments, this virtualization is a two-dimensional visualization. The virtualization may include actual imagery of the actual product or graphical or computer generated representations of the actual product or part.

The customer then specifies the quantity of blank parts to be customized and a delivery or completion date of the order (Step 814). In an on-demand process in accordance with several embodiments, this completion date may be on the order of days as opposed to months. The order is then submitted in the appropriate format and including image and customization data specifying all parameters of imagery to be applied (Step 816). In some embodiments, this includes a custom image design template in the form of a file, such as a PSD file with all selectable options included within the file and defining a virtual SKU of the ODC. In some embodiments, the image and customization data includes one or more image files or includes one or more pointers or links to one or more image files within a local or remote database, storage medium or remote website.

In one form, as described above, the order is then sent to the OEM and then the ODM and ODC. Typically, the ODC completes application of imagery to the blank parts which are then delivered to the ODM for final assembly and delivered to the OEM and/or the end customer. The end customer then receives the completed order from the ODM and/or the OEM (Step 818). In some embodiments, the ODC assembles the customized components or assembly is not required since the customized part is the complete customized product. In some embodiments, the ODC delivers the customized part to the OEM or end customer.

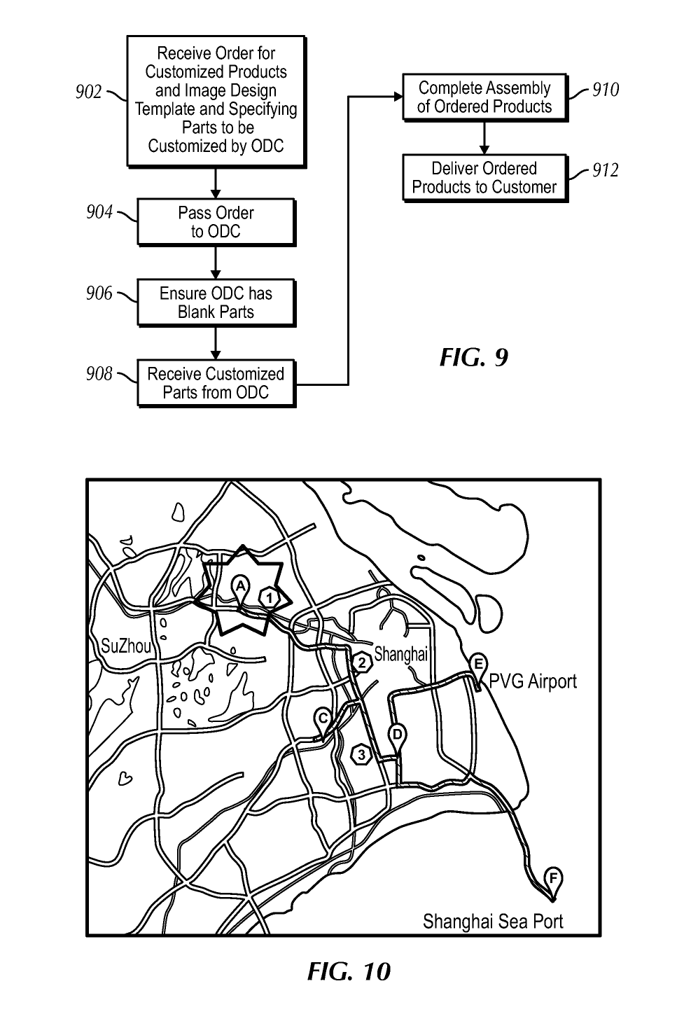

Referring next to FIG. 9, a flowchart illustrates the steps performed by the original design manufacturer (ODM) in an on-demand personalization process in accordance with several embodiments. In this embodiment, the ODM 306 receives the order for customized products including image and customization data for specified components, where the customization of the specified parts is to be completed by the ODC (Step 902). In some embodiments, the image and customization data defines or specifies all customization options, such as those described herein and may include or more image files, or include one or more pointers to, references to or links to one or more image files stored in a local or remote database, storage medium, or remote website. In some embodiments, the image and customization data defines a virtual SKU of a catalog that points to or references a pre-stored set of image and customization data pre-approved by the OEM and stored with a library or database. Additionally, in some embodiments, the order includes one or more a timestamp, defines the part and quantity, defines a due date, defines a priority, defines a dependence or relationship to another order, defines delivery information, etc. The order is passed to the ODC (Step 904). At this point, or prior to this point, the ODM ensures that the ODC has a sufficient quantity of parts to complete the order (Step 906). For example, the ODM coordinates with the ODC to ensure that blank parts delivered on consignment to the ODC are within minimum and maximum inventory levels. If additional blank parts are needed, the ODM and/or its parts suppliers deliver additional blank parts to the ODC. The ODC then applies the image to the parts and delivers customized parts back to the ODM (Step 908). At this point, the ODM completes assembly to the extent needed (Step 910) and delivers the ordered products to the end customer and/or the OEM (Step 912). In some embodiments, assembly of the ordered products is not required or is done by the ODC.

Referring next to FIG. 10, an illustration shows the selection of image application devices and their location relative to original design manufacturers in accordance with several embodiments. In FIG. 10, points A, C and D represent the locations of particular ODMs in Shanghai, China. Point E is a location of the PVG Airport and point F is the location of the Shanghai Sea port. Several OEMs are located within the vicinity of point A. Accordingly, in one embodiment, the on-demand management platform of the ODC factors in the location of particular OEMs when scheduling the image application process across an array of available image application devices at one or more available image application facilities. Example image application facilities owned or controlled by the ODC are indicated at locations 1, 2 and 3. Assuming the management platform has the ability to select image application devices from one or more different facilities, in one embodiment, the management platform preferably assigns the image application process to the closest facility to the location of the ODM where the parts are to be delivered. In some embodiments, this is done to minimize the amount of time from order receipt to delivery of customized components. For example, if customized components are to be delivered to an OEM at location D, the management platform may assign the image application process to a facility at location 3, assuming availability of blank parts and image application devices at location 3. However, in some cases, there may not be enough blank parts at location 3 to satisfy the order, so the measure platform may then assign the image application process to the facility at location 2, or split the process between the facilities at locations 2 and 3. Another option may be to re-prioritize processes scheduled to be performed at location 3 in order that a more time sensitive order be implemented at location 3. In one embodiment, an order currently being implemented at location 3 may be rescheduled to be executed at locations 1 and/or 2, again assuming availability of blank parts in image application devices. In some embodiments, the management platform uses location and availability information in assessing whether or not the order can be accepted. It is understood that there may be many reasons or criteria involved in the selection of a particular location, including distance and location relative to ODMs and other regional transport system locations such as airport and seaport, that factor into a given management platform's decisions to distribute the image application process.

It is understood that in one or more of the processes and/or flowcharts presented herein, not all steps are required in all embodiments. Further in some embodiments, the ordering of steps may be altered depending on the implementation. Additionally, the entities, systems and/or processes performing one or more of these steps may be implemented at one or more of the end customer, the OEM, the ODM, parts suppliers and/or the ODC.

### Example On-Demand Customizer Functional Facility and Process Flow

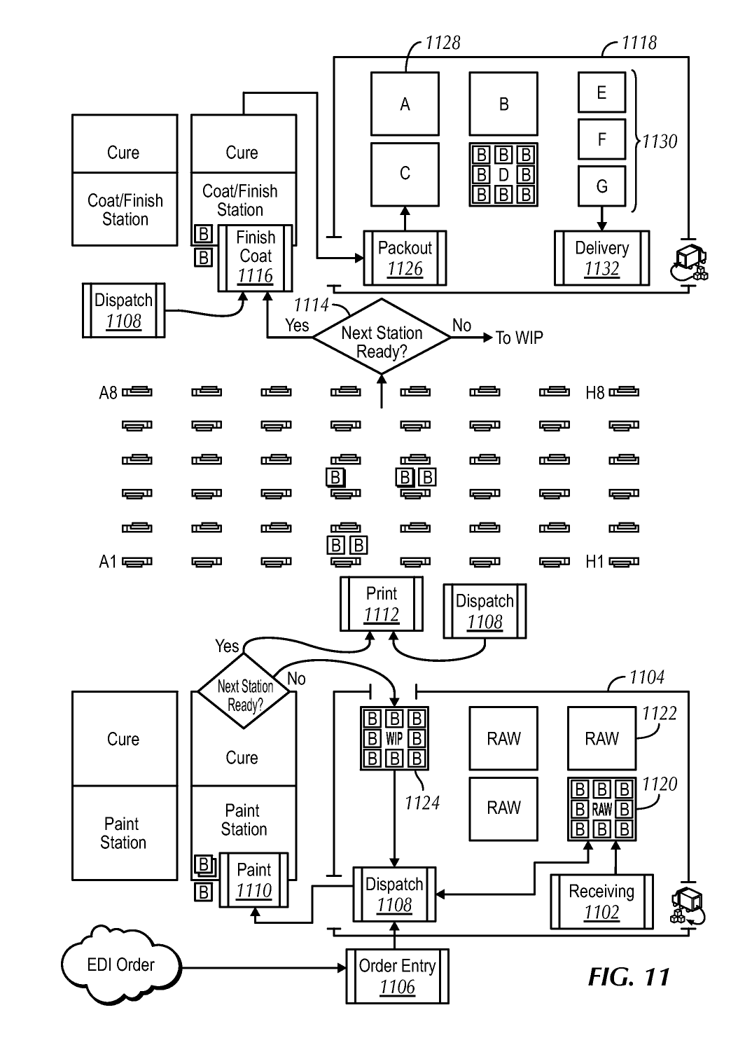

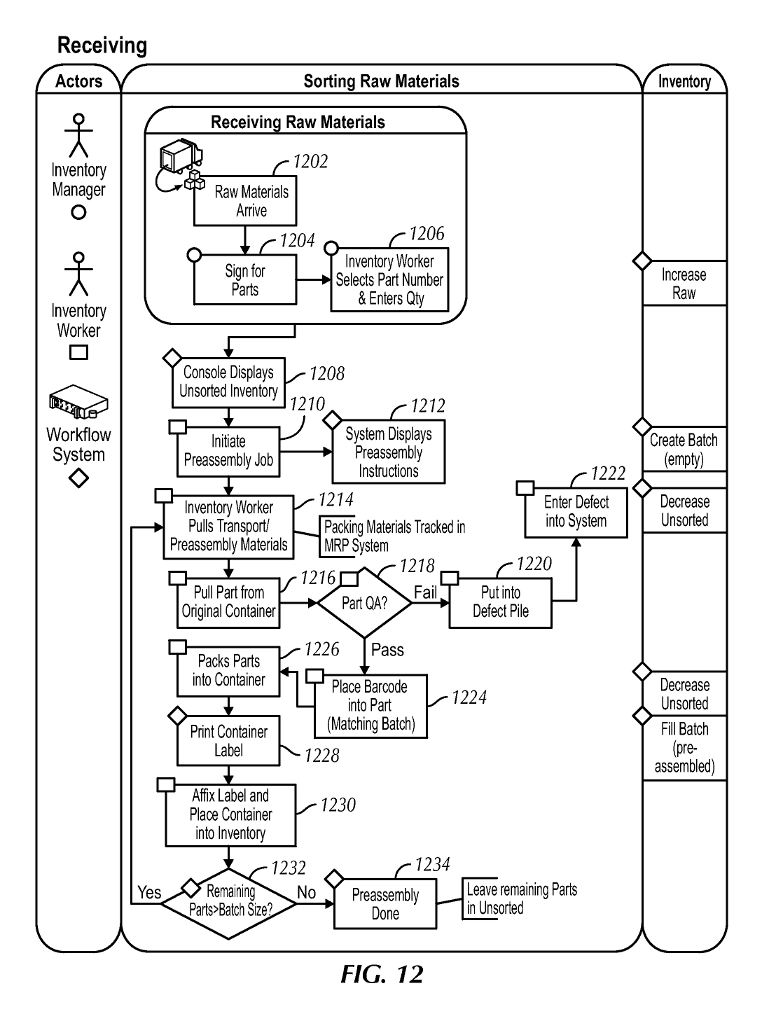

Referring next to FIG. 11, an exemplary physical and functional layout diagram is shown of an image application facility under control of on-demand customizer in accordance with several embodiments. Concurrent reference is also made to FIGS. 12-22, which illustrate various flowcharts of example processes performed for example by the image application facility of FIG. 11.

In accordance with some embodiments, un-customized or blank parts or components are received at the facility from the ODM and/or its parts suppliers. The receiving functional block 1102 represents the steps involved in receiving blank components, coding them, entering them into the management platform, batching them and inventorying them in a manner optimized for flow through the facility during the image application process. In one embodiment, batches of blank parts are placed, positioned, organized and/or preassembled onto carts or other mobile devices allowing the blank parts to be transported throughout the facility, and including fixtures as needed to allow the parts to fit quickly with the application devices. Batches 1120 of blank parts (raw materials) are grouped together and stored in an inventory area 1104. Groups 1122 represents batched blank parts awaiting processing, also referred to raw batches. Group 1124 represents batched parts as a work in progress (WIP), for example, having been painted but awaiting printing and/or curing. FIG. 12 provides one embodiment of the receiving process 1102.

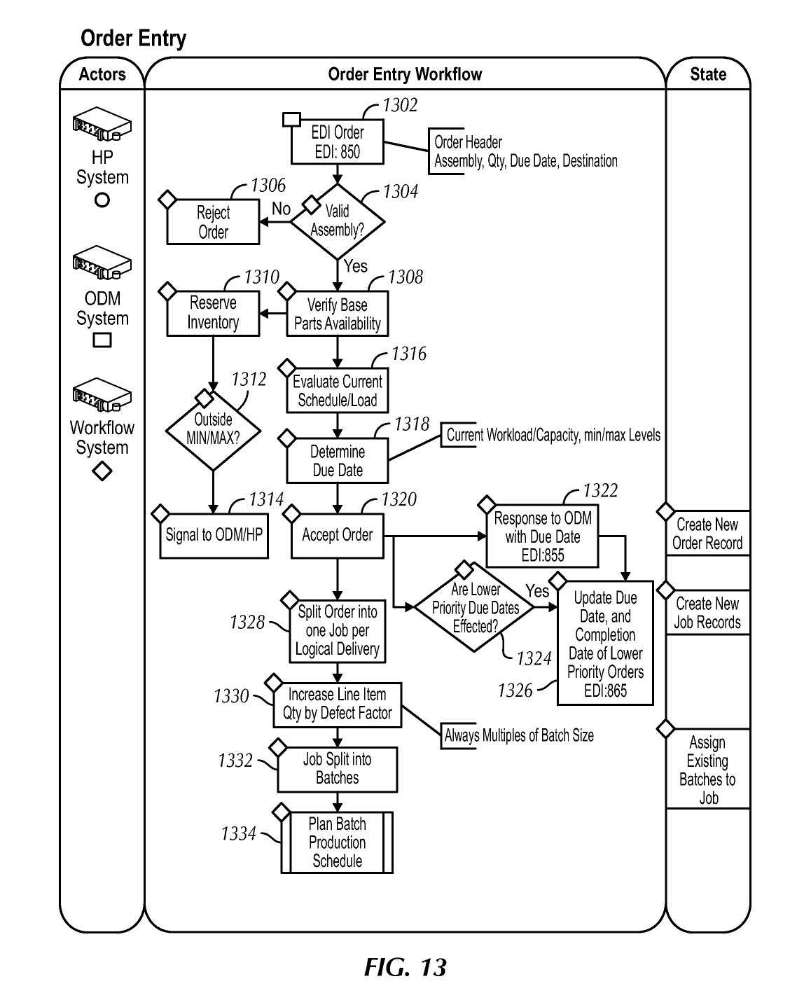

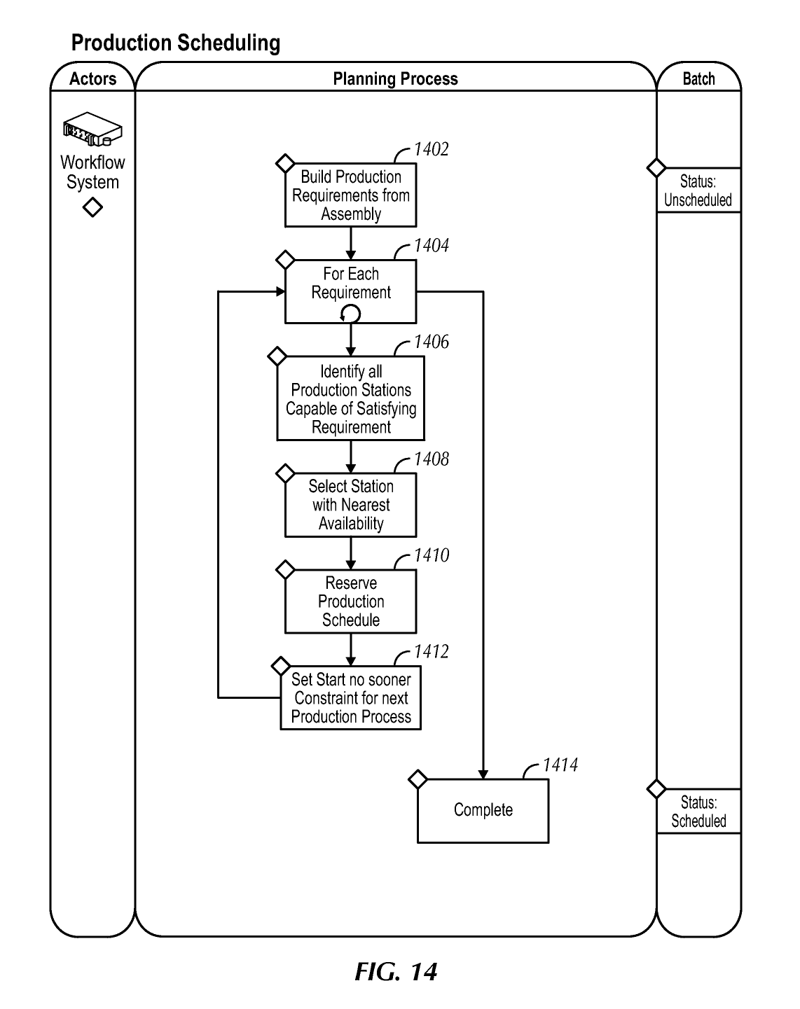

A purchase order based order for customized parts is received and handled at the Order Entry functional block 1106. For example, the order is received via an EDI interface. In some embodiments, the order entry process is performed and/or coordinated by the management platform in order to make a determination as to whether the facility has the availability of parts and equipment to accept the order. The order entry process further determines the priority of the order and plans batch production schedule. FIG. 13 provides one embodiment of the order entry process 1106. FIG. 14 provides one embodiment of the batch production schedule process included within the order entry process of FIG. 13. The batch production schedule process determines how to properly flow batched parts through the facility in order to meet the order.

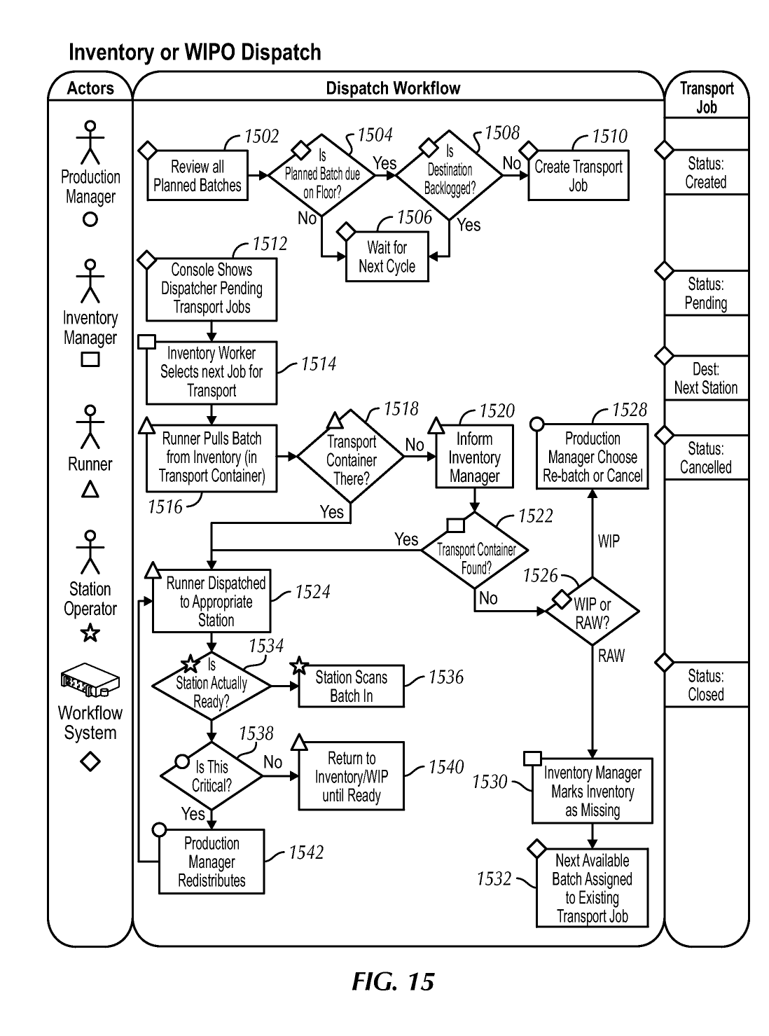

The inventory or dispatch process 1108 generally coordinates which batches or groups of batches are scheduled for processing in one or more locations of the facility. In one embodiment, the management system coordinates with various workers, signaling which batches are to be moved where. FIG. 15 provides one embodiment of an inventory and dispatch process.

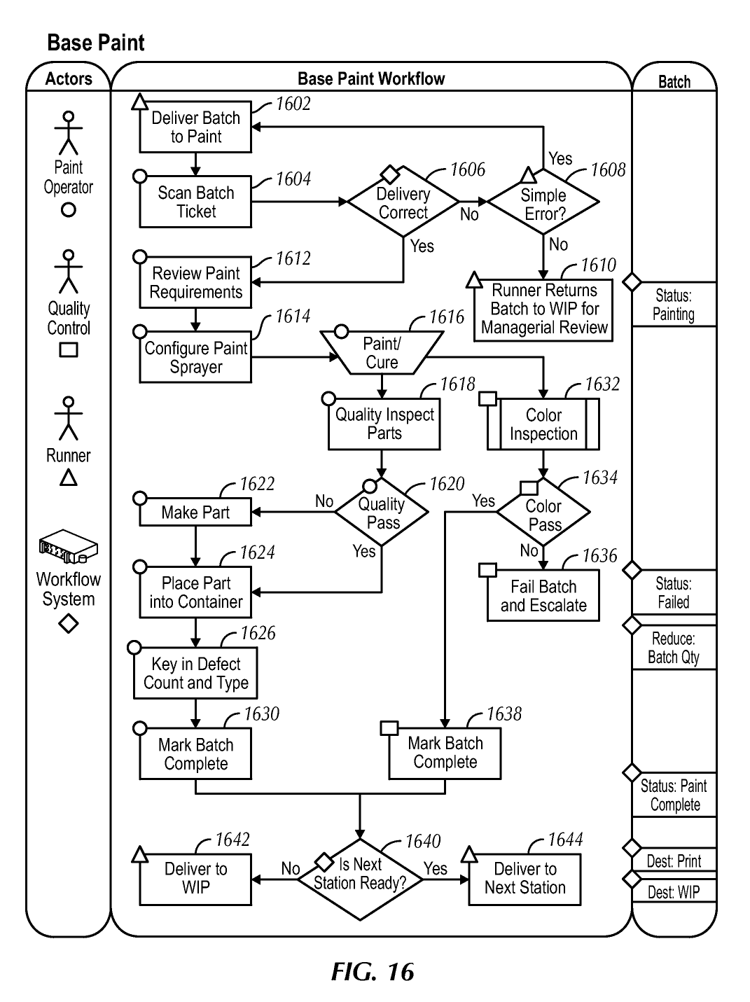

In many embodiments, the base paint layer is initially applied to selected batches of blank parts. Dispatch moves the selected batches to the paint process 1110. The paint process uses one or more paint stations and optional corresponding cure stations. Curing stations may be needed depending on the coating chemistry or technology. In some embodiments, application methods of the coating may be automatically applied via robot, reciprocator and in the form of spray, dip (e.g., thermoplastic and electrode position), roll, curtain coating, and so on. In some embodiments, the type of coating application technique will be determined by many factors including part orientation, coating surface, etc. to identify the best process to be utilized. Typical painting and curing stations include one or more of water based, solvent based or UV cured painting and curing stations. In some embodiments, each painting station is an automated robot painter that can accommodate multiple spray heads to deliver the desired painting or coating. Parts are typically painted, cured and checked for defects. At the conclusion of the paint process, the system determines if the next station is ready 1112, for example, determines if the printing process is ready. If a printing station is ready, the selected batches or group of batches are moved to the printing process 1114. If the next station is not ready, the selected batches or group of batches are moved back into the inventory area 1104 as a work in progress. FIG. 16 provides one embodiment of the paint process 1110.

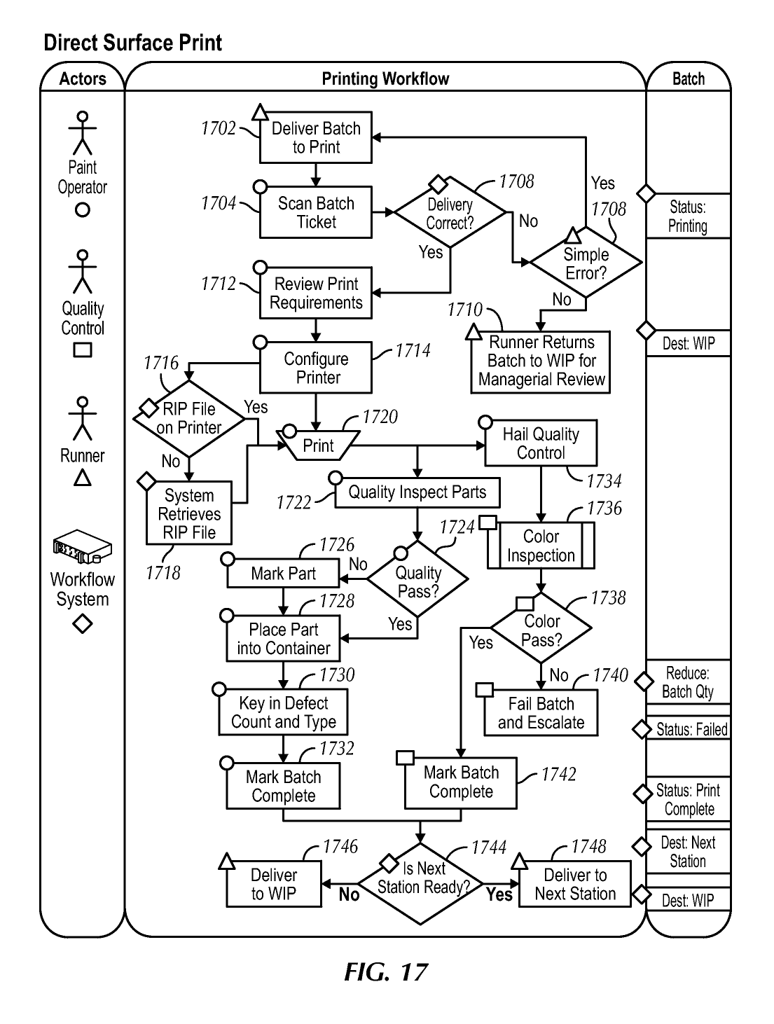

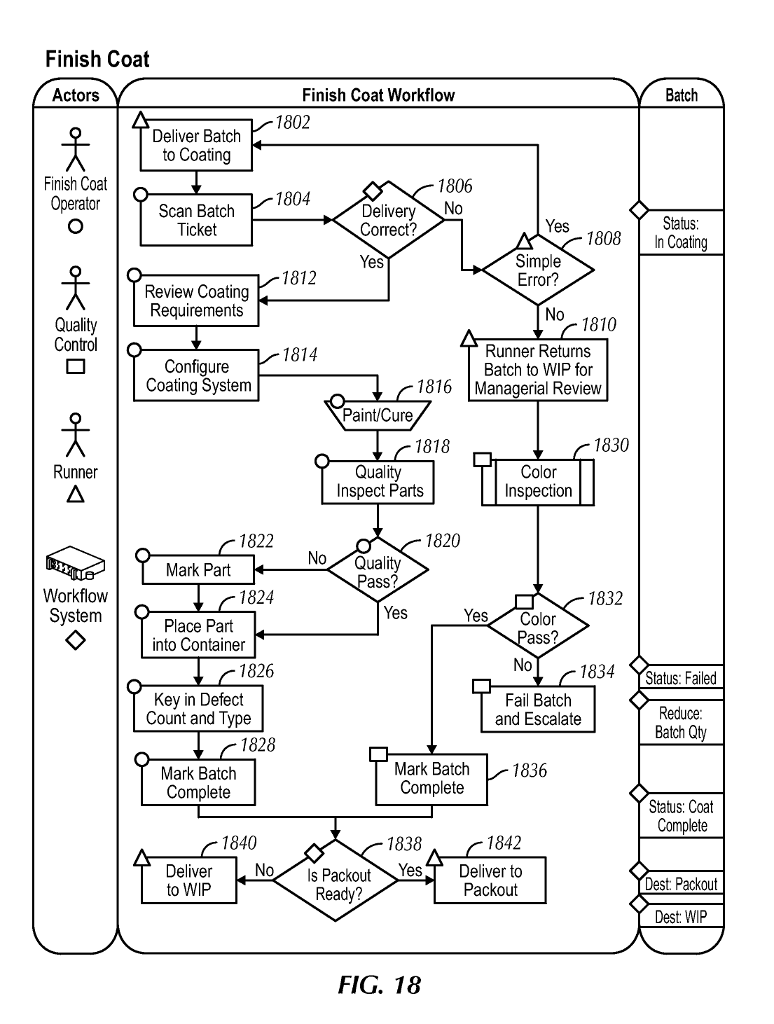

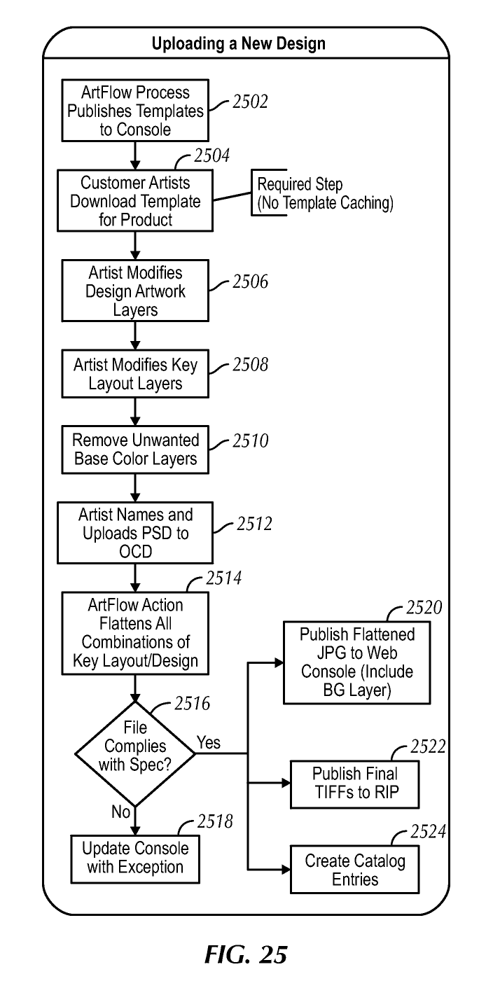

After base paint layer has been applied, and according to the image application schedule, batches are moved to a printing station comprising an array of printing devices to perform the printing process 1112. According to the production schedule and under the direction of the management platform, each batch is directed to a specific available printing device of the array of printing devices. In preferred form, each printing device is a LaserJet or UV curable ink printer capable of printing one or more colors direct to the surface of the component, whether a base paint layer has been applied or not. An example of a suitable printer is commercially available from Teckwin International of Shanghai, China. The management platform is also responsible for electronically delivering the image data needed to the specific printing device. In one embodiment management platform delivers a raster image processed (RIP) file to the printing device. In some embodiments, the RIP file is based on the received image and customization file, such as a PSD file (see also FIG. 25 for additional description of one embodiment relating to template and RIP file generation). Factory workers are responsible for moving the batched parts through the printing station and performing a color inspection and defect check. FIG. 17 provides one embodiment of the direct surface print process 1112, and FIG. 18 provides one embodiment of a color inspection process. Once the printing process is complete, the system determines if the next station is ready 1114. If the next station is not ready, the painted and printed batched parts are moved back to the inventory area 1104 as a work in progress. If the next station is ready 1114, the painted and printed batched parts are moved to the coat/finish station for the finish coat process 1116.

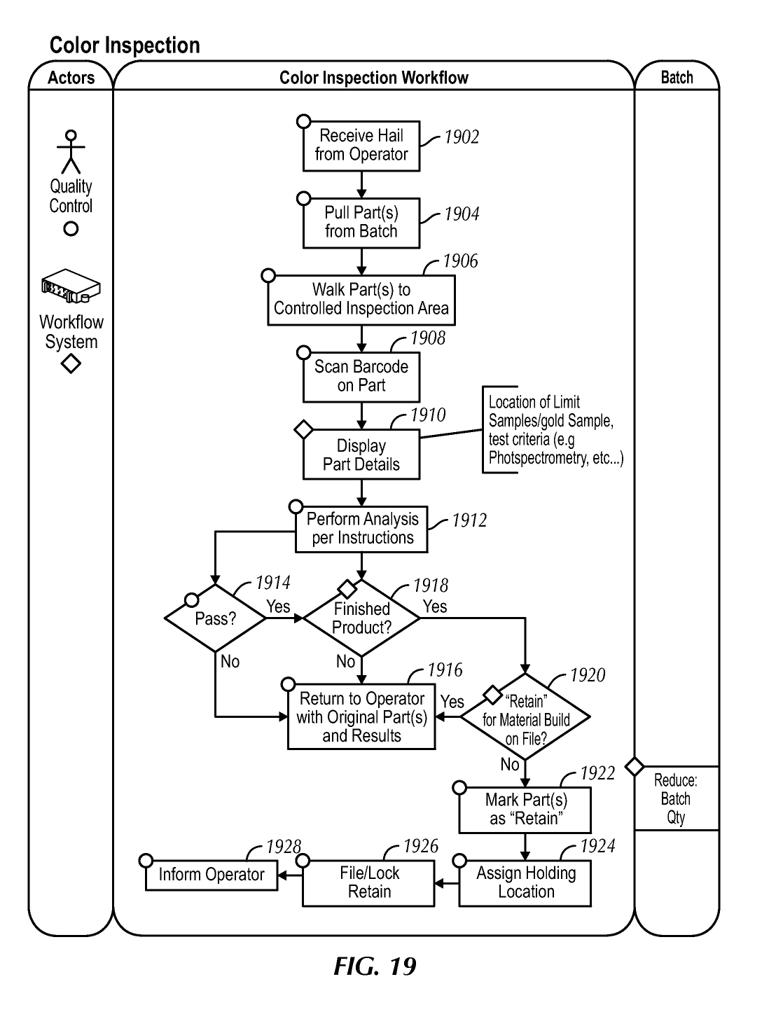

The finish coat process 1114 applies a protective coating layer at a specified hardness level as specified by the order. In some embodiments, the coating provides an additional color component and/or an etching or surface treatment of the finish coat. The finish coat is then optionally cured and again color is inspected. This station includes one or more coat/finish stations and corresponding one or more optional curing stations. Typical coating and curing stations are similar to painting and curing stations and can include one or more of water based, solvent based or UV cured painting and curing stations to apply and cure clear coats. Solvent paints are thermally cured whereas UV paints are cured with exposure to UV light. In some cases, an industrial coating is applied, for example, by UV curing coating machinery manufactured by Eodex Enterprises LTD of Taiwan. Again, curing stations may be needed depending on the coating chemistry or technology. In some embodiments, application methods of the coating may be automatically applied via robot, reciprocator and in the form of spray, dip (e.g., thermoplastic), roll, curtain coating, and so on. In some embodiments, the type of coating application technique will be determined by many factors including part orientation, coating surface, etc. to identify the best process to be utilized. In some embodiments, the clear coat finish is formulated to be a high gloss, semi-gloss, matte or soft-touch finish. In some embodiments, each painting station is an automated robot painter that can accommodate multiple spray heads to deliver the desired painting or coating. As the batched parts leave the finish coat process, they are moved to a holding area. Furthermore, in some embodiments, the finish coat process can be implemented to provide a specified hardness level. For example, in some embodiments, the finish coat provides performance and appearance standards as dictated by the end consumer In some embodiments, the final topcoat/print finish can be any hardness level, any gloss level, textured, soft touch (tactile) feel finishes, slip finishes, anti-fingerprint finishes, and/or any other finish coats known to those skilled in the art. FIG. 19 provides one embodiment of the finish coat process.

It is noted that although not illustrated, in some embodiments, surface pre-treatments may be applied using or more surface treatment devices. For example, when applying images to metal substrates, in some embodiments, an optional chemical film treatment layer is applied to the metal substrate using known chemical film treatment application devices. In other embodiments, any painted or printed layer may be plasma treated to modify (e.g., raise) dyne levels to ensure good adhesion for additional layers to be applied thereon. Such plasma treatment may be applied by plasma treatment devices as known in the art. For example, a base paint layer may be plasma treated prior to being printed with a direct to surface post mold printer to ensure good adhesion of the print layer to the base paint layer. Additionally, the print layer may be plasma treated prior to being painted with a clear or top coat to ensure good adhesion of the top coat layer to the print layer. Thus, any known pre-treatment techniques that correspond to one or more of the substrate materials and/or painting, printing, coating, or other image application techniques described herein or otherwise known in the art may be implemented.

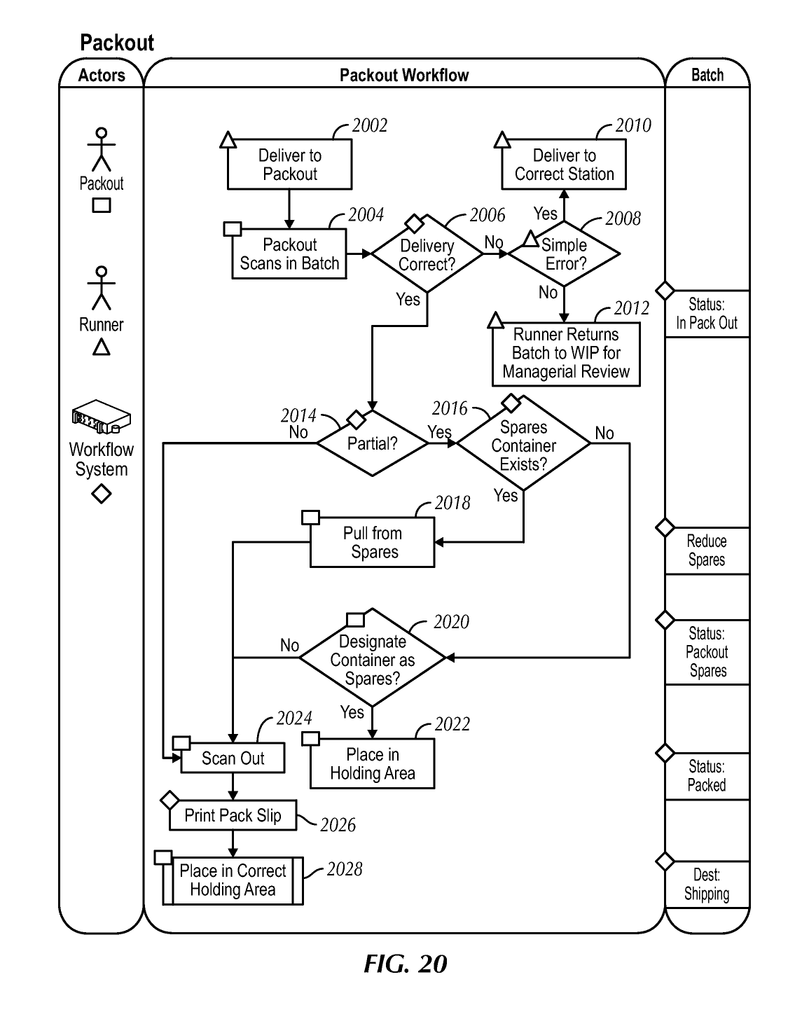

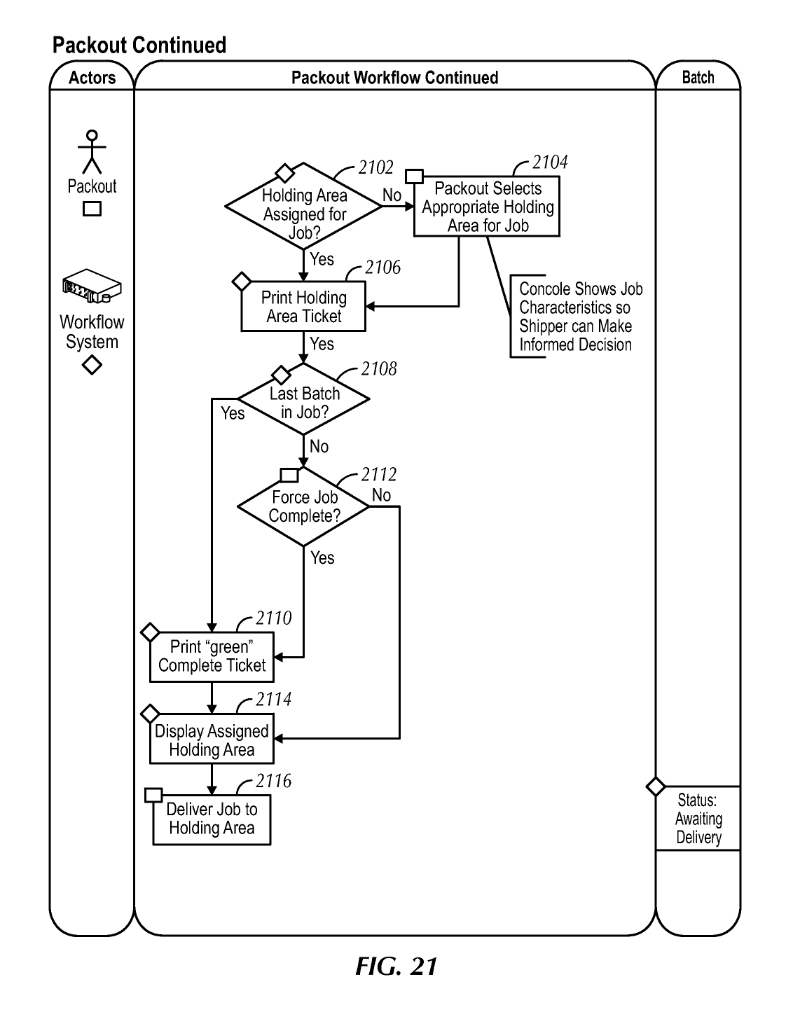

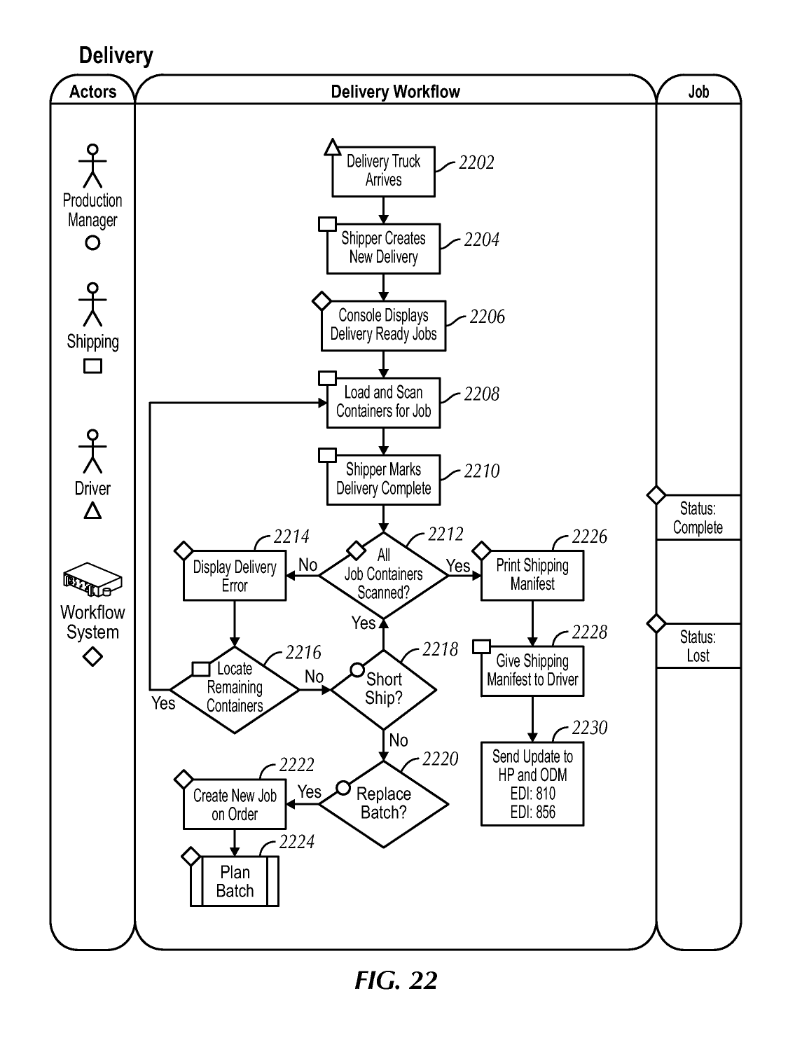

A packout process 1126 is performed in the holding area 1118. Generally, defective parts are removed and incomplete batches are combined with spares (for example, from other incomplete batches) to form complete and finished batches, which are located in holding areas 1128 containing groups of batches. Holding areas 1128 A, B, C and D are illustrated. FIGS. 20 and 21 provide one embodiment of the packout process. Batches ready for delivery are located in holding areas 1130, illustrated as areas E, F and G. The holding area location (e.g., A, B, C, D, E, F and G) of a given batch is entered into the management system to assist in delivery management. Next, the delivery process 1132 coordinates shipping addresses, shipping labels and delivery trucks of batches ready for delivery. Additionally, in some embodiments, the delivery process 1132 outputs signaling to the ODM or other entity that the customized parts will be delivered to. FIG. 22 illustrates one embodiment of the delivery process.

Accordingly, the flow through an on-demand customization facility of some embodiments generally entails receiving blank, un-customized parts which are sorted in a manner well-suited for delivery and processing in the facility. Orders for customized parts are received, processed and accepted if it is determined that the order can be fulfilled within a specified time. Parts are then moved to a painting and curing station to apply a base paint layer directly on the surface of the component. Next, the painted parts are moved to a direct surface printing station which applies the on-demand imagery as specified by the order. Next, the parts are moved to the finish coat station where finish coat is applied as specified by the order. Complete customized parts are organized for shipping and delivery and delivered to the appropriate customer. In some cases, the blank parts are pre-treated before being painted and/or printed and also in some cases, additional surface treatment, such as plasma treatment, is used to ensure good adhesion.

In several embodiments, the workflow within the facility under control of the management software platform ensures that the amount of time elapsed from receipt of the order to delivery of customized parts is on the order of hours. For example in one embodiment, an order may be completed within 24 hours. The number of painting, curing, printing, coating, pre-treatment and/or plasma treatment stations may be scaled as necessary to allow for large quantities parts to be processed within the same timeframe. For example, in the case of custom keyboards for a notebook style computer, some embodiments can process an order for up to 10,000 or up to 1,000,000 customized keyboards within 24 hours of order receipt. In this way, personalized or customized variable image data can be applied to blank parts and delivered to an ODM for assembly to create products for OEM and/or an end customer such as a retailer in a truly on-demand fashion. The following discussion of FIGS. 12-22 provides further details of a workflow process within an example image application facility in accordance with several embodiments.

Referring next to FIG. 12, one embodiment of the receiving process of FIG. 11 is shown. Initially, the raw materials are received from trucks and arrive at the facility (Step 1202). An inventory manager signs for receipt of the parts (Step 1204) and then selects the part number and enters the quantity received into the management system (Step 1206). At this point, the management system interface, also referred to as the console, displays (e.g., on a computer display or screen, or handheld display device) the received inventory as unsorted inventory, and increases the number of unsorted inventory by the quantity received (Step 1208). Next, an inventory worker initiates a preassembly job to organize, group, and/or preassemble parts under direction of the management system (Step 1210). For example, the management system displays preassembly instructions and creates a batch (Step 1212). In some embodiments, preassembly involves coupling the blank parts to a suitable fixture for use in the image application process. In other embodiments, blank parts are simply grouped, sorted, located or organized into batches without assembling them to fixtures. In other embodiments, the blank parts are already coupled to a suitable fixture and the blank parts are grouped, sorted, located or organized into batches. In one embodiment, the preassembly instructions may specify how many units are included in a batch and/or how they should be packed onto trays of a mobile cart with or without fixtures. Then, an inventory worker retrieves transport materials (Step 1214) and pulls a part or parts from the original container (Step 1216). The inventory worker then checks the quality of the part (Step 1218). If it fails, the part is put into defect pile (Step 1220) and entered as a defect in the management system (Step 1222). The management system decreases the number of unsorted inventory units by the defect. If the part passes the quality test, a batch barcode is placed into the part (Step 1224). In one form, the bar code matches that of the batch bar code. Then, the part is packed into a container (Step 1226), and the system decreases the number of unsorted inventory, and adds to the number within the filled batch. The system prints a label for the container (Step 1228), which in some cases, is the same barcode as that used for all parts of the container. The label is affixed and the container is then placed in the inventory (Step 1230). The worker continues with more parts until the number of remaining parts is not greater than the batch size defined by the management system (Step 1232). That is, when the number of remaining parts is greater than the batch size, the worker continues preassembling parts. When the number of remaining parts is not greater than the batch size, the preassembly is done (Step 1234) and the remaining unsorted parts are left in unsorted inventory.

Referring next to FIG. 13, one embodiment of the order entry process of FIG. 11 is shown. In this process, an order is received from the ODM system, for example via an EDI interface (Step 1302). The order includes a header, assembly, quantity, due date, and destination. In some embodiments, the assembly is a virtual SKU that corresponds to image and customization data that defines or points to the imagery to be applied to which components or parts. The management system then determines if the assembly is valid (Step 1304), and if not rejects the order (Step 1306). If the assembly is valid, the management system verifies that the blank components or parts are available to complete the order (Step 1308). For example, the system checks reserve inventory (Step 1310) and determines if inventory levels will remain within minimum and maximum levels (Step 1312), and signals the ODM (Step 1314) if additional blank parts are needed to complete the order or to keep inventory levels within the minimum and maximum levels after completion of the order. If the blank parts are available, the management system evaluates the current schedules and loads within the facility (Step 1316). The system then determines a due or completion date given the current workload, capacity and minimum and maximum levels (Step 1318). If it is determined that the order can be completed within a specified time, the order is automatically accepted by the system (Step 1320) and the response is sent to the ODM with the due date (Step 1322). The system may also check if lower priority orders would be affected by acceptance of the present order (Step 1324). If so, the due date and completion date of lower priority orders may be updated and communicated to the ODM via the EDI interface (Step 1326). When the order is accepted, the system creates a new order record. To manage the order, the order is split into one job per logical delivery, and the system creates new job records (Step 1328). In order to account for defects, the system increases the line item quantity of the order by a defect factor (Step 1330). Each job is then split into batches and the system assigns existing batches to the job (Step 1332). The system then plans a batch production schedule in order to coordinate the image application process throughout the facility (Step 1334).

Referring next to FIG. 14, a flowchart illustrates one embodiment of the steps involved in a batch production schedule process, such as performed within the image application facility of FIG. 11. Initially the system builds production requirements from the received assembly (Step 1402). For example, production requirements may specify at least one or more of the following: base paint color with or without edge fading; surface printing including variable image data defining text, font, color, graphics, pattern, images, region or language, and so on; finish coating including color, hardness, finish treatment, for example, or any other parameter described herein. For each requirement specified in the assembly (Step 1404), the system identifies all production stations capable of satisfying the requirement (Step 1406). For example, if base layer painting is required, the system identifies proper painting and curing station. The station to satisfy that requirement with the soonest availability is selected for the schedule (Step 1408) and that station is reserved in the production schedule (Step 1410). Further the system may also consider “recommendations” in production scheduling to select preferred stations among all the stations which satisfy all production requirements. The scheduling further sets a “start no sooner than constraint” for the next production process (Step 1412). Once specified for all requirements, the batch production scheduling process of this embodiment is complete (Step 1414).

Referring next to FIG. 15, a flowchart shows one embodiment of the steps involved in an inventory or work in progress dispatch process, such as performed within the image application facility of FIG. 11. At cycles, the management system reviews all planned batches (Step 1502) and determines if a planned batch is due on the floor for processing (Step 1504). If not, the batch will wait for the next cycle (Step 1506). If the planned batch is due on the floor, it is determined if the destination station is backlogged (Step 1508) and if so, the planned batch will wait for the next cycle (Step 1506). If the destination station is not backlogged and is available, the system creates a transport job with a status of “created” (Step 1510). Next, the console displays to a dispatcher all pending transport jobs, and the status of the transport job is changed to “pending” (Step 1512). An inventory manager selects the next job for transport (Step 1514), and the system sets the destination for the transport job at the next station. A runner then pulls the batch from inventory (Step 1516), for example, a batch of preassembled parts in a transport container or movable cart. If the transport container is not at inventory (Step 1518), the runner informs an inventory manager (Step 1520). If the transport container is found (Step 1522) the runner scans the barcode located on the batch which then displays the destination. The runner is then dispatched to the appropriate station (Step 1524). If the transport container is not found (Step 1522), it is checked to see if the transport container is in work in progress or is a raw container (Step 1526). If work in progress, the production manager can choose to re-batch the container or cancel (Step 1528). If the container is a raw container, the inventory manager marks the inventory as missing (Step 1530) and the next available batch is assigned to the existing transport job by the management system (Step 1532). If the station is ready (Step 1534), the operator of that station scans the batch in (Step 1536), and the status of the transport job is changed by the system to be “closed”. If the station is not ready, it is determined if it is critical in order to keep with the schedule (Step 1538) and if not, the transport container is returned to inventory is a work in progress until ready (Step 1540). If it is critical, the production manager redistributes the transport job as needed (Step 1542). Accordingly, the inventory and dispatch process is used to move containers, batches, or groups of batches from inventory or work in progress to different stations throughout the facility.

Referring next to FIG. 16, a flowchart illustrates one embodiment of the steps involved in a base paint process, such as performed within the image application facility of FIG. 11. According to the schedule, a batch to be painted is delivered to the paint station by a runner (Step 1602). The paint operator scans the batch ticket (Step 1604). The system checks to verify that the delivery is correct (Step 1606). If incorrect, it is determined if this is a simple error (e.g., adjacent station is the correct station) (Step 1608), and if so the batch is delivered to the appropriate paint station. If it is not a simple error, the runner returns the batch to work in progress for managerial review (Step 1610). If the delivery is correct, the paint operator reviews the paint requirements (Step 1612). The system changes the status of the batch to “painting”. The operator then configures the paint sprayer (Step 1614) and initiates the paint and/or cure operation (Step 1616). The paint operator then inspects quality of each part painted (Step 1618). If they do not pass quality (Step 1620), the part is marked (Step 1622) and placed into the container (Step 1624). If the part does pass quality, it is placed into the container (Step 1624). The paint operator keys in the defect counts and types into the system (Step 1626) and then marks the batch complete (Step 1630). Additionally, quality control inspects the color (Step 1632). If the color does not pass (Step 1634), the whole batch is failed and escalated to management (Step 1636). If the color passes, the batch is marked complete (Step 1638). When the paint operator and the quality control mark the batch complete, the system changes the status of the batch to “paint complete”. The management system then determines if the next station and the process is ready (Step 1640), and if not, the batch is returned to work in progress (Step 1642). If the next station is ready, the batch is delivered to the next station (Step 1644). The system changes the destination of the batch to be either print or work in progress.

Referring next to FIG. 17, a flowchart illustrates one embodiment of the steps involved in a direct surface print process, such as performed within the image application facility of FIG. 11. Initially, the runner delivers the batch to the print station (Step 1702). The print operator scans the batch ticket (Step 1704) and the system determines if the delivery is correct (Step 1706). If not correct, the runner checks if it is a simple error (Step 1708), and if yes, the batch is delivered to the appropriate print station. If it is not a simple error, the runner returns the batch to work in progress for managerial review (Step 1710). If the system determines that the delivery is correct (Step 1706), the system changes the batch status to “printing”. The print operator reviews the print requirements (Step 1712) and configures the printer accordingly (Step 1714). The system determines whether the proper RIP file has been sent to the printer (Step 1716) and if not, delivers the RIP file to the printer (Step 1718). The operator initiates the printing (Step 1720) and inspects quality of the printed parts (Step 1722) and contacts quality control (Step 1734). If the print operator determines that a part does not pass quality (Step 1724), the part is marked (Step 1726) and placed into the container (Step 1728). If the print operator determines that the part passes quality (Step 1724), the part is placed into the container (Step 1728). The print operator then keys in the defect count and types (Step 1730) and marks the batch complete (Step 1732). Additionally, quality control inspects the color (Step 1736). If the color does not pass (Step 1738), the batch is failed and escalated to management (Step 1740), and the system changes the status of the batch to “failed”. If the color passes, the batch is marked as complete (Step 1742). When both the print operator and the quality control mark the batch complete, the system changes the batch status to “print complete”. The management system then determines if the next station and process is ready (Step 1744), and if not, the batch is returned to work in progress (Step 1746). If the next station is ready, the batch is delivered to the next station (Step 1748). The system changes the destination of the batch to be either coat or work in progress.

Referring next to FIG. 18, a flowchart illustrates one embodiment of the steps involved in a finish coat process, such as performed within the image application facility of FIG. 11. Initially, a runner delivers the batch to the coating process (Step 1802) and the finish coat operator scans the batch ticket (Step 1804). Based on the scanned ticket, the management system determines if the delivered batch is correct (Step 1806). If not, the runner determines if this is a simple error (Step 1808), and if it is, delivers the batch to the appropriate coating station. It is not a simple error, the runner returns the batch to work in progress for managerial review (Step 1810). If the delivery is correct, the finish coat operator reviews the coating requirements (Step 1812). Example coating requirements may specify the coating materials, thickness, hardness, glossiness, and any surface treatment, for example. The management system changes the status of the batch to “in coating”. The finish coat operator then configures the coating system (Step 1814) and begins the painting and curing operation (Step 1816). Typically, this involves operating one or more coating and finishing stations and corresponding curing stations. The finish coat operator inspects the quality of the coated parts (Step 1818). If the part does not pass the quality inspection (Step 1820), the part is marked (Step 1822) and placed into the container (Step 1824). If the part does pass the quality inspection, the part is simply placed in the container (Step 1824). The finish coat operator then keys in the defect count (Step 1826) and type and marks the batch complete (Step 1828). Additionally, quality control expects the color (Step 1830). If the color does not pass (Step 1832), the batch is failed and escalated to management (Step 1834), and the system changes the status of the batch to “failed”. If the color passes, the batch is marked as complete (Step 1836), and the management system reduces the batch quantity. When both the finish coat operator and the quality control mark the batch complete, the system changes the batch status to “coat complete”. The management system then determines if the packout process is ready (Step 1838), and if not, the batch is delivered to work in progress (Step 1840). If the packout process is ready, the batch is delivered (Step 1842) to the holding area 1118 to begin the packout process 1126. The system changes the destination of the batch to be either “packout” or “work in progress”.

Referring next to FIG. 19, a flowchart shows one embodiment of the steps involved in the color inspection process, such as performed within the image application facility of FIG. 11. The quality control receives a hail from an operator (Step 1902) and pulls parts from the batch (Step 1904). The parts are moved to a controlled inspection area (Step 1906) and the barcode on the part is scanned (Step 1908). The system then displays the details to quality control (Step 1910), such as location of limit samples/gold samples, and test criteria (e.g., spectrophotometry, etc.). Quality control performs this analysis per the instructions (Step 1912) and determines if the part passes (Step 1914). If the part does not pass, the part is returned to the operator with the results (Step 1916). If the part passes, it is determined if the product is finished (Step 1918). If it is not finished, the part is returned to the operator (Step 1916). If the product is finished, the system determines if a retain for this material build (the raw materials used in the decoration process) is on file (Step 1920). In one embodiment, a retain indicates that a sample of parts (e.g., 1 or 2 parts) are held back (e.g., not delivered) and kept. Retains are kept so that if a customer begins to see an issue with a part (such as fading, bubbling, etc. . . . ), the ODC has a sample that was manufactured at the same time and with the same inks, paints, top coat, etc. . . . for comparison. If a retain is not on file the parts are marked (Step 1922) and assigned a holding location (Step 1924). Quality control stows and locks the retained part (Step 1926) and returns to the operator with the results of the inspection and to inform the operator that the parts have been retained (Step 1928). Otherwise, if a retain for this material build is already on file, then quality control simply returns with the parts and the results of the quality inspection (Step 1916).

Referring next to FIGS. 20 and 21, flowcharts illustrating one embodiment of the steps involved during the packout process, such as performed within the image application facility of FIG. 11. First referring to FIG. 20, a runner delivers the batch to packout (Step 2002), and the packout worker scans in the batch (Step 2004). The system determines if the delivered batch is correct (Step 2006) and if not, indicates so to the runner, who determines if this is a simple error (Step 2008). It is a simple error, the runner delivers the batch to the proper destination (Step 2010). It is not a simple error, the runner returns the batch to work in progress for managerial review (Step 2012). If the delivered batch is correct, the system changes the status of the batch to “in packout”. The system then determines if it is a partial batch or a complete batch (Step 2014). If it is a partial batch, the system determines if a spares container exists (Step 2016). If so, the worker is instructed to pull parts from the spares container to fill the batch (Step 2018), and the system reduces the quantity of spares. If no spares container exists (Step 2016), the worker determines if the batch should be designated as a spares container (Step 2020). If so, the container is placed in a holding area (Step 2022). If not, the partial batch is scanned out (Step 2024), and the system changes the status to “packout spares”. If the batch is not a partial batch (Step 2014) (i.e., it is a complete batch), a packout worker scans out the batch (Step 2024). At scan out, the system changes the batch status to “packed”. After scan out, the system prints a packing slip (Step 2026). The worker than places the batch in the proper holding area, and the batch destination is assigned to “shipping” (Step 2028).

Referring next to FIG. 21, the packout process is continued. The management platform determines if a holding area has been assigned the job (Step 2102). If not, the packout worker selects an appropriate holding area for the job (Step 2104). The console of the system shows job characteristics so the shipper can make an informed decision. If a holding area has been assigned for the job, the system prints a holding area ticket (Step 2106). If this is the last batch in a job (Step 2108), the system prints a green complete ticket (Step 2110). If not the last job, the worker determines if the job should be forced to be complete (Step 2112), and if so, the system prints a green complete ticket (Step 2110). If the job is not forced to be complete, the system displays the assigned holding area (Step 2114) and the packout worker delivers the job to the proper holding area (Step 2116). The system changes the batch status to “awaiting delivery”.

Referring next to FIG. 22, a flowchart illustrates one embodiment of the steps involved in a delivery process, such as performed within the image application facility of FIG. 11. Initially, a delivery truck arrives (Step 2202), and a shipping worker creates a new delivery (Step 2204). The management system displays delivery ready jobs on the console to the shipping worker (Step 2206). The shipping worker loads and scans containers for the job (Step 2208) and marks delivery complete (Step 2210). The system determines if all job containers have been scanned (Step 2212), and if not, displays a delivery error (Step 2214). If the shipping worker is able to locate the remaining containers (Step 2216), those containers are loaded and scanned (Step 2208) and the shipper marks delivery complete (Step 2210). If the worker is unable to locate the remaining containers, the production manager determines if delivery should be shipped short of completion (Step 2218). If it is determined not to short ship, the production manager then determines if the batch should be replaced (Step 2220) and if so, the system creates a new job on the order (Step 2222) and proceeds to plan batch scheduling (Step 2224). If it is determined to short ship (Step 2218), the system then determines if all job containers are scanned (Step 2212). If so, the management system prints the shipping manifest (Step 2226) and changes the job status to “complete”. The shipping worker gives the shipping manifest to the driver (Step 2228) and the system sends signaling (Step 2230) to the ODM and/or the OEM via the EEI interface.

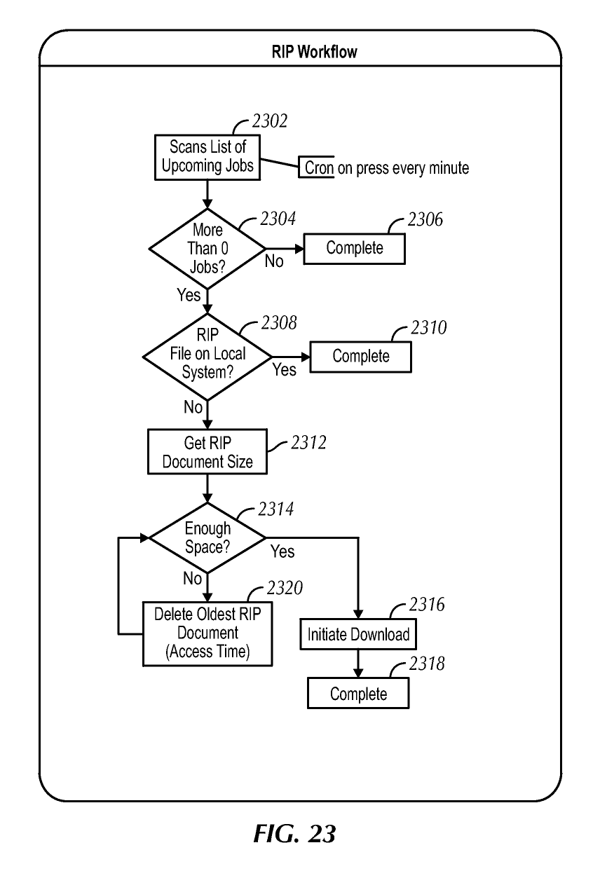

Referring next to FIG. 23, a flowchart illustrates one embodiment of the steps involved in a raster image processor workflow process, such as performed within the image application facility of FIG. 11. In one embodiment, the process of FIG. 23 works to support a direct surface printing process of FIG. 17, and is performed by the management system. The system scans a list of upcoming print jobs (Step 2302). In one embodiment, this is done every minute. If there are zero upcoming jobs (Step 2304), the RIP workflow is complete (Step 2306). If there are upcoming jobs, the system determines if the RIP file is stored on the local system (Step 2308), and if so the RIP Workflow is complete (Step 2310). If not, the system obtains the size of the RIP document (Step 2312). It is then determined if there is enough space for the RIP file (Step 2314). If so, the download of the RIP file is initiated (Step 2316) and the process is complete (Step 2318). If there is not enough space, the oldest RIP document is deleted (Step 2320), and it is again determined if there is enough space for the RIP file, until the file can be downloaded.

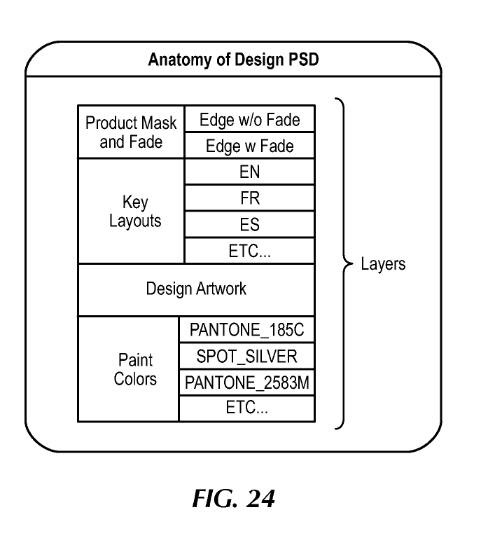

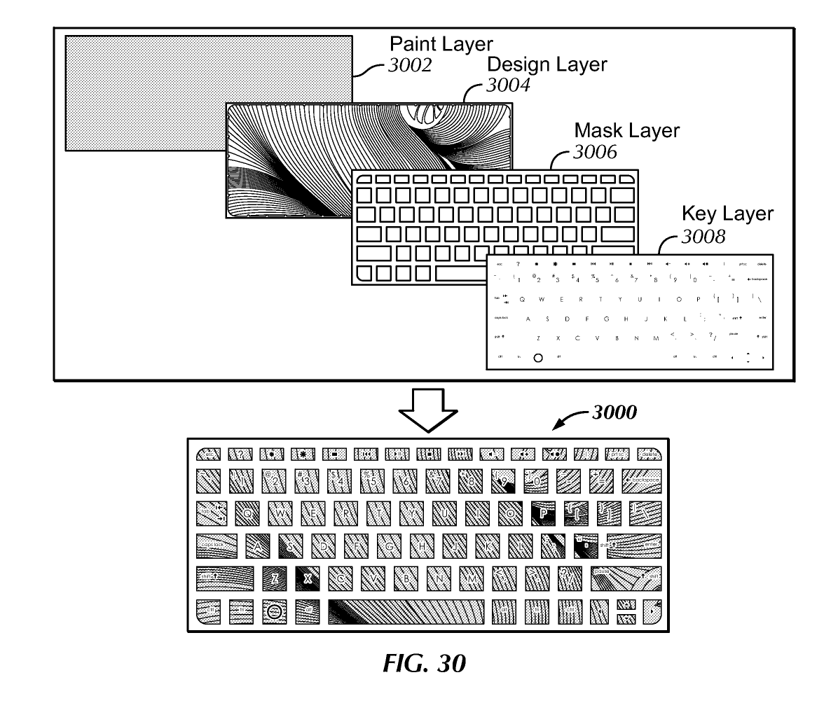

Referring next to FIG. 24, a diagram illustrates various layers of an image specification file or customizable design template that may be received with an order for customized parts or may be received from an OEM, for example, as a pre-approved template to be stored for later end customer selection from a catalog, in accordance with some embodiments. In the illustrated embodiment, the image specification file takes the form of a layer-based file format such as a PSD file. In some embodiments, there is a separate PSD file for each part that may be customized, the file specifying all parameters that may be customized by the end customer. The illustrated example PSD file is specific to a keyboard for a notebook style computer and includes product mask and fade layers, key layout layers, design artwork layers, and paint color layers. In the product mask and fade layer, the user may define an edge with or without fading. Generally, the mask layer defines the areas that will be masked off from the painting/printing processes. The key layout layer allows the user to specify language and/or regionalization for the keyboard. The design artwork layer provides for the selection of images, patterns, artwork, photographs, color, transparency, etc. The paint colors later allows for selection of base paint layer to be applied to the part. See also FIG. 30 for an example representation of these various layers. An advantage of the PSD file format is that the template may be edited in a variety of standard software applications by the end customer. Additionally, each combination of options defines a different Virtual SKU for the ODC. It is understood that PSD is one exemplary format of a layered image file and one example of an image specification file, and it is understood that other formats may apply in other embodiments.

Referring next to FIG. 25, a flowchart illustrates one embodiment of the steps involved in uploading a design or image for application to blank parts in accordance with one embodiment. Initially, customization templates are published to the console of the management system (Step 2502). In one embodiment, this is referred to as part of an ArtFlow process. Once in the console, in accordance with some embodiments, customization templates may be downloaded by the OEM (Step 2504). Accordingly, OEM artists download customization templates for particular product. In some embodiments, this is provided via an interactive interface provided by a hosted application to the remote users of the OEM, for example for a web or network connection, and does not allow the template to be cached at the OEM's local machine. OEM artists then modify the design artwork layers (Step 2506), key layout layers (Step 2506) and remove unwanted base color layers (Step 2510). In one embodiment, the OEM is effectively editing the template in the form of a PSD file. Then, the OEM artist names and uploads the edited PSD file back to the management system of the on-demand customizer (Step 2512). The art flow process then flattens all combinations of key layout and design (Step 2514) and determines if the file complies with the specification (Step 2516). If not, the console is updated with an exception (Step 2518). If it does comply with the specification, a flattened JPG file including a background (BG) layer is published to the web console (Step 2520). Also, final unique TIFF files are published to the raster image processor (RIP) (Step 2522) and the resulting RIP file is then stored in a database to which one or more post mold printing devices have access. It is noted that the TIFF file is specific to the selected combination of graphics, text, images, fonts, etc. selected by the OEM artists when editing the template. In some embodiments, the TIFF does not include the paint layer specifications. Catalog entries are then created (Step 2524) in order to create a database record of all assemblies (i.e., selected combinations of designs/text/colors/etc. . . . ) in a relational database. This is used for example, to verify an assembly is valid at order acceptance. It's also for general management, for example, if it is desired to search for all saved designs that required blue base paint, or other desired parameter. Once a catalog entry is created, in some embodiments, it is available for selection by end customers when ordering customized parts. That is, the catalog entry becomes an OEM pre-approved set of image and customization data that defines a pre-approved combination of customization parameters and imagery. In this way, end customers can select from several pre-approved library or catalog designs without having to create a template.

In other embodiments, as part of the ordering process, the end customer is provided with the ability to download, edit and submit an edited PSD file, at the time of placing an order. In this embodiment, when the RIP file is created, it is saved for access by the printing devices in order to complete the order. A catalog entry will also be created for future use if desired.

Referring next to FIG. 26, a flowchart illustrates one embodiment of the steps performed in enrolling a device to be personalized and customized in accordance with one embodiment. To enroll a general part to be able to be customized by the image application facility, raw materials are obtained (Step 2602). For example, a given part (e.g., a keyboard) to be set up in the system is received. Next, a fixture is prototyped (Step 2604) to allow the part to be efficiently used in the image application for example, and in one embodiment, the fixture will hold the part in the desired orientation when used in a direct surface printing device. The fixture will depend on the dimensions and shape of the blank part and the portion/s to be painted and/or printed. The template image and customization file is then designed (Step 2606), such as a template PSD file. Print tests are then run (Step 2608), and it is determined if the results are approved (Step 2610). If not, one or both of the prototyped fixture (Step 2604) and template file are redesigned (Step 2608). Print tests are run again until the results are approved. Once approved, the print layout (Step 2612) and fixture are finalized (Step 2614). Additionally, the raster image processor workflow is finalized (Step 2616) and a hot folder is created. In some embodiments, a hot folder is a folder watched by the management system. When files are placed in hot folders, the system performs an action. In one embodiment, a TIFF may be published to the raster image processor (RIP) by placing the TIFF in a hot folder. This then alerts the RIP that there is a TIFF to process. In some cases, different hot folders may indicate a different configuration or operation. For example, a TIFF placed in a hot folder having certain configuration information (e.g., a color profile) will provide a different resulting RIP file than the same TIFF placed in a hot folder with different configuration information. Once the print layout is finalized, the product is added to the catalog (Step 2618) and is now ready for users to download and place on demand orders for customized parts.

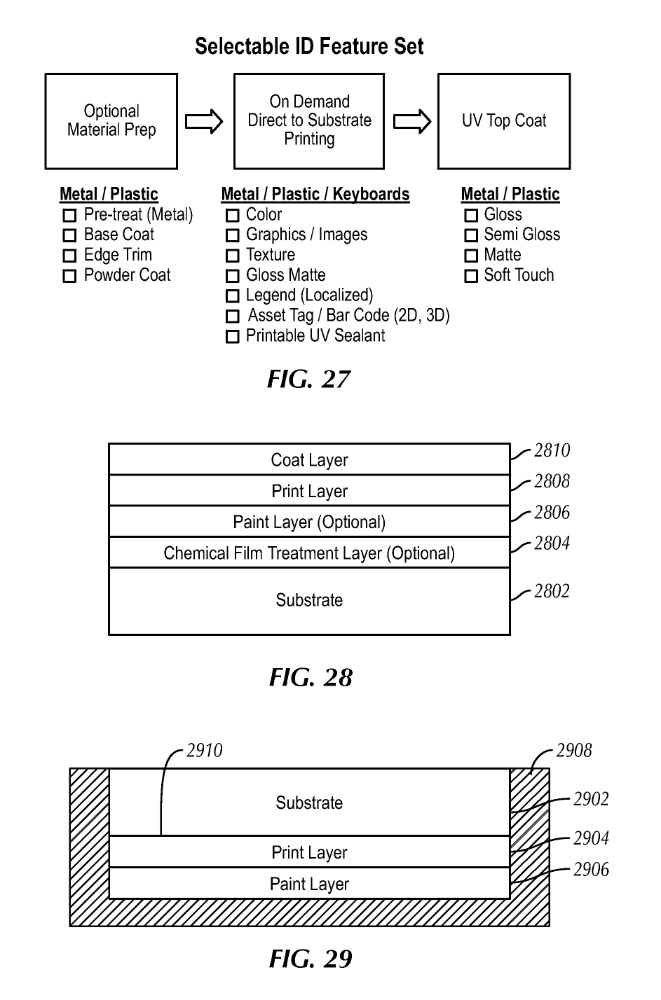

Referring next to FIG. 27, a diagram illustrates various selectable features that may be specified by an end-user when placing an order for customized parts or may be specified by an OEM or other entity when setting up a catalog entry for an available and pre-approved set of customized imagery for later selection by an end customer in accordance with one embodiment. This diagram is not meant to be an exhaustive list of all selectable features, and may further include other features or parameter selections described herein. Optional material preparation parameters for metal or plastic parts include a pre-treatment (typically for metal), base coat, edge trim and/or powder coat. On demand direct to surface substrate printing options for metal or plastic parts, including keyboards, include color, graphics/images, texture (e.g., laser etched texture, topographical texture, printed texture through selective application of print layers), gloss matte, legend (localized), asset tag/barcode (either 2D or 3D barcode), and/or printable UV sealant. UV topcoat options for metal or plastic parts include gloss, semi gloss, matte and/or soft touch. It is understood that any other options such as described herein may also be included such as text, size, font, language, transparency, etc.

Referring next to FIG. 28, an illustration is shown of a layering diagram of imagery applied to a substrate in accordance with several embodiments. The layering diagram of FIG. 28 may be created using any of the devices and techniques described herein. Initially, a substrate 2802 is provided. The substrate may be any material, such as metal, plastic, ceramic, glass, fabric, etc., or any combination thereof. Additionally, the substrate may be flat or have other dimensions or curvature depending on the part. The substrate may also be configured to be permanently or removably attachable to the customized product or integrated with the customized product.

In the event the substrate 2802 is metal, in some embodiments, a chemical film treatment layer 2804 is applied using known chemical film treatment processes. The chemical film treatment layer may be applied in advance of an order or may be done on demand when an order is received.

In the event the substrate is plastic, a chemical film treatment layer is not applied, and in some cases, the surface of the substrate 2802 is plasma treated to raise dyne levels to ensure good adhesion. As is known in the art, plasma treatment is an electrostatic process that removes oils from the surface and raises dyne levels to create attraction between molecules. In some embodiments, a primer layer (not shown) or other adhesive layer (not shown) may be applied as needed depending on the material of the substrate 2802.

In the event the substrate 2802 is glass or ceramic, no chemical film treatment layer is applied, but an optional plasma treatment may be performed.

Next, and optionally, a base paint layer 2806 is applied to the substrate or the chemical film treatment layer depending on the substrate material, for example, using a solvent or UV painting process. Again, a plasma treatment may be applied to the base paint layer once cured to ensure good adhesion to any layer applied thereon. Again, although not shown, in some cases, an adhesive layer may be applied over the base paint layer 2806.

Next, a print layer 2808 is applied to the base paint layer 2806 or optionally, to the substrate 2802 or chemical film treatment layer 2804. The print layer 2808 may be applied using solvent or UV based printing or other techniques described herein. Again, a plasma treatment may be applied to the print layer once cured to ensure good adhesion to any layer applied thereon. Again, although not shown, in some cases, an adhesive layer may be applied over the print layer 2808.

Next, a top or coat layer 2810 is applied to the print layer 2808 to seal the customization. For example, the coat layer is a solvent based or UV cured paint layer. In some cases, an industrial coating is applied, for example, by UV curing coating machinery manufactured by Eodex Enterprises LTD of Taiwan. In some embodiments, the clear coat finish is formulated to be a high gloss, semi-gloss, matte or soft-touch finish.

Additionally, it is understood that the base paint layer 2806, the print layer 2808 and the coat layer 2810 may use materials or be applied or formed using any of the materials, techniques, processes, technologies described herein or as understood by those of ordinary skill in the art.

It is noted that in some embodiments, additional layers may be provided. Additional layering diagrams more specific to pressure sensitive adhesive substrates are described in U.S. patent application Ser. No. 11/726,960, filed Mar. 23, 2007 and entitled “Adhesive Cover for Consumer Devices”, published as US Publication No. 2008/0233326; and U.S. patent application Ser. No. 11/759,600, filed Jun. 7, 2007 and entitled “Fishing Lures and Adhesive Cover for Same”, published as US Publication No. 2008/0104880, both of which are incorporated herein by reference.

Referring next to FIG. 29, an illustration is shown of a layering diagram of imagery applied to a second surface of a substrate in accordance with several embodiments. In this embodiment, a second or through surface 2910 of a glass substrate 2902 is customized. In some embodiments, the glass substrate 2902 is at least partially light transmissive. Since it is a glass substrate, no chemical film treatment is needed, and a print layer 2904 is applied to the through surface 2910 of the substrate 2902. Then an optional paint layer 2906 is applied over the print layer 2904. In one embodiment, the print layer provides imagery and the paint layer is a base or background color to the print layer, such as white or other color. Furthermore, although not illustrated, an optional coat layer may be applied over the paint layer 2906. Once cured, in some embodiments, the substrate 2902 is inserted into a receiving opening of the holding structure 2908 of the device, product or part to be customized. The opening formed in the structure 2908 may take the form of a recess formed in the structure and sized to fit the glass substrate. The glass substrate is adhered, snapped into or friction fit into the opening. Thus, the glass substrate acts as a protective top coat layer. Additionally, the customization is provided whereby the imagery is applied on the second or through surface 2910 of the substrate 2902 and visible to consumers through the substrate 2902 in a unique visual effect for the comsumer. It is noted that the order of the print layer and paint layer are reversed relative to the embodiment of FIG. 28 since the print layer is intended to be viewed through the substrate in FIG. 29 and not in FIG. 28.

Referring next to FIG. 30, is an illustration of layers separately configurable to define imagery to be applied on-demand to a keyboard for a computer device in accordance with one embodiment. The imagery 3000 includes a paint layer 3002, a design layer 3004, a mask layer 3006 and a key layer 3008. The paint layer 3002 defines a base coat of paint having a specified color to be initially applied to the substrate of the component. In some cases, the paint layer is applied by paint application device, such as a solvent or UV based painting device. The design layer 3004 defines an image, pattern, graphic, photographic image, and/or combinations of these including one or more colors. The image of the design layer is positioned such that the end image will be superimposed over, or at least partially extend over, or at least be partially contiguous over at least one or two of the plurality of keys. In some embodiments, the design layer is applied using a direct print to substrate printing process, such as using an UV curable ink or solvent printing device or LaserJet printing device. In the illustrated case, the image of the design layer is to be applied over all of the keys. The mask layer 3006 defines areas where image application is to occur and not occur on the component. For visualization, the mask layer is applied to both the painting process and the printing process. The key layer 3008 adds an additional element of customization in the functional printing of the keys on the keyboard. The key layer may define the regional language original specification of the keyboard as well as color, size, style, font and size of the text and symbols to appear on the keys. In this way, the customer may specify an English QWERTY keyboard, a German QUERTZ keyboard, a Chinese keyboard, etc. In other embodiments, the key layer may include printed short cuts for commonly used programs, such as company specific programs or gaming shortcuts depending on the customization. In accordance with several embodiments, the various layers are defined in the customer order as specified in the image and customization data of the order. In one example, such image and customization data appears within a design template in the form of a PSD file including all selectable options as edited and customized by the end customer. In some embodiments, the mask layer 3006 is created from a file specifying the physical dimensions and proportions of the part to be customized. For example, a CAD file or other file specifying dimensional data is used to create the mask layer. Additionally, it should be clear that the mask layer 3006 is specific to the part to be customized, in this case, specific to a certain keyboard. As can be seen, the final image data applied to the blank keyboard will include color, pattern, and key language and regionalization information. Additionally, it is understood that the paint layer 3002, the design layer 3004, the mask layer 3006 and the key layer 3008 may use materials or be applied or formed using any of the materials, techniques, processes, technologies described herein or as understood by those of ordinary skill in the art.

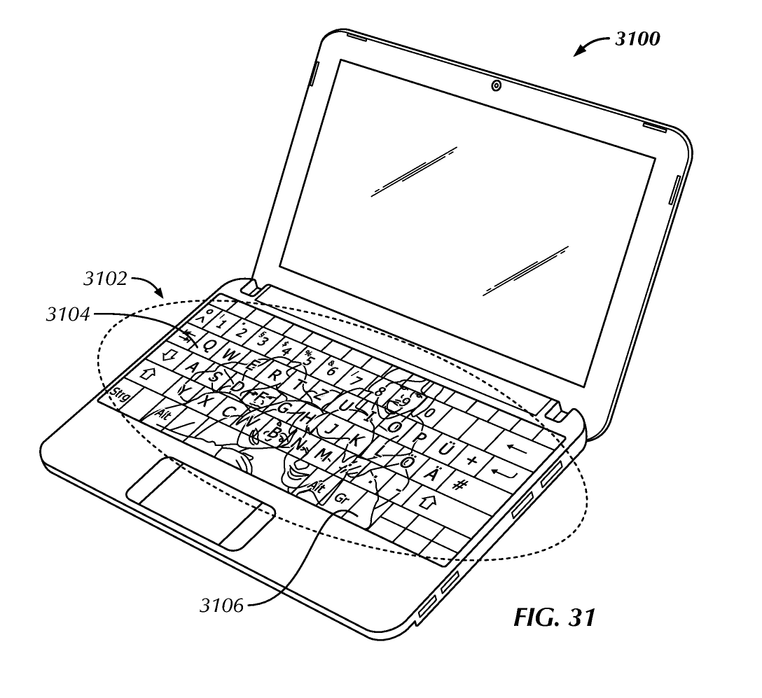

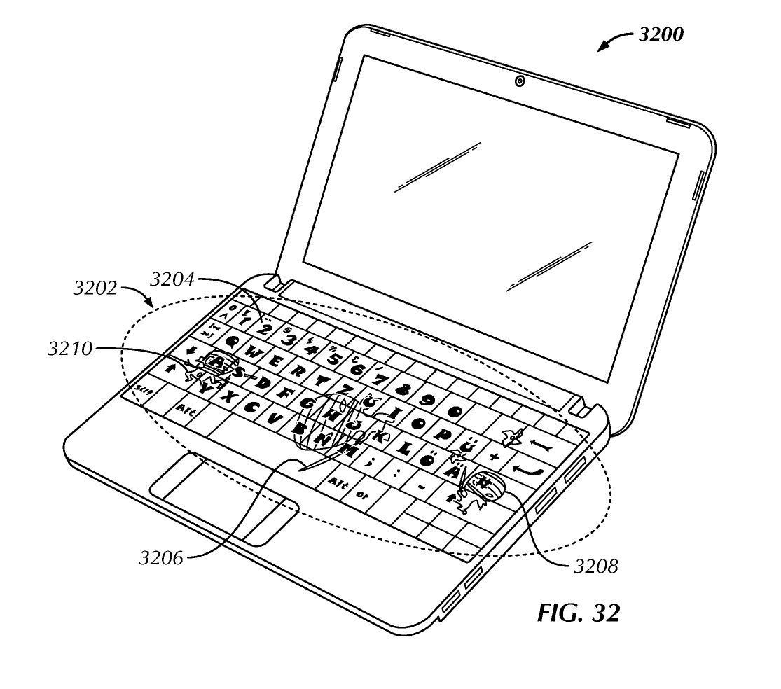

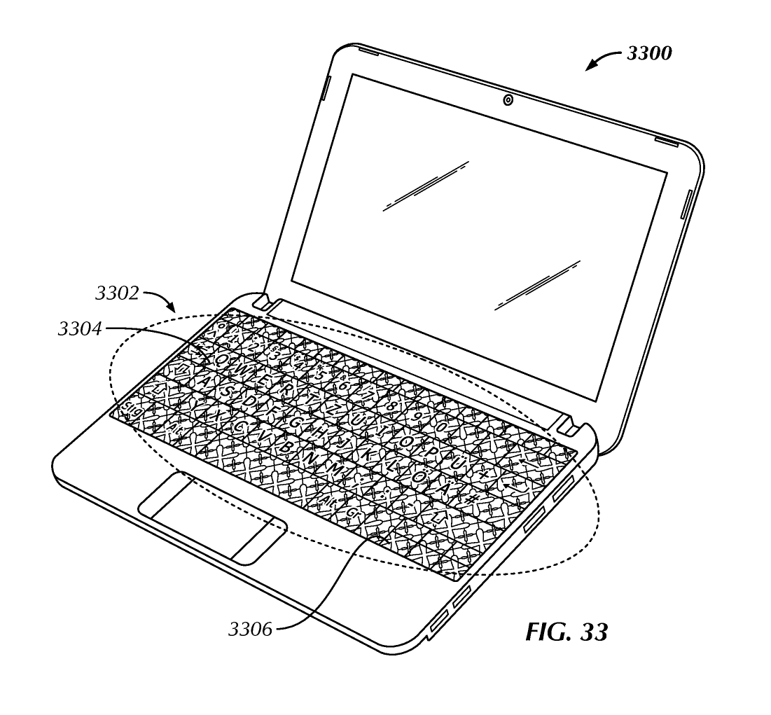

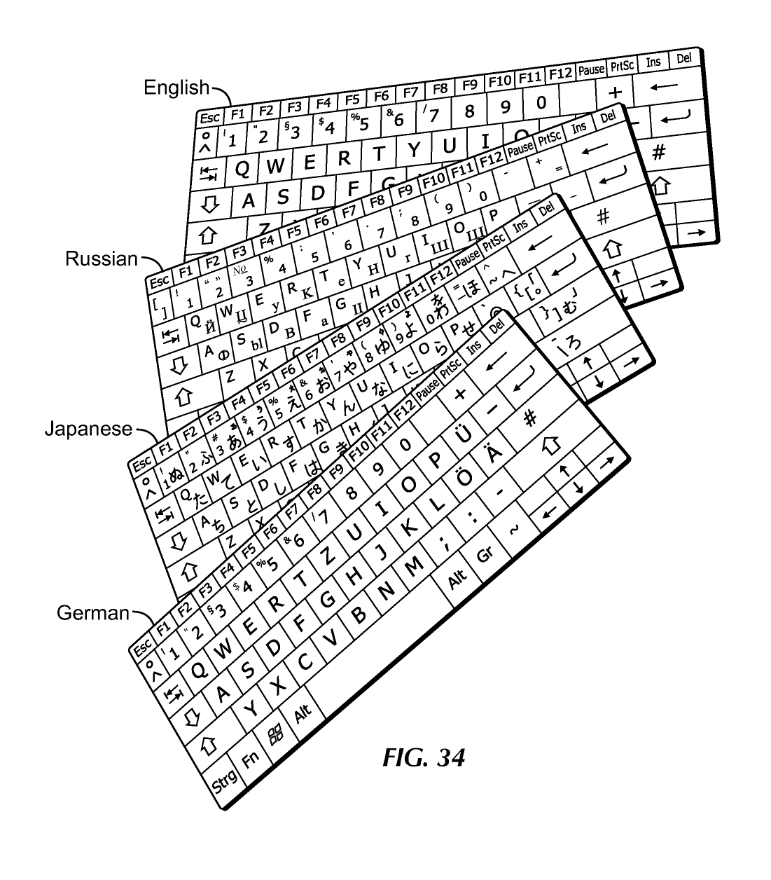

Referring next to FIGS. 31-33, exemplary notebook style computers 3100, 3200, 3300 are illustrated that include various keyboards customized with various imagery applied on-demand, for example by an ODC. Generally, each keyboard includes a key receiving structure that includes a plurality of keys coupled thereto. For example, the key receiving structure may be the tray including physical and electrical connections to the tray. The tray may mount into the base of a notebook or netbook computer or may mount into the body of a free-standing keyboard. Also, each key has at least one key label corresponding to at least one function of the key (e.g., “Q”, “W”. “ENTER”, “ [symbol] ”, “CAPS LOCK” and so on). In the embodiment of FIG. 31, the imagery includes an image 3102 comprising a basecoat color (e.g., white fading to blue, not visible in FIG. 31), text 3104 (QUERTZ key text in a specific style, size, font) and including a photograph 3106 superimposed over and spanning at least a portion of some of the keys. In the embodiment of FIG. 32, the imagery 3202 includes an image comprising a basecoat color (e.g., turquoise, black, gray, etc. (not shown in FIG. 32)), stylistic text 3204 (QUERTZ text and specific style and font or theme) and including design artwork 3206, 3208, 3210 (e.g., cartoon-like graphic images) applied on (spanning over) at least a portion of several of the keys. In the embodiment of FIG. 33, the imagery 3302 includes an image comprising a basecoat color (e.g., gray and black (not shown FIG. 33)), text 3304 (e.g., QUERTZ keyboard in a specified font/style) and including patterned design artwork 3306 superimposed on and spanning across all keys in accordance with another embodiment. It is noted that when using the term superimposed, it is not required that the superimposed image will appear on top of other layers. The image and customization data will define which layers are applied over other layers. In the case of FIGS. 31-33, in one embodiment, the paint layer is first applied, then the design layer and then the key layer. In the embodiment of FIG. 34, imagery for the key layer is show illustrating regional and language customization options in accordance with one embodiment. For example, illustrated are a German QUERTZ key layer, a Japanese QUERTY key layer, a Russian QUERTY key layer, and an English QUERTY key layer. In one or more embodiments of the devices of FIGS. 31-33, an image is superimposed on and spanning at least a portion of two or more of the plurality of keys, each key generally having at least one key label corresponding to at least one function of the key. In some embodiments, the image is configured such that each of the keys has a unique appearance apart from the key label/s. In some embodiments, the image spans across at least a portion of at least two adjacent keys and includes image portions on at least two adjacent keys, such that the image portions are configured to cooperate with each other to form the image or a portion of the image. It is noted that in the context of images spanning across multiple keys, each key may be generically referred to as a component of a device having an image layer comprising an image applied thereto, such that the images cooperate to form a larger image.

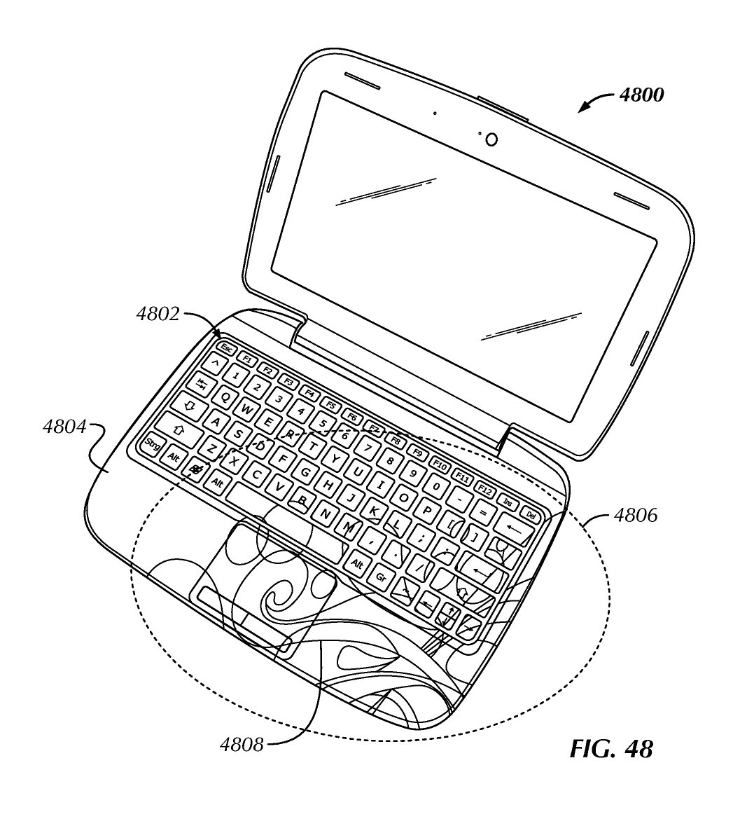

Referring next to FIG. 48, an exemplary notebook style computer 4800 is shown including a keyboard 4802 and surrounding tray portion 4804 (often referred to as a “C cover”) customized with an image 4806 comprising multiple colors (not shown in FIG. 48) and including design artwork 4808 in accordance with another embodiment. The keyboard 4802 includes a key receiving structure that includes a plurality of keys coupled thereto as described above. For example, the key receiving structure may be the tray including physical and electrical connections to the tray. The tray may mount into the base of a notebook or netbook computer or may mount into the body of a free-standing keyboard. Each key also has at least one key label corresponding to at least one function of the key (e.g., “Q”, “W”. “ENTER”, “ [symbol] ”, “CAPS LOCK” and so on). The computer device also includes a tray cover portion 4804 peripherally surrounding at least a portion of the plurality of keys. As illustrated, the tray cover portion is substantially in a plane defined by the keyboard; however, in other embodiments, the tray cover portion is not be so configured. Further, in some embodiments, the tray cover portion 4804 is rigid and an integral portion of the computer device. In some embodiments, the tray cover portion is referred to as a “C Cover”. In FIG. 48, the keyboard 4802 and tray cover portion 4804 are customized with an image superimposed on and spanning at least a portion of at least one of the keys and at least a portion of the tray cover portion. For example, a multi-color pattern extends over several keys and a portion of the tray portion. It is noted that although the illustrated image 4806 includes multiple colors in a larger pattern, in some embodiments, the image includes one or more of stylistic text, a logo, artwork, a photograph, and a pattern. Furthermore, the image of FIG. 48 includes image portions on at least one key and on at least a portion of the tray cover portion, such that the image portions are configured to cooperate with each other to form the image 4806 or a portion of the image (i.e., a larger multiple color swirling pattern). Similar to that described above, in some embodiments, the image spanning the key/s and a portion of the tray cover portion and how it is applied is defined by the image and customization data discussed above. It is noted that in the context of images spanning from one or more keys to a tray portion, each key and the tray portion may be generically referred to as a component of a device having an image layer comprising an image applied thereto, such that the images cooperate to form a larger image.

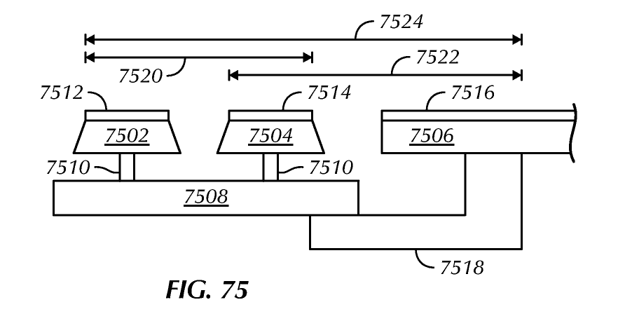

Referring next to FIG. 75, a side view is shown of the layers and image cooperation between different components of a customized product in accordance with several embodiments. Illustrated are three components 7502, 7504 and 7506. It is understood that these components may be any components of a device to be customized. The components are separate physical components that when assembled into the product are held in a fixed relationship to each other. In this example, components 7502 and 7504 are keys of a keyboard for a computer type device, and component 7506 is a tray portion that surrounds at least a portion of the components 7502 and 7504. A coupling structure is used to hold components 7502 and 7504 in a fixed position relative to each other. In this example, the coupling structure is a key receiving structure 7508 including posts 7510 that attach to an underside of components 7502 and 7504. Coupling structure 7518 (directly or indirectly) rigidly couples component 7506 in a fixed relationship to components 7502 and 7504. It is understood that many possible coupling structures are possible and will depend on the nature of the product and the components.

Also illustrated are image layers 7512, 7514 and 7516 applied over respective components 7502, 7504 and 7506, respectively. The image layers may be applied in any of the ways described herein or otherwise. In one or more embodiments, the image layers each comprise respective images and the images are applied and configured such one or more of the images form a larger image that spans across the components, such as illustrated in FIGS. 31-33 and 48. For example, larger image 7520 may be formed by the images on of image layers 7512 and 7514; larger image 7522 may be formed by the images on of image layers 7514 and 7516; and larger image 7524 may be formed by the images on of image layers 7512, 7514 and 7516. The images of the individual image layers 7512, 7514 and 7516 may be any combination of color, text, imagery, etc. such as described herein. In some embodiments, the images minimally include a design, image, photograph, artwork, or pattern, for example. Again, while the specific examples provided herein relate to keys and surrounding trays, this may apply to numerous other customized products having components with cooperating imagery.

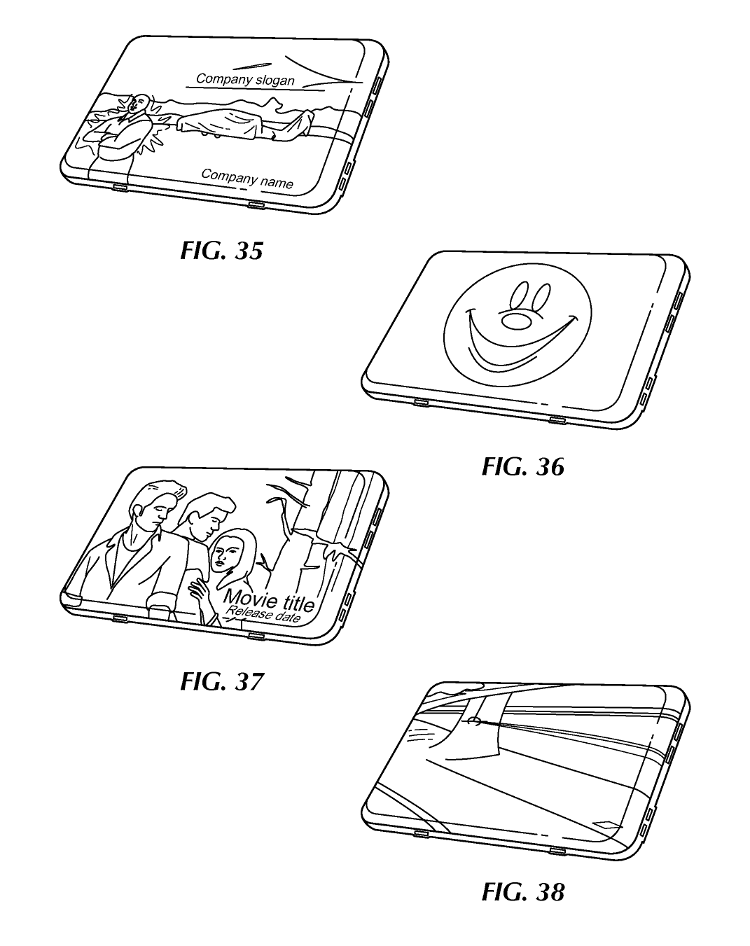

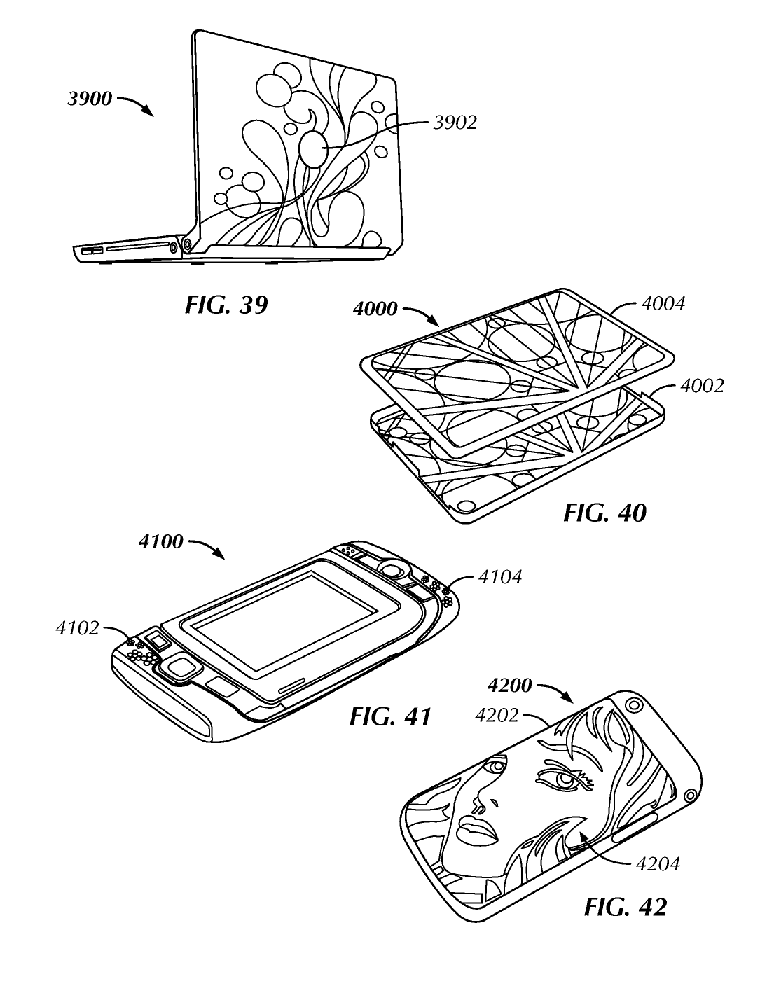

Referring next to FIGS. 35-39, exemplary notebook or netbook style computers are illustrated in which the display screen back cover or lid (referred to as the “A cover”) is customized with an image comprising one or more of color, text and including design artwork in accordance with several embodiments. For example, in one embodiment, the imagery is applied to the cover during manufacturing and the customized cover is assembled in the completed computer for sale to consumers. FIGS. 35-39 show various examples of customization options. For example, the cover of FIG. 35 may be customized for corporate users including one or more corporate colors, images, logos, slogans, symbols, images. In some embodiments, this allows corporate computer purchasers to order computer devices that are customized to include one or more of enterprise level specific imagery, employee specific imagery, divisional specific imagery, location specific imagery, etc., to be used for a variety of purposes including educational, promotional, motivational uses, etc. The cover of FIG. 36 is customized with artwork, such as licensed artwork, or other imagery believed by the end customer to represent current customer demand. The cover of FIG. 37 is customized with licensed imagery and includes promotional information or advertising. For example, the cover of FIG. 37 is promoting the coming release of a movie and includes images from the movie promotional artwork, movie title, release date and another information useful in the promotion. The cover of FIG. 38 is customized with artwork that is selected from a library of original or licensed content. The cover of the computer 3900 of FIG. 39 is customized with artwork with the computer manufacturer logo 3902 having been masked such that the imagery is applied (e.g., painted and/or printed) about the logo 3902.

Referring next to FIG. 40, an exemplary notebook style computer case 4000 is illustrated that includes a bottom shell 4002 and a top shell 4004 customized with imagery in accordance with another embodiment. In this embodiment, imagery is applied to both the bottom shell and the top shell. Once customized, the shells are snapped, adhered, or friction fit into position in order to customize the notebook style computer. In some embodiments, the substrate of the shells may be opaque or may be at least partially light transmissive adding a further feature of customization.

Referring next to FIG. 41, an exemplary mobile phone 4100 is shown in which a portion of its housing is customized with imagery in accordance with another embodiment. That is, part/s 4102, 4104 of the plastic housing or outer plastic shell forming the mobile telephone has imagery (e.g., color and pattern, color not illustrated in FIG. 41) applied thereto. Referring next to FIG. 42, an exemplary mobile phone 4200 is shown in which a battery cover 4202 is customized with imagery 4204 in accordance with another embodiment. In this embodiment, the mobile telephone may be purchased by the customer according to the in-box model in which the phone includes the custom battery door when purchased. Alternatively, the telephone may be purchased with a standard battery door according to the out of box model and the customized battery door is ordered to replace the existing standard battery door.

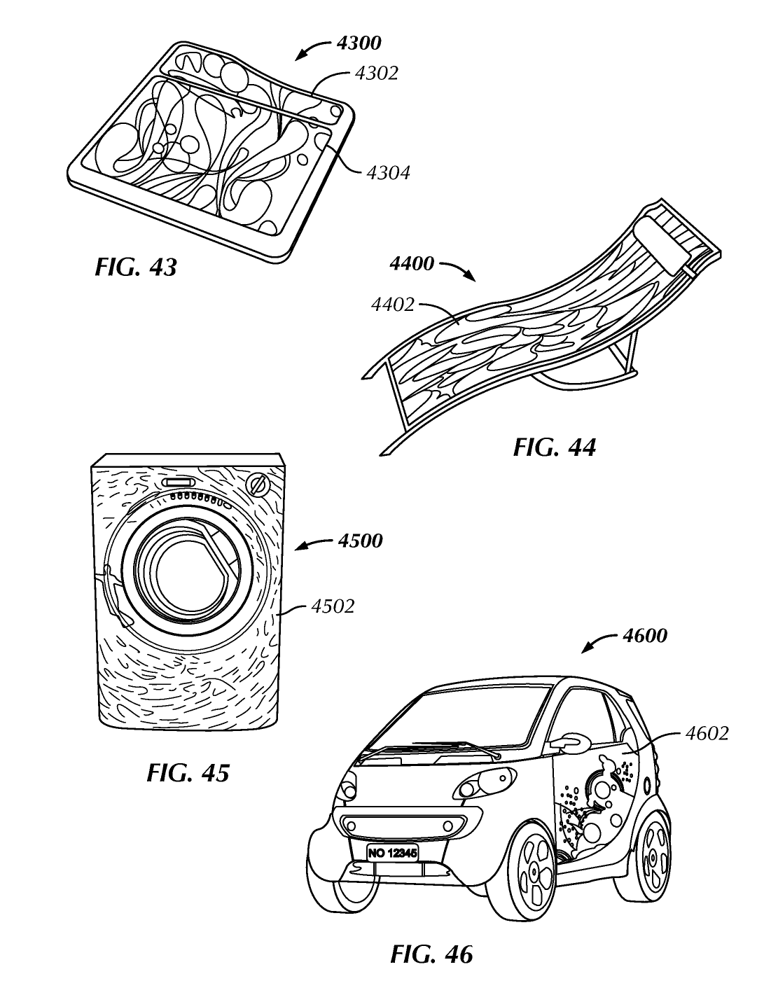

Referring next to FIG. 43, an exemplary case 4300 is shown for a notebook style computer, portions 4302, 4304 of the case being customized with imagery in accordance with another embodiment. In this embodiment, the portions of the case that is customized according to one or more embodiments described herein is a fabric substrate that may or may not be positioned over a hard shell. Referring next to FIG. 44, an exemplary chair 4400 in which a fabric portion 4402 is customized with imagery in accordance with another embodiment. In one embodiment, the fabric is customized by the ODC for assembling into the chair by the ODM.

Referring next to FIG. 45, an exemplary washing machine appliance 4500 is illustrated and includes a front panel 4502 which is customized with imagery in accordance with another embodiment. In this case, the substrate may be metal, plastic or other material and the imagery is applied thereto. The front panel 4502 is then assembled into the final custom washing machine. Referring next to FIG. 46, an exemplary automobile 4600 is shown in which one or more body panels 4602 are customized with imagery in accordance with another embodiment. For example, door panels may be provided to the ODC for imagery to be applied thereto, then the customized panels are delivered to the ODM (or other car manufacturer) for final assembling into the custom car. In some cases, users may order custom door panels after purchase of the car to replace standard door panels.

It is understood that while several examples are provided specific to the customization of keyboards and covers for notebook and netbook style computers one or more embodiments allow similar customization to other parts of the device or product. For example, in the context of computer products, covers (e.g., see FIGS. 35-39), bezels, tray covers, touchscreen materials, etc., may also be customized in one or more of color, text, style, theme, artwork, photographic images, and so on. Additionally, although several examples are shown for keyboards for integration into a netbook or notebook computer, in some embodiments, the customized keyboard is for use in a stand alone keyboard that will be coupled to a desktop computer or a notebook or netbook computer. It is also understood that customization is not limited to consumer electronic devices, but may include any electronic devices such as the devices of FIGS. 41-46 and/or their accessories, medical electronic devices or other non-electronic devices, apparel, footwear, luggage, etc., such as those described herein and otherwise.

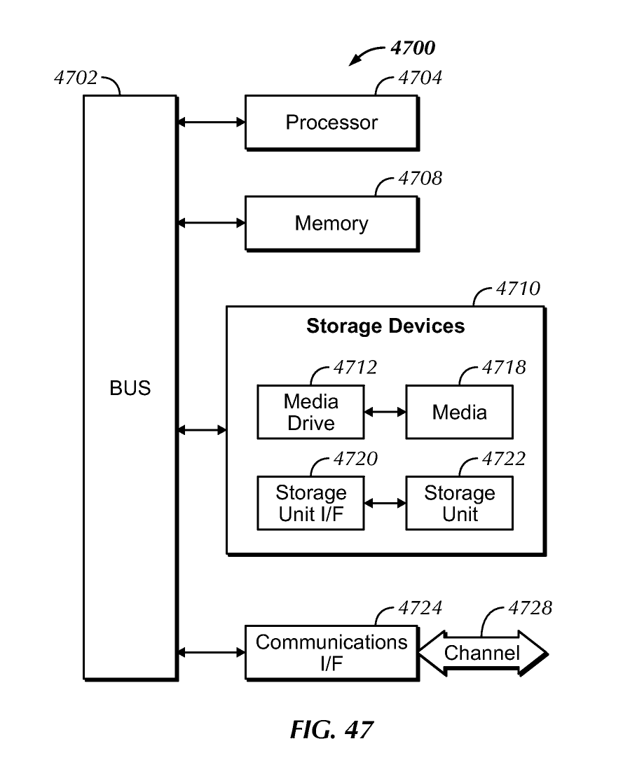

In several embodiments, one or more elements may be implemented using one or more computing systems capable of carrying out the functionality described with respect thereto. One such example computing system is shown in FIG. 47. Computing system 4700 may represent, for example, desktop, laptop and notebook computers; hand held computing devices (PDA's, smart phones, palmtops, etc.); mainframes, supercomputers, or servers; or any other type of special or general purpose computing devices as may be desirable or appropriate for a given application or environment.

Various forms of control logic can be used to implement the various features and functions associated with several embodiments. Such control logic can be implemented using hardware, software, or a combination thereof. For example, one or more servers, computing systems, controllers, processors, processing systems, ASICs, PLAs, and other computing devices, logic devices, modalities or components can be included to implement the desired features and functionality.

In one embodiment, these elements are implemented using one or more computing systems capable of carrying out the functionality described with respect thereto. One such example computing system is shown in FIG. 47. Computing system 4700 may represent, for example, desktop, laptop and notebook computers; hand held computing devices (PDA's, smart phones, palmtops, etc.); mainframes, supercomputers, or servers; or any other type of special or general purpose computing devices as may be desirable or appropriate for a given application or environment.

Referring now to FIG. 47, the computing system 4700 can include one or more processors, such as a processor 4704. Processor 4704 can be implemented using a general or special purpose processing engine such as, for example, a microprocessor, controller or other control logic. In the example, processor 4704 is connected to a bus 4702 or other communication medium. Various software embodiments are described in terms of this example computing system 4700. After reading this description, it will become apparent to a person skilled in the relevant art how to implement the invention using other computer systems or architectures.

Computing system 4700 also includes a main memory 4708, preferably random access memory (RAM) or other dynamic memory, for storing information and instructions to be executed by processor 4704. Main memory 4708 also may be used for storing temporary variables or other intermediate information during execution of instructions to be executed by processor 4704. Computing system 4700 can likewise includes a read only memory (“ROM”) or other static storage device coupled to bus 1102 for storing static information and instructions for processor 4704.

The computing system 4700 can also include information storage mechanism 4710, which can include, for example, a media drive 4712 and a removable storage interface 4720. The media drive 4712 can include a drive or other mechanism to support fixed or removable storage media. For example, a hard disk drive a floppy disk drive, a magnetic tape drive, an optical disk drive, a CD, DVD, or Blu-ray drive (read or read/write versions), or other removable or fixed media drive. Storage media 4718, can include, for example, a hard disk, a floppy disk, magnetic tape, optical disk, a CD or DVD or Blu-ray, or other fixed or removable medium that is read by and written to by media drive 4712. As these examples illustrate, the storage media 4718 can include a computer usable storage medium having stored therein particular computer software or data.

In alternative embodiments, information storage mechanism 4710 may include other similar instrumentalities for allowing computer programs or other instructions or data to be loaded into computing system 4700. Such instrumentalities can include, for example, a removable storage unit 4722 and an interface 4720. Examples of such can include a program cartridge and cartridge interface, a removable memory (for example, a flash memory) and memory slot, and other removable storage units 4722 and interfaces 4720 that allow software and data to be transferred from the removable storage unit 4718 to computing system 4700.

Computing system 4700 can also include a communications interface 4724. Communications interface 4724 can be used to allow software and data to be transferred between computing system 4700 and external devices. Examples of communications interface 4724 can include a modem, a network interface (such as an Ethernet or other NIC card), a communications port (such as for example, a USB port), a PCMCIA slot and card, etc. Software and data transferred via communications interface 4724 are in the form of signals which can be electronic, electromagnetic, optical or other signals capable of being received by communications interface 4724. These signals are provided to communications interface 4724 via a channel 4728. This channel 4728 can carry signals and can be implemented using a wireless medium, wire or cable, fiber optics, or other communications medium. Some examples of a channel can include a phone line, a cellular phone link, an RF link, a network interface, a local or wide area network, and other communications channels.

In this document, the terms “computer program medium” and “computer usable medium” are used to generally refer to media such as, for example, memory 4708, storage device 4718, a hard disk installed in hard disk drive 4712, and/or signals on channel 4728. These and other various forms of computer usable media may be involved in carrying one or more sequences of one or more instructions to processor 4704 for execution. Such instructions (which may be grouped in the form of computer programs or other), when executed, enable the computing system 4700 to perform features of embodiments as discussed herein. In particular, the computer programs, when executed, enable the processor 4704 to perform various embodiments of the present invention.

In an embodiment where the elements are implemented using software, the software may be stored in a computer program product and loaded into computing system 4700 using removable storage drive 4714, hard drive 4712 or communications interface 4724. The control logic (in this example, software instructions), when executed by the processor 4704, causes the processor 4704 to perform the functions of one or more embodiments as described herein.

### Second Example On-Demand Customizer Functional Facility and Process Flow

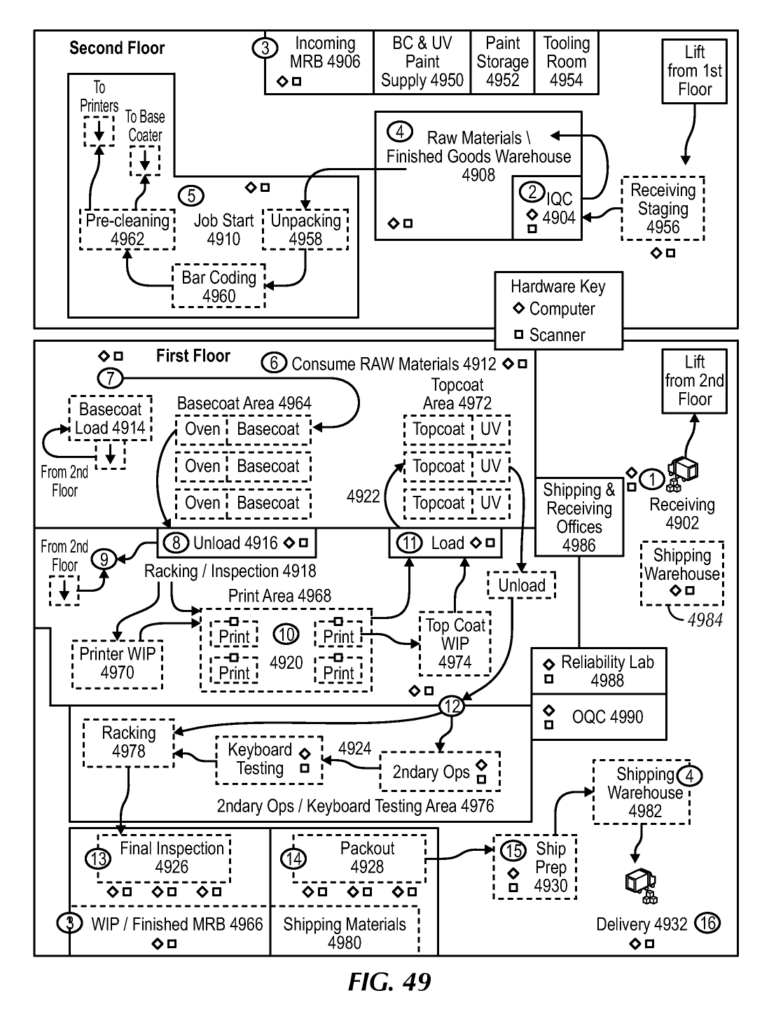

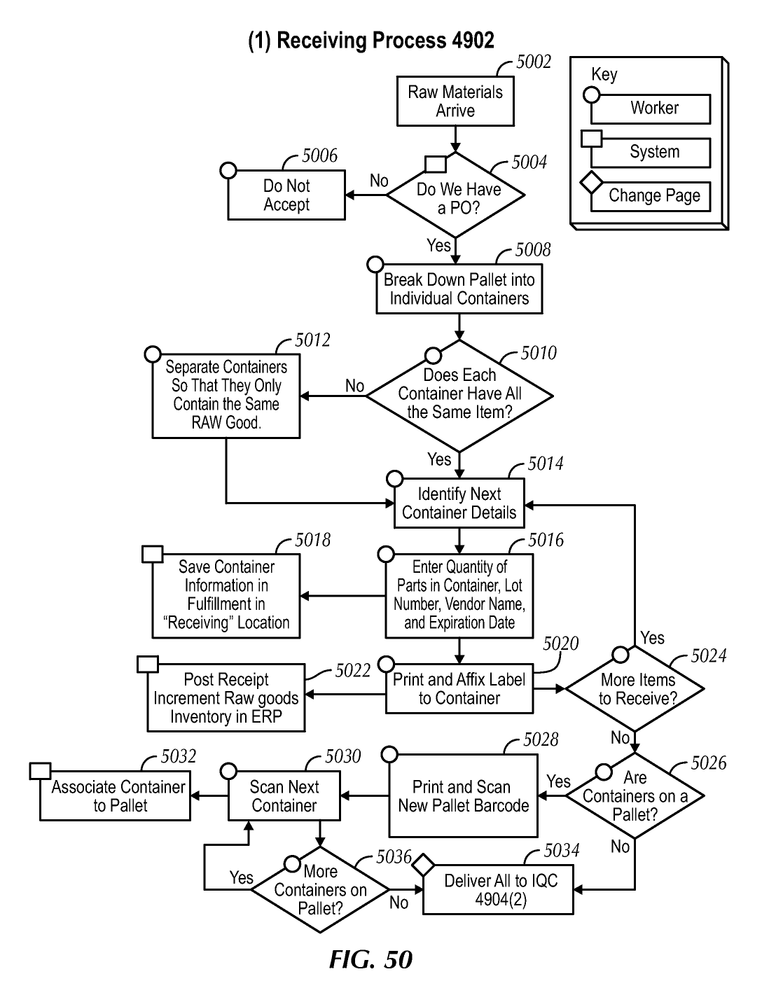

Referring next to FIG. 49, another exemplary physical and functional layout diagram is shown of an image application facility under control of on-demand customizer in accordance with several embodiments. Concurrent reference is also made to FIGS. 50-65, which illustrate various flowcharts of example processes performed for example by the image application facility of FIG. 49.

In this embodiment, the facility has a first floor and a second floor, although it is understood that the facility may be implemented in one or more floors and/or layouts.

In accordance with some embodiments, raw materials including un-customized or blank parts or components are received at the facility from the ODM and/or its parts suppliers. The receiving process 4902 represents the steps involved in receiving blank components, sorting them into containers, entering them into the system, labeling them and transporting them (e.g., via a lift to the second floor) to the incoming quality control process 4904. In some embodiments, incoming raw materials are received at the shipping warehouse and processed by one or more workers. In one embodiment, the raw materials are sorted and placed into containers each having the same raw materials. The worker enters information corresponding to the received raw materials into the system and prints and affixes a label or other tracking device to the container. The system stores the information. Containers of raw materials are organized onto barcoded pallets. The worker scans containers and the system associates the containers to the pallet. The containers and pallets are then transported to the incoming quality control process (IRQ) 4904, e.g., via a lift to a receiving staging area 4956 on the second floor. FIG. 50 provides one embodiment of the receiving process 4902. It is noted that all data stored by the system is stored and maintained in one or more web-based databases, for example, using Microsoft® SharePoint™.

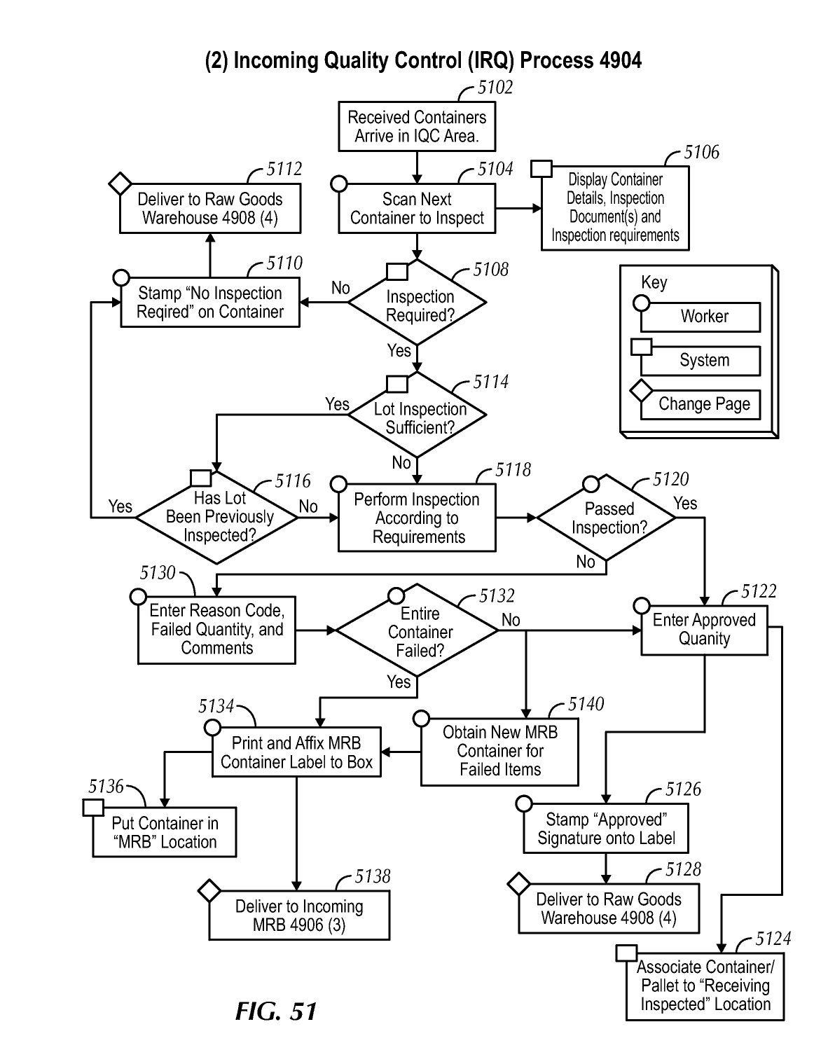

In one embodiment, at the IRQ process 4904, it is determined if inspections are needed. If so, the parts are inspected. If no inspection is required or the inspection is passed, the passed containers/pallets are moved to the Raw Goods Warehouse 4908. Parts not passing inspection are moved to the incoming material review board process 4906. FIG. 51 provides one embodiment of the IRQ process 4904.

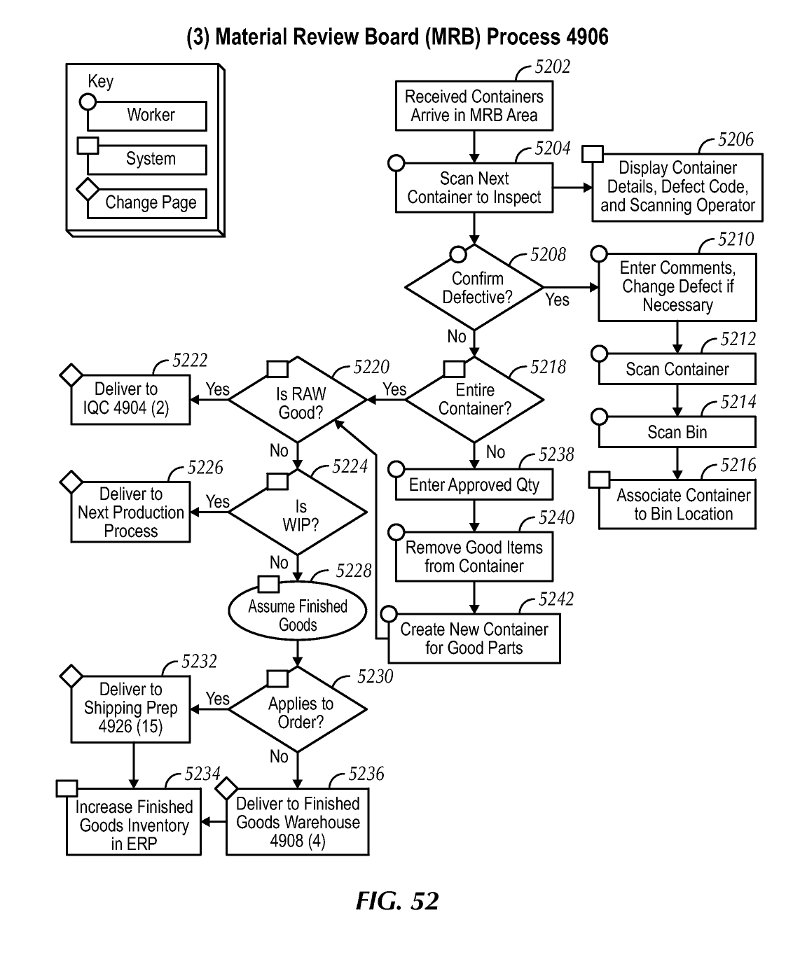

In one embodiment, at the Incoming MRB process 4906, defects are confirmed and it is determined if the defective goods are raw goods, work in progress, or finished, and whether they apply to an order and parts are delivered to other areas of the facility. FIG. 52 provides one embodiment of the Incoming MRB process 4906.

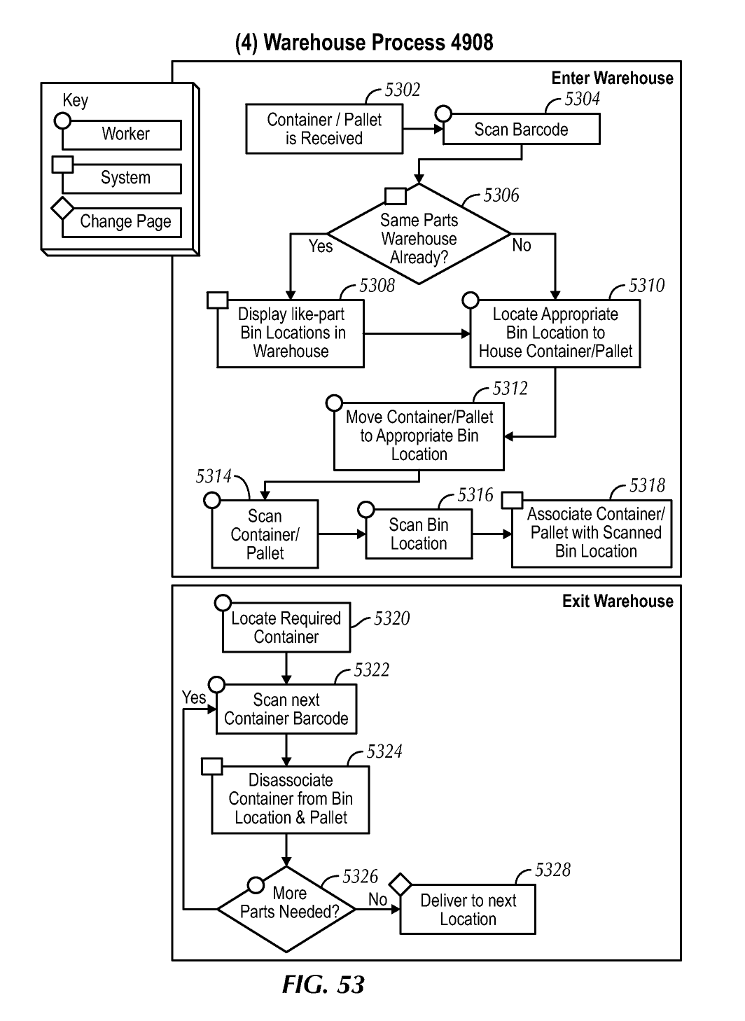

In one embodiment, the warehouse process 4908 receives and processes containers and/or pallets holding containers into bin locations in the warehouse. The management system stores all bin locations for scanned containers/pallets. The warehouse also manages the removal of containers/pallets from the warehouse including disassociating containers from bin locations. FIG. 53 provides one embodiment of the warehouse process 4908. Also illustrated near the Incoming MRB 4906 area is a basecoat (BC) and UV paint supply area 4950, paint storage 4952 and tooling room 4954.

Typically, an order is received from the ODM system, for example via an EDI interface. The order may include a header, assembly, quantity, due date, and destination. In some embodiments, the assembly is a virtual SKU that corresponds to image and customization data that defines or points to the imagery to be applied to which components or parts. The management system then determines if the assembly is valid, and if not rejects the order. If the assembly is valid, the management system verifies that the blank components or parts are available to complete the order. For example, the system checks reserve inventory and determines if inventory levels will remain within minimum and maximum levels, and signals the ODM if additional blank parts are needed to complete the order or to keep inventory levels within the minimum and maximum levels after completion of the order. If the blank parts are available, the management system evaluates the current schedules and loads within the facility. The system then determines a due or completion date given the current workload, capacity and minimum and maximum levels. If it is determined that the order can be completed within a specified time, the order is automatically accepted by the system and the response is sent to the ODM with the due date. The system may also check if lower priority orders would be affected by acceptance of the present order. If so, the due date and completion date of lower priority orders may be updated and communicated to the ODM via the EDI interface. When the order is accepted, the system creates a new order record. To manage the order, in some embodiments, the order is split into one job per logical delivery, and the system creates new job records.

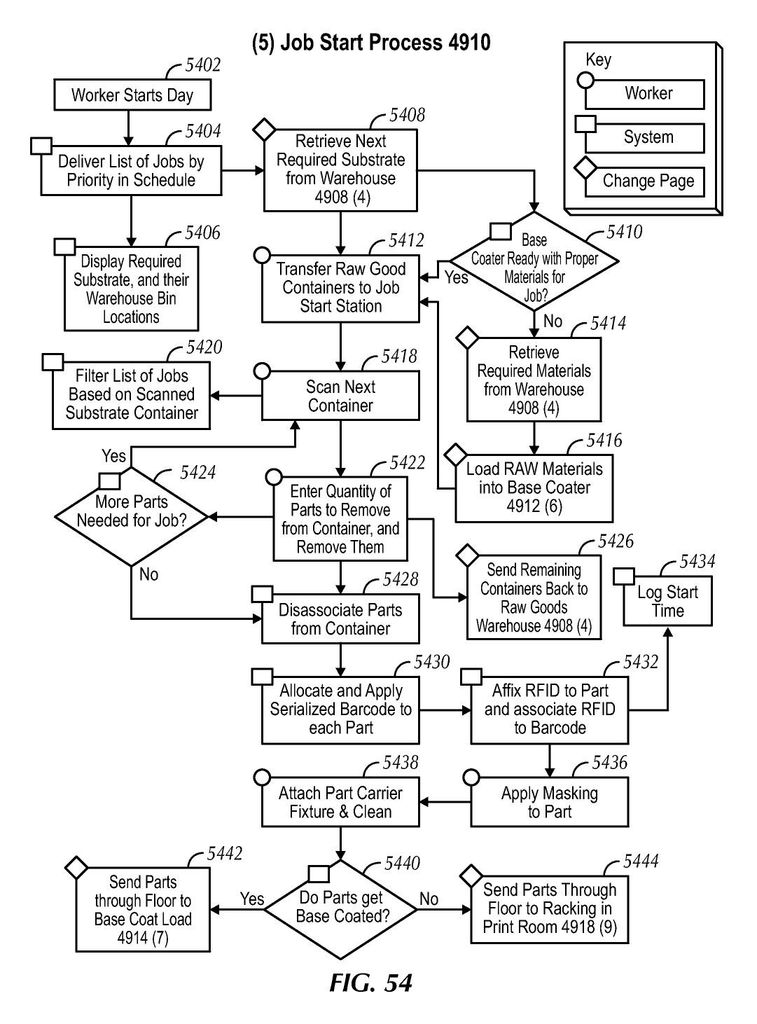

In one embodiment, the job start process 4910, displays to a worker a prioritized list of jobs, where the jobs are a result of the fact that one or more orders have been received into the system. The system informs the worker what blank and/or partially customized parts are needed, and where to get them. Parts are collected, unpacked 4958 and loaded onto a conveyor at the job start area. The parts are then bar coded, e.g., using laser etching or inscribing, at bar coding 4960. Additionally, non-optically readable tracking devices (e.g., RFID devices) are affixed to the part (e.g., at bar coding area 4960). In some embodiments, the bar code identifier is written to the RFID device also on the part. Optional pre-cleaning is performed at pre-cleaning area 4962. Parts then go to either base coater or to printers (e.g., down to first floor). FIG. 54 provides one embodiment of the job start process 4910.

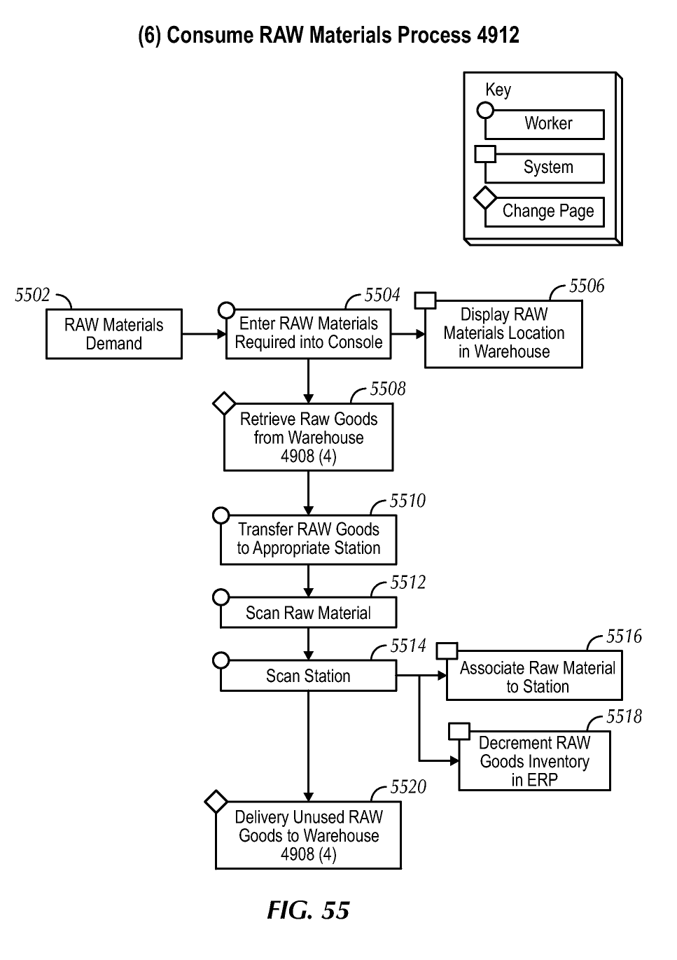

Generally, RAW materials may be moved or consumed from the RAW materials warehouse area 4908 to other processes within the facility. When doing so, raw materials are retrieved from the warehouse and transferred to the appropriate station. Materials and the station are scanned by the worker, e.g., using RFID readers or other scanning devices. The system associates the raw material to the particular station and decrements the raw goods inventory. Unused raw materials go back to the warehouse area 4908. FIG. 55 provides one embodiment of the consume RAW materials process 4912.

Moving back to the flow, if basecoating is required, the parts go to the Basecoat Area 4964 for a basecoat load process 4914, basecoating and a baseload unload process 4916. At the basecoat load, parts are generally loaded onto a JIG, which is a fixture designed to hold parts for basecoating. In one form, the JIG fits onto the main rails of the painting equipment and secondary fixtures (e.g., pins) hold the parts to the main JIG. The JIG and all parts are scanned (e.g., using RFID readers or scanners) and the system associates the parts to the JIG. The paint controller system obtains part and color information from a flow control software or system. For example, the paint controller system is informed that the parts are computer covers and that they should be painted blue. The paint controller system is the hardware and software controlling robotic paint equipment whereas the flow control software or system is the portion of the management system that controls the flow of devices within the facility. Parts are then painted and cured, e.g., in an oven.

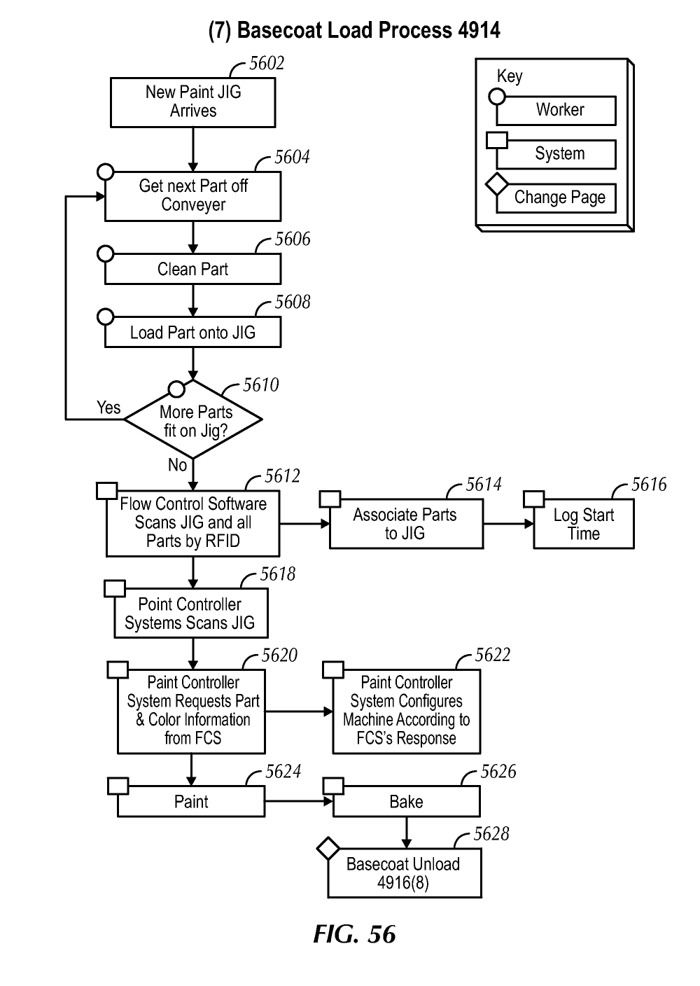

Although not shown, the basecoating area may also apply a primer or include other pre-treatments. The paint process uses one or more paint stations and optional corresponding cure stations. Curing stations may be needed depending on the coating chemistry or technology. In some embodiments, application methods of the coating may be automatically applied via robot, reciprocator and in the form of spray, dip (e.g., thermoplastic and electrode position), roll, curtain coating, and so on. In some embodiments, the type of coating application technique will be determined by many factors including part orientation, coating surface, etc. to identify the best process to be utilized. Typical painting and curing stations include one or more of water based, solvent based or UV cured painting and curing stations. In some embodiments, each painting station is an automated robot painter that can accommodate multiple spray heads to deliver the desired painting or coating. It is understood that any of the pre-treating, painting, and/or curing techniques described herein may be implemented at the Basecoat area 4964. FIG. 56 provides one embodiment of the basecoat load process 4914.

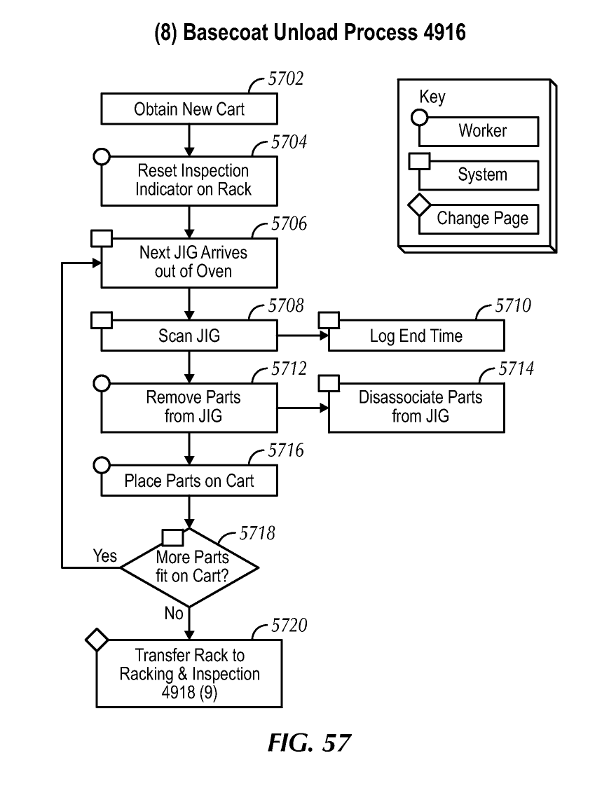

The basecoat unload process 4916 receives painted parts from the oven, which are scanned (e.g., using RFID, optical scanner and/or other non-optical scanner) so that the system knows what parts have been painted. Parts are then placed on carts and moved to the Racking and inspection 4918 area. FIG. 57 provides one embodiment of the basecoat unload process 4916.

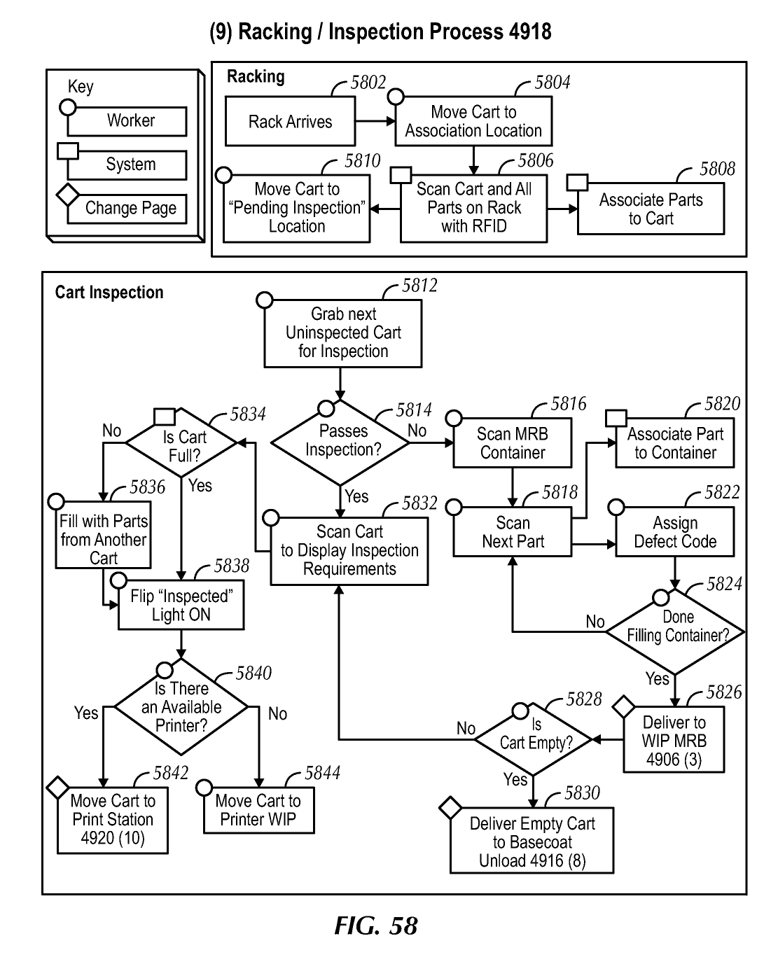

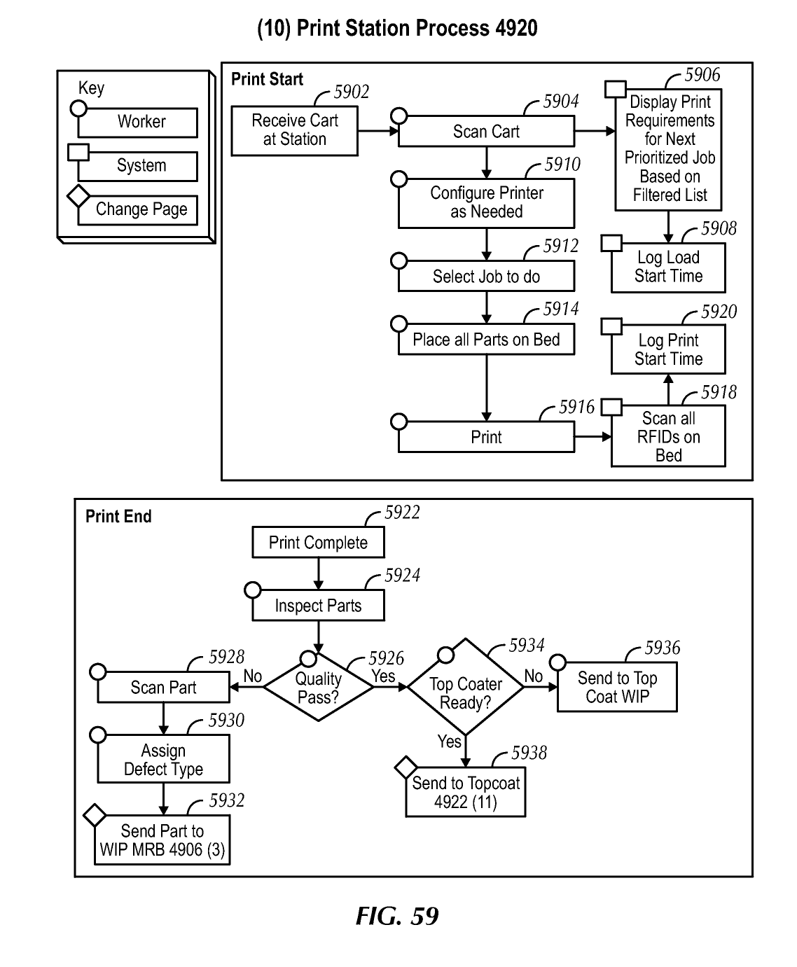

The racking/inspection process 4918 involves adding the parts to racks in preparation for inspection and printing. Again, the rack and all parts are scanned and associated together in a database by the management system. Carts are then inspected according to the desired inspection procedure. Parts that do not pass are given a defect code and moved to the WIP MRB area 4966. If passing inspection, the carts are either moved to an available printer in the print area 4968, or to the printer WIP area 4970. FIG. 58 provides one embodiment of the racking/inspection process 4918.

Next, the print station process 4920 is implemented at the print area 4968. At the start of printing, a cart is received from the racking/inspection process 4918 or from the printer WIP area 4970. The cart is scanned and parts are placed on the print bed and scanned so that the system knows what parts are to be printed. The system in turns configures the printers with the appropriate configuration data including digital files indicating what to print, e.g., a RIP file. The printing process is implemented using any of the printing technologies and variations described herein. Once printed, the parts are inspected for quality. If not passing, the parts are sent to the WIP MRB area 4966. If passing, and if parts are to be topcoated, the parts are sent to the topcoat area 4972 or to the Topcoat WIP area 4974. FIG. 59 provides one embodiment of the print station process 4920.

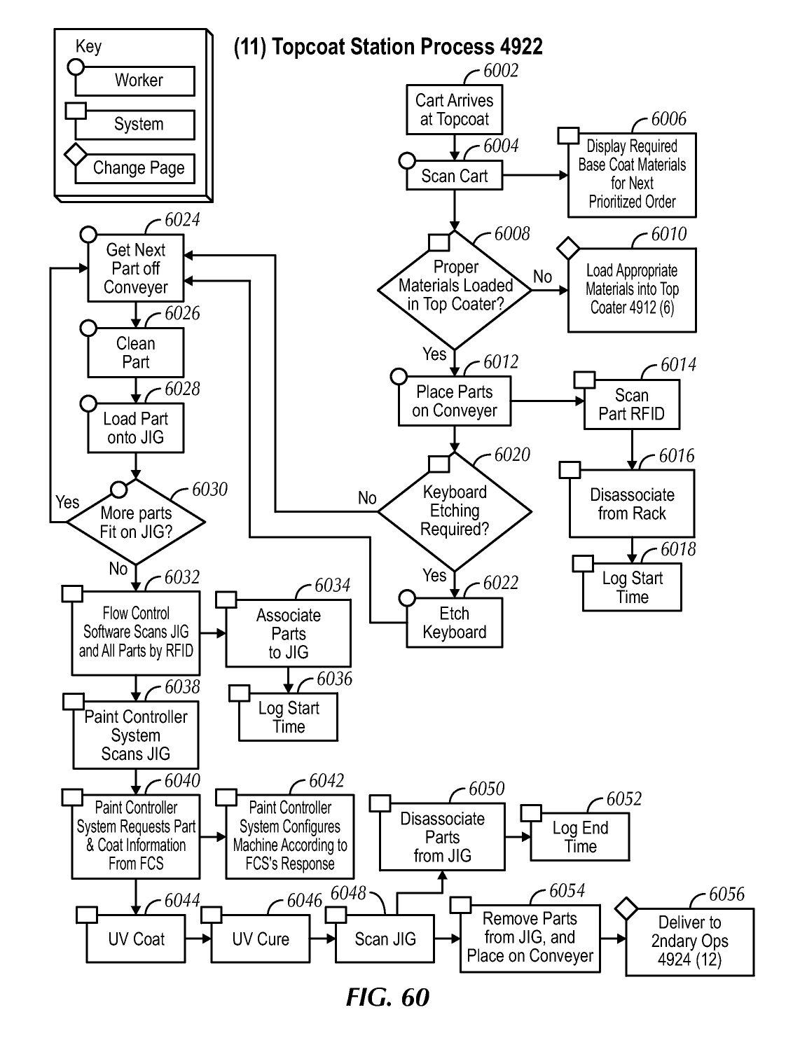

Next, the parts are top coated as specified by the orders. A cart arrives at the topcoat area 4972 and is scanned. If etching is required, etching is performed. Parts are then placed on a JIG and coated and cured. In some embodiments, the coating provides an additional color component and/or an etching or surface treatment of the finish coat. The finish coat is then optionally cured and again color is inspected. This station includes one or more coat/finish stations and corresponding one or more optional curing stations. Typical coating and curing stations are similar to painting and curing stations and can include one or more of water based, solvent based or UV cured painting and curing stations to apply and cure clear coats. Solvent paints are thermally cured whereas UV paints are cured with exposure to UV light. In some cases, an industrial coating is applied, for example, by UV curing coating machinery manufactured by Eodex Enterprises LTD of Taiwan. Again, curing stations may be needed depending on the coating chemistry or technology. In some embodiments, application methods of the coating may be automatically applied via robot, reciprocator and in the form of spray, dip (e.g., thermoplastic), roll, curtain coating, and so on. In some embodiments, the type of coating application technique will be determined by many factors including part orientation, coating surface, etc. to identify the best process to be utilized. In some embodiments, the clear coat finish is formulated to be a high gloss, semi-gloss, matte or soft-touch finish. In some embodiments, each painting station is an automated robot painter that can accommodate multiple spray heads to deliver the desired painting or coating. As the batched parts leave the finish coat process, they are moved to a holding area. Furthermore, in some embodiments, the finish coat process can be implemented to provide a specified hardness level. For example, in some embodiments, the finish coat provides performance and appearance standards as dictated by the end consumer. In some embodiments, the final topcoat/print finish can be any hardness level, any gloss level, textured, soft touch (tactile) feel finishes, slip finishes, anti-fingerprint finishes, and/or any other finish coats known to those skilled in the art. FIG. 60 provides one embodiment of the topcoat station process 4922.

It is noted that although not illustrated, in some embodiments, surface pre-treatments may be applied using or more surface treatment devices. For example, when applying images to metal substrates, in some embodiments, an optional chemical film treatment layer is applied to the metal substrate using known chemical film treatment application devices. In other embodiments, any painted or printed layer may be plasma treated to modify (e.g., raise) dyne levels to ensure good adhesion for additional layers to be applied thereon. Such plasma treatment may be applied by plasma treatment devices as known in the art. For example, a base paint layer may be plasma treated prior to being printed with a direct to surface post mold printer to ensure good adhesion of the print layer to the base paint layer. Additionally, the print layer may be plasma treated prior to being painted with a clear or top coat to ensure good adhesion of the top coat layer to the print layer. Simple cleaning pre-treatments may include an isopropyl alcohol (IPA) wipe or other cleaning step. Thus, any known pre-treatment techniques that correspond to one or more of the substrate materials and/or painting, printing, coating, or other image application techniques described herein or otherwise known in the art may be implemented.

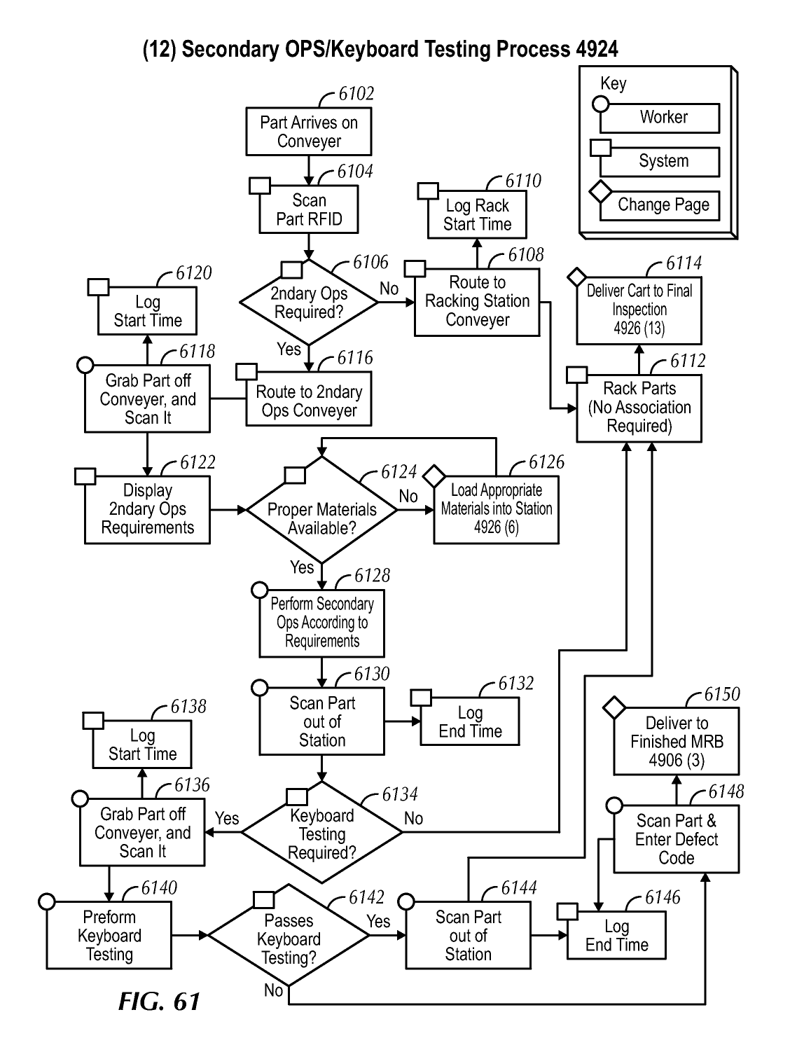

Next, the parts either go to a secondary operations/keyboard testing area 4974 or to a racking area 4978. At area 4974, any required secondary operations are performed. For example, in the case of computer components, webcams, touchpads, or other electronic devices may be added to the customized parts. The secondary operations will depend on the customized parts and to what extent further assembly is done at the facility. Keyboard testing is to ensure customized keyboard perform properly. At the racking area 4978, parts are simply added to a rack. At this step, no specific association of parts to rack is needed, but could be used in some embodiments. FIG. 61 provides one embodiment of the secondary operations/keyboard testing process 4924.

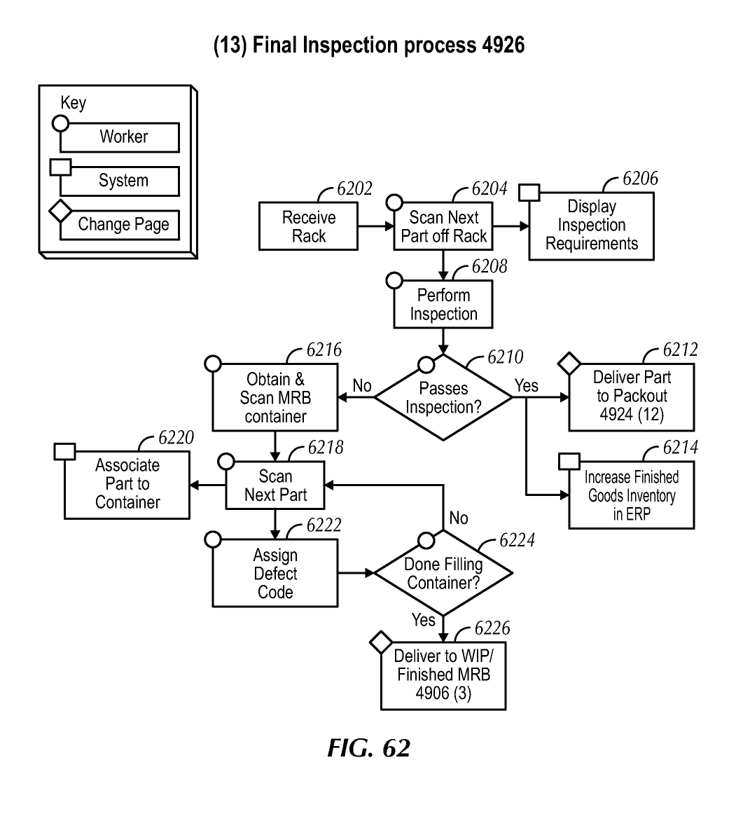

Next, parts go to the final inspection area/process 4926. Parts are pulled from the rack and scanned and inspected. If passing, they are sent to the packout area/process 4928. If not passing, the parts are sent to the WIP/Finished MRB 4966. FIG. 62 provides one embodiment of the final inspection process 4926.

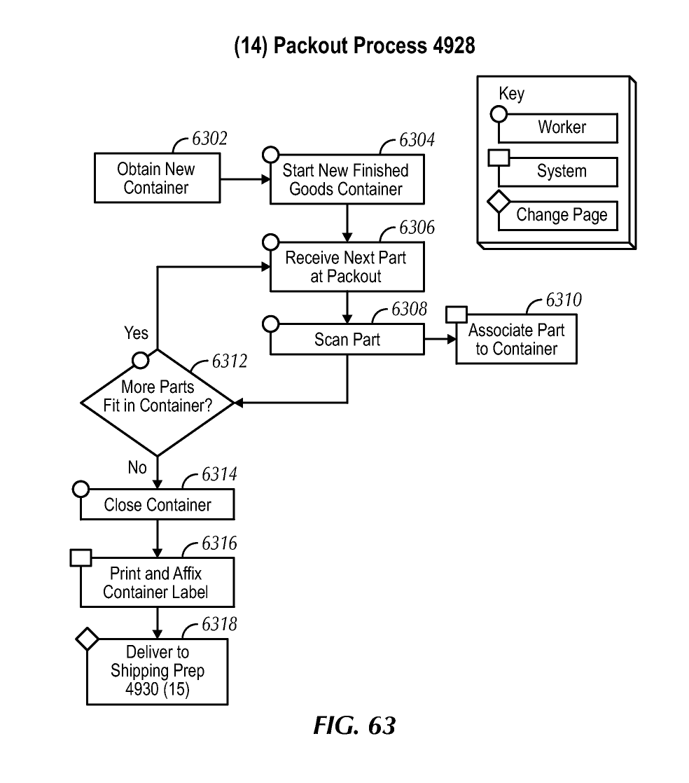

At packout, the goods are added to finished goods containers, scanned and associated in the system to the container. Printed labels are affixed and the parts are delivered to the shipping preparation area/process 4930 using the shipping materials 4980. FIG. 63 provides one embodiment of the packout process 4928.

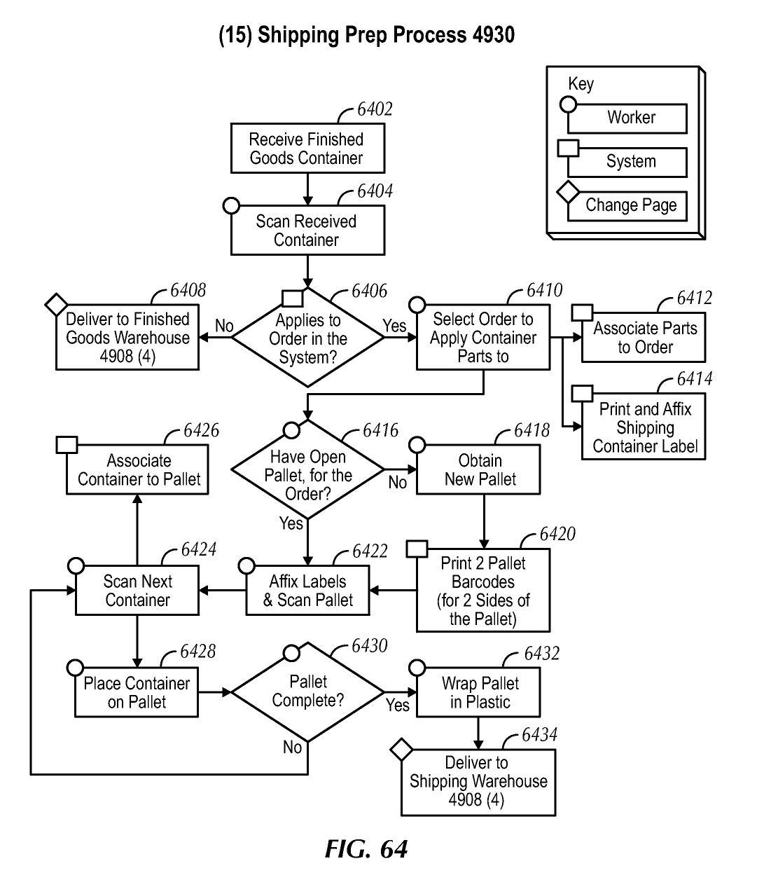

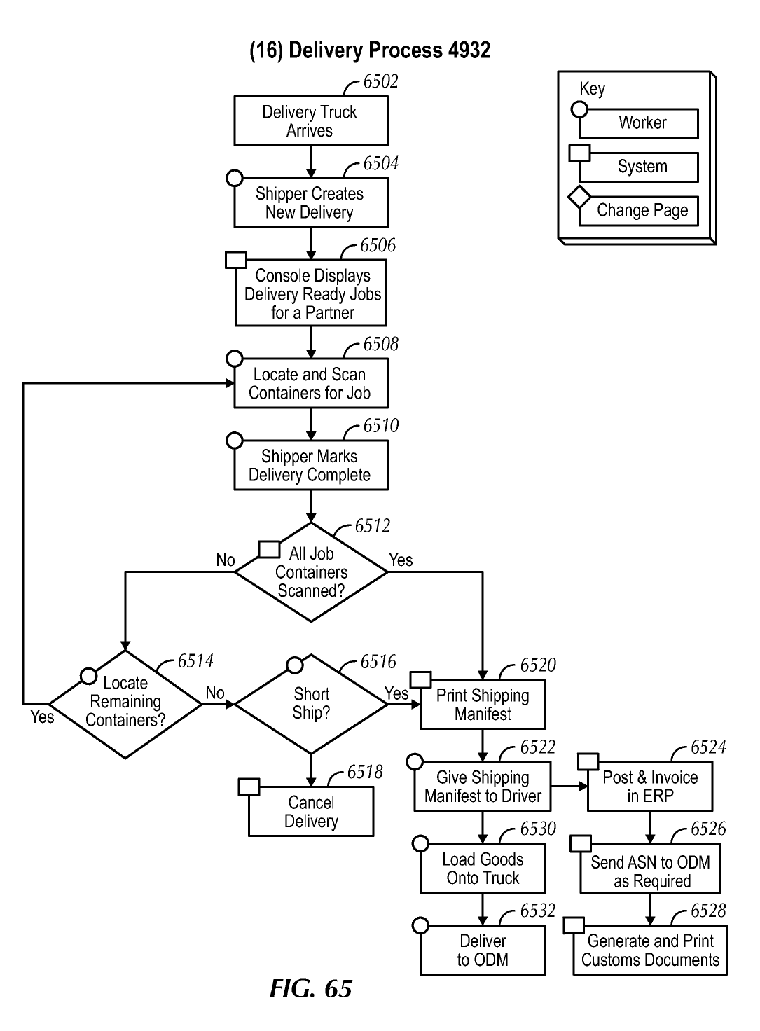

At the shipping prep areas/process 4930, finished goods containers are received and scanned into the system and matched to one or more orders. As needed, the containers are added to pallets which are barcoded and delivered to the shipping warehouse 4982 and/or 4984. FIG. 64 provides one embodiment of the shipping preparation process 4930. Next, the parts are delivered to their intended destination. Containers and/or pallets are loaded onto trucks with the appropriate delivery instructions. FIG. 65 provides one embodiment of the delivery process 4932.

Other areas illustrates are shipping and receiving offices 4986, the reliability lab 4988 and the outgoing quality control area 4990. It is further noted that the location of at least some of the scanners and computers used in some embodiments of the manufacturing system. In other embodiments, more or less scanners and/or computers may be needed. Scanners may take the form of optically reading scanners, including bar code scanners, cameras that can optically see a part/container/cart/rack with software that recognizes and classifies the part/container/cart/rack, for example. Scanners may also include non-optically reading scanners, such as radio frequency scanning devices, RFID devices, RFID tags, NFC devices, etc. In some embodiments, when scanning parts, carts, rack, containers, etc. in the system, an identifier is obtained and matched in a database that provides other information, such as part identity, customization parameters and so forth. This information can be selectively transmitted to different station or components of the system. In some embodiments, this database is local to the manufacturing facility while in other embodiments it is remotely located but accessible through a network interface.

Accordingly, in several embodiments, the workflow within the facility under control of the management software platform ensures that the amount of time elapsed from receipt of the order to delivery of customized parts is on the order of hours. For example in one embodiment, an order may be completed within 24 hours. The number of painting, curing, printing, coating, pre-treatment and/or plasma treatment stations may be scaled as necessary to allow for large quantities of parts to be processed within the same timeframe. For example, in the case of custom keyboards for a notebook style computer, some embodiments can process an order for up to 10,000 or up to 1,000,000 customized keyboards within 24 hours of order receipt. In this way, personalized or customized variable image data can be applied to blank parts and delivered to an ODM for assembly to create products for OEM and/or an end customer such as a retailer in a truly on-demand fashion. The following discussion of FIGS. 50-65 provides further details of a workflow process within an example image application facility in accordance with several embodiments.

Referring next to FIG. 50, one embodiment of the receiving process 4902 of FIG. 49 is shown. Initially, the raw materials are received from trucks and arrive at the facility (Step 5002). Next, the management system (also simply referred to as the system) determines if there is a purchase order (Step 5004). If not, the raw materials are not accepted (Step 5006). If so, an inventory worker (also referred to as a worker) breaks down the pallet of raw materials into one or more individual containers, such as by type of material (Step 5008). The worker then determines if each container includes all of the same items (Step 5010). If not, the worker separates containers so that they only contain the same raw materials (Step 5012) then identifies the contents of the next container (Step 5014). If the container has all of the same parts as determined in Step 5010, the worker performs Step 5014. The worker then enters the quantity of parts in the container, lot number, vendor name, and expiration date (Step 5016). The system saves the container information in Fulfillment in Receiving location (Step 5018). The worker then prints and affixes a label to the container (Step 5020) and the system posts the receipt and increments the raw goods inventory in the Enterprise Resource Planning (ERP) system (Step 5022). In one embodiment, the label is specific to the entity controlling the facility, e.g., the on demand customizer (ODC). The worker then determines if there are more items to receive (Step 5024) and if yes, the worker performs Step 5014. If no, the worker determines if the containers are on a pallet (Step 5026). If yes, the worker prints and scans a new pallet barcode or other tracking identifier (Step 5028), and scans the next container (Step 5030). The system then associates the container to the pallet (Step 5032). For example, this information is stored in a local or remotely accessible memory and/or database. If the containers are not on a pallet (Step 5026), the containers are delivered to an incoming quality control 4904 process (Step 5034), see also the process of FIG. 51. After the worker scans the next container (Step 5030), the worker determines if there are more containers on the pallet (Step 5036), and if so, the worker performs Step 5030 and the system performs Step 5032. If not, the containers are delivered to an incoming quality control 4904 process (Step 5034), see FIG. 51. It is noted that in the key, the term “change page” means go to the flowchart that describes the listed step in more detail.

Referring next to FIG. 51, one embodiment of the incoming quality control (IQC) process 4904 of FIG. 49 is shown. Initially, containers of raw materials (e.g., blank parts) arrive are received from trucks and arrive at the IQC area (Step 5102). The worker scans the next container to inspect (Step 5104) and the system causes the display of the container details, inspection documents, and inspection requirements (Step 5106). Next, the system determines if an inspection is required (Step 5108) and if not, the worker stamps “no inspection required” on the container (Step 5110) and the goods are delivered to the raw goods warehouse 4908 (Step 5112), see also FIG. 53. If an inspection is required, the system determines if a lot inspection is sufficient (Step 5114). If yes, the system determines if the lot has been previously inspected (Step 5116) and if so, the worker performs Step 5110. If the lot has not been previously inspected (Step 5116) or a lot inspection is not sufficient (Step 5114), the worker then performs an inspection according to the displayed requirements (Step 5118). The worker determines if the inspection has passed (Step 5120) and if so, the worker enters the approved quantity (Step 5122), and the system associates the container/pallet to “Receiving inspected” location (Step 5124). The worker then stamps “approved” onto the label (Step 5126) and container/pallet is delivered to the Raw Goods Warehouse (Step 5128), see also FIG. 53. If the inspection did not pass (Step 5120), the worker enters the reason code, failed quantity and comments (Step 5130). Then, the worker determines if the entire container failed (Step 5132), and if so, the worker prints and affixes a material review board (MRB) container label (Step 5134), the system puts the container in the “MRB” location (Step 5136), and the container is delivered to the Incoming MRB process (Step 5138), see also the process of FIG. 52. In the event less than the whole container failed (Step 5132), the worker performs Step 5122 for the passed materials and obtains a new MRB container for the failed items (Step 5140). The worker then performs Step 5134, the system performs Step 5136 and Step 5138 is performed.

Referring next to FIG. 52, one embodiment of the material review board (MRB) process 4906 of FIG. 49 is shown. Initially, containers arrive at the MRB area (Step 5202) and the worker scans the next container to inspect (Step 5204), and the system displays container details, defect codes and the scanning operator (Step 5206). The worker then confirms the item is defective (Step 5208), and if so, the worker enters comments, changes the defect if necessary (Step 5210). Then the worker scans the container (Step 5212), scans a bin (Step 5214) and the system associates the container to the bin location (Step 5216). If the defect is not confirmed (Step 5208), the system determines if it is the entire container that is not defective (Step 5218) and if so, the system determines if it is a raw good (Step 5220) and if so, the container is delivered to IQC 4904 (Step 5222), see also the process of FIG. 51. If the container is not raw goods (Step 5220), the system determines if it is a work in progress (WIP) (Step 5224). If so, the container is delivered to the next production process (Step 5226). If not, the system assumes that the container represents Finished Goods (Steps 5228). Next, the system determines if the container applies to an order (Step 5230), and if so, the container is delivered to the Shipping Prep area for the shipping prep process 4930 (Step 5232), see also the process of FIG. 64, and the system increases the Finished Goods Inventory in ERP (Step 5234). If the container does not apply to an order (Step 5230), the container is delivered to the Finished Goods Warehouse 4908 (Step 5236), see also the process of FIG. 53. If no at Step 5218, the worker enters the approved quantity (Step 5238), removes the good items from the container (Step 5240), and creates a new container for good parts (Step 5242).

Referring next to FIG. 53, one embodiment is shown of the warehouse process 4908 occurring at the raw materials/finished goods warehouse of FIG. 49. Initially, at the warehouse entry side, a container and/or pallet with containers is received at the warehouse (Step 5302). The worker scans the bar code (Step 5304) and the system determines if the same parts are already in the warehouse (Step 5306). If so, the system displays like-part bin locations in the warehouse (Step 5308) and the worker locates the appropriate bin location to house the container/pallet (Step 5310). If the same parts are not in the warehouse (Step 5306), the worker performs Step 5310. The, the worker moves the container/pallet to the appropriate bin location (Step 5312), scans the container/pallet (Step 5314), scans the bin location (Step 5316), and the system associates the container/pallet with the scanned bin location and stores this association in a database (Step 5318). On the warehouse exit side, the worker locates a required container (Step 5320) and scans the next container barcode (Step 5322). The system disassociates the container from the bin location and pallet (Step 5324). The worker determines if more parts are needed (Step 5326), and if so, performs Step 5322. If not, the container is delivered to the next location (Step 5328).

Referring next to FIG. 54, one embodiment is shown of the job start process 4910 of FIG. 49. Initially, the worker starts the day (Step 5402). The system displays a list of jobs by priority in schedule (Step 5404), such as may be done in any of the ways described herein. The system displays the required part or substrate and the warehouse bin location (Step 5406). The next required part is retrieved from the warehouse 4908 (Step 5408), see also the process of FIG. 53. The system determines if the Base Coater is ready with proper materials for the job (Step 5410), and if so, the worker transfers raw good containers to the job start station (Step 5412). If not, required materials are retrieved from the warehouse 4908 (Step 5414), see also the process of FIG. 53. Then, RAW materials are loaded into the base coater load 4914 (Step 5416), see also the process of FIG. 55. Next, Step 5412 is performed, then worker scans the next container (Step 5418), and the system filters the list of jobs based on the scanned substrate container (Step 5420). Next, the worker enters the quantity of parts to remove from the container and removes them (Step 5422). The system determines if more parts are needed for the job (Step 5424), and if so, the process goes back to Step 5418. If not, the process goes to Step 5428 (see below). After Step 5422, the remaining containers are sent back to the Raw Goods Warehouse 4908 (Step 5426), see also the process of FIG. 53, and the system disassociates parts from the container (Step 5428). The system then allocates and applies serialized barcodes to each part (Step 5430), and the worker affixes an RFID device to the part and the system associates the RFID device to the barcode (Step 5432). The system then logs the start time (Step 5434). The worker then applies a masking to the part (Step 5436). The worker attaches a part carrier fixture and cleans the part and/or the part carrier fixture (Step 5438). Next, the system determines if the parts get base coated (Step 5440), and if so, the parts are sent through the floor to the Base Coat Load process 4914 (Step 5442), see also the process of FIG. 56. If not, the parts are sent through the floor to Racking in the Print Room 4918 (Step 5444), see also the process of FIG. 58.

Referring next to FIG. 55, one embodiment is shown of a consume raw materials process 4912 of FIG. 49. It is noted that this is a generic workflow and in some embodiments, can be applied to all stations on the floor to relieve inventory of RAW goods. Initially, there is a demand for RAW (Step 5502). The worker enters required RAW materials into the console, e.g., of or coupled to the system (Step 5504). The system displays the location of the RAW materials in the warehouse (Step 5506). Then, the RAW goods are retrieved from the warehouse 4908 (Step 5508), see also the process of FIG. 53. Next, the worker transfer the RAW goods to the appropriate station (Step 5510), scans the RAW materials (Step 5512), and scans the station (Step 5514). The system associates the RAW materials to the station (Step 5516) and decrements the RAW Goods inventory in ERP (Step 5518). Then, the unused RAW goods are delivered to the warehouse 4908 (Step 5520), see also the process of FIG. 53.

Referring next to FIG. 56, one embodiment is shown of the basecoat load process 4914 of FIG. 49. First, a new paint JIG or fixture arrives (Step 5602). The worker gets the next part off of the conveyor (Step 5604), cleans the part (Step 5606) and loads the part onto the JIG (Step 5608). The worker then determines if more parts can fit on the JIG (Step 5610), and if so, Step 5604 is performed. If not, the flow control software (FCS) running by the system scans the jig and all parts using RFID devices (Step 5612). For example, the FCS may implement any method to control the flow of parts within the floor. In some embodiments, the FCS implements dynamic flow, such as described in FIGS. 66-68. The system then associates the parts to the JIG (Step 5614), and logs the start time (Step 5616). Next, Paint Controller system scans the JIG (Step 5618). In some embodiments, the paint controller system is an automated system or a programmable logic controller (PLC) used to control robotic spray paint systems. Next, the paint controller system requests part and color information from the flow control software (Step 5620), and configures paint machines according to the response from the flow control software (Step 5622). Next, the system executes painting (Step 5624) and baking/curing (Step 5626) according to any of the ways described herein or otherwise known. The process then continues at the basecoat unload process 4916 (Step 5628), see the process of FIG. 57.

Referring next to FIG. 57, one embodiment is shown of the basecoat unload process 4916 of FIG. 49. First, a new cart is obtained (Step 5702), then the worker resets the inspection indicator on the Rack (Step 5704). The system outputs the next JIG from the oven (Step 5706), scans the JIG (Step 5708) and logs the end time (Step 5710). Next, the worker removes parts from the JIG (Step 5712) and the system disassociates the parts from the JIG (Step 5714). The worker then places the parts on the Cart (Step 5716). The system determines if there are more parts on the cart (Step 5718), and if so, Step 5706 is performed. If not, the Rack is transferred to the Racking and Inspection process 4918 (Step 5720), see also the process of FIG. 58.

Referring next to FIG. 58, one embodiment is shown of the racking/inspection process 4918 of FIG. 49. In one embodiment of a racking process, the rack arrives (Step 5802) and the worker moves the cart to association location (Step 5804). The system scans the cart and all parts on the Rack (Step 5806), e.g., the scanner is an RFID reader and all parts and the cart have RFID devices. The system associates the parts to the cart in the database (Step 5808), and the worker moves the cart to the “pending inspection” location (Step 5810).

In one embodiment of a cart inspection process, the worker grabs the next uninspected cart for inspection (Step 5812). The worker determines if the cart passes inspection (Step 5814). If not, the worker scans the Material review Board container (Step 5816), scans the next part (Step 5818) and assigns a defect code (Step 5822). The system associates the part to the MRB container (Step 5820). If the worker is not done filling the container (Step 5824), the worker goes back to Step 5818. If the worker is done filling the container (Step 5824), the container is delivered to the WIP MRB 4906 (Step 5826), see also the process of FIG. 52. The worker then determines if the cart is empty (Step 5828), and if so, the empty cart is delivered to the Basecoat Unload 4916 (Step 5830, see the process of FIG. 57). If the cart is not empty (Step 5828), the worker scans the cart to display inspection requirements (Step 5832). Also, back to Step 5814, if the cart passes inspection, the worker performs Step 5832. After Step 5832, the system determines if the cart is full (Step 5834). In one example, the system knows how many parts can fit on the cart and knows how many parts on the cart. If not full, the worker fills the cart with parts from another cart (Step 5836), then the worker flips the “inspected” light of the cart ON (Step 5838). At Step 5834, if the cart is full, the worker performs Step 5838. Next, the worker determines if there is an available printer (Step 5840). If so, the cart is moved to the print station 4920 (Step 5842), see also the process of FIG. 59. If not, the worker moves the cart to Printer WIP (Step 5844).

Referring next to FIG. 59, one embodiment is shown of the print station process 4920 of FIG. 49. In one embodiment of a print start process, a cart is received at the print station (Step 5902) and the worker scans the cart (Step 5904). The system displays the print requirements for the next prioritized job based on the filtered list (Step 5906) and the load start time is logged (Step 5908). It is noted that in one embodiment, the priority of Step 5906 is determined using dynamic flow filtering, such as described in FIGS. 66-68. Next, the worker configures the printer as needed (Step 5910), selects the job to do (Step 5912), places the parts on the printer bed (Step 5914) and initiates the printing process (Step 5916). It is noted that the system may use any of the printing techniques such as those described herein. The system scans all RFID devices on the bed (Step 5918) and logs the print start time (Step 5920).

In one embodiment of a print end process, the print is completed (Step 5922) and the worker inspects the parts (Step 5924). The worker determines if the parts pass quality (Step 5926), and if not, the worker scans the part (Step 5928) and assigns a defect type (Step 5930). The part is then sent to the WIP MRB 4906 (Step 5932), see also the process of FIG. 52. If the parts pass quality (Step 5926), the worker determines if the top coater is ready (Step 5934), and if not, the worker sends to the Top Coat WIP (Step 5936). If so, the parts are sent to the Topcoat process 4922 (Step 5938), see also FIG. 60.

Referring next to FIG. 60, one embodiment is shown of the topcoat station process 4922 of FIG. 49. Initially, a cart arrives at Topcoat (Step 6002), and the worker scans the cart (Step 6004). The system displays the required base coat materials for the next prioritized order (Step 6006). The system then determines if the proper materials are loaded in the topcoater (Step 6008), and if not, the appropriate materials are loaded therein (Step 6010), see also FIG. 55. If the proper materials are loaded into the top coater (Step 6008), the worker places the parts on a conveyor (Step 6012) and the system scans all RFID devices on parts (Step 6014), disassociates them from the Rack (Step 6016) in the database and logs the start time (Step 6018). Next, the system determines is keyboard etching is required (Step 6020) and if not, the worker gets the next part off of the conveyor (Step 6024). If etching is needed (Step 6020), the worker etches the keyboard (Step 6022) and then gets the next part off of the conveyor (Step 6024). The worker cleans the part (Step 6026) and loads the parts on the JIG (Step 6028). The worker then determines if more parts can fit on the JIG (Step 6030) and if so, performs Step 6024. If not, the flow control software (FCS) of the system scans the JIG and all parts using RFID or other non-optically readable technologies (Step 6032), associates the parts to the JIG (Step 6034) and logs the start time (Step 6036). The paint controller system then scans the JIG (Step 6038) and request part and coat information from the FCS (Step 6040). The paint controller system configures the painting machines according to the response from the FCS (Step 6042). Next, the system initiates the UV coating process (Step 6044) and UV curing process (Step 6046). It is understood that any of the coating or finishing techniques described herein may be used. After coating and curing, the system scans the JIG (Step 6048), disassociates the parts from the JIG (Step 6050) and logs the end time (Step 6052). Then, the system (e.g., robotic paint system) removes parts from the JIG and places them on the conveyor (Step 6054) and they are delivered to secondary operations 4924 (Step 6056), see also the process of FIG. 61.

Referring next to FIG. 61, one embodiment is shown of the secondary ops/keyboard testing process 4924 of FIG. 49. First, the part arrives on a conveyor (Step 6102) and the system scans the RFID devices of all parts (Step 6104) and determines if secondary operations are needed (Step 6106). If no, then the system routes the parts to a Racking station conveyor (Step 6108) and logs the Rack Start Time (Step 6110). Them the system racks the parts (no association needed) (Step 6112) and the cart is delivered to Final Inspection 4926 (Step 6114). If secondary operations are needed (Step 6106), the system routes to secondary ops (Step 6116) and the worker grabs parts off of the conveyor and scans them (Step 6118). The system logs the start time (Step 6120) and displays the secondary ops requirements (Step 6122). Next, the system determines if the proper materials are available (Step 6124), and if not they are loaded into the appropriate station 4926 (Step 6126), see also the process of FIG. 55. If the materials are available (Step 6124), the worker performs the secondary ops (Step 6128), e.g., adds webcam, touchpads, other electronics. The worker then scans the part out of the station (Step 6130) and the system logs the end time (Step 6132). The system then determines if keyboard testing is required (Step 6134) and if not, the process goes to Step 6112. If so, the worker grabs the part off of the conveyor and scans it (Step 6136) and the system logs the start time (Step 6138). The worker then performs the keyboard testing (Step 6140). The system then determines whether the keyboard passes the testing (Step 6142), and if so the worker scans the part out of the station (Step 6144) and logs the end time (Step 6146) and the process goes to Step 6112. If the keyboard does not pass (Step 6142), the worker scans the part and enters the defect code (Step 6148) and the system logs the end time (Step 6146). Then, the part is delivered to Finished MRB 4906 (Step 6150), see also FIG. 53.

Referring next to FIG. 62, one embodiment is shown of the final inspection process 4926 of FIG. 49. First, the rack is received at the final inspection area (Step 6202) and the worker scans the next part off the rack (Step 6204). The system displays the inspection requirements (Step 6206). The worker then performs the inspection (Step 6208) and determines if it pass the inspection (Step 6210). If it passes, the system increase the finished goods inventory in ERP (Step 6214) and the part is delivered to Packout 4928 (Step 6212). If the part does not pass inspection (Step 6210), the worker obtains and scans an MRB container (Step 6216) and scans the next part (Step 6218). The system associates the part to the container (Step 6220), for example, within a database. Next, the worker assigns a defect code (Step 6222) and determines if the worker is done filling the container (Step 6224). If not, the process goes to Step 6218. If so, the container of finished goods is delivered to WIP/Finished Goods MRB 4906 (Step 6226), see also the process of FIG. 52.

Referring next to FIG. 63, one embodiment is shown of the packout process 4928 of FIG. 49. Initially, a new container is obtained at packout (Step 6302). The worker starts a new finished goods container (Step 6304), receives the next part at packout (Step 6306), and scans the part (Step 6308). The system associates the part to the container (Step 6310). The worker determines if more parts will fit in the container (Step 6312), and if so, the process goes back to Step 6306. If not, the worker closes the container (Step 6314). The system prints and affixed a container label on the container (Step 6316) and the container is delivered to Shipping Prep 4930 (Step 6318).

Referring next to FIG. 64, one embodiment is shown of the shipping prep process 4930 of FIG. 49. Initially, a finished goods container is received at the shipping prep area (Step 6402) and the worker scans the received container (Step 6404). The system determines if the goods apply to an order in the system (Step 6406), and if not, the goods are delivered to the Finished Goods warehouse 4908 (Step 6408), see also the process of FIG. 53. If so, the worker selects the order to apply the container parts to (Step 6410) and the system associates the parts to the order (Step 6412) and prints and affixes a shipping container label (Step 6414). The worker then determines if there are any open pallets for the order (Step 6416), and if not, obtains a new pallet (Step 6418). The system prints two pallet barcodes (one for each side of the pallet) (Step 6420) and the process continues at Step 6422. If there is an open pallet for the order (Step 6416), the worker affixes labels and scans the pallet (Step 6422). Next, the worker scans the next container (Step 6424) and the system associates the container to the pallet (Step 6426). The worker then places the container on the pallet (Step 6428) and determines if the pallet is complete (Step 6430). If not, the worker performs Step 6424. If so, the worker wraps the pallet in plastic (Step 6432) and the pallet is delivered to the shipping warehouse (Step 6434), see also FIG. 53.

Referring next to FIG. 65, one embodiment is shown of the delivery process 4932 of FIG. 49. Initially, a delivery truck arrives (Step 6502) and the shipper creates a new delivery (Step 6504) and the system displays delivery ready jobs for a partner (Step 6506). The shipper then marks the delivery complete (Step 6510) and the system determines if all job containers are scanned (Step 6512). If not, a worker determines if remaining containers can be located (Step 6514). If so, the worker performs Step 6508. If not, the worker determines if it is OK to short ship (Step 6516). If not, the delivery is canceled (Step 6518). If OK to short ship (Step 6516), the process goes to Step 6520. If all job containers are scanned (Step 6512), the system prints a shipping manifest (Step 6520). Then the worker gives the shipping manifest to the driver (Step 6522) and the system posts and invoices the order in the ERP (Step 6524), scans an advance shipment notification (ASN) to the original design manufacturer (ODM) (Step 6526) and generates and prints customs documents (Step 6528). Next, the worker loads the goods onto the truck (Step 6530) and the goods are delivered to the ODM (Step 6532).

Again, it is understood that there are many variations of the detailed flows of FIGS. 50-65 and that these represent a specific example relating to the on demand decoration of notebook style computers, and that these one or more of these processes including some or all of their individual steps may apply to other parts and products to be customized.

Manufacturing Using Dynamic Flow Filtering

As long tail economics continue to drive increasing product variety systems for managing the manufacture and embellishment (e.g., customization) of diverse product models within a single production line are forcing changes in the way floor control and inventory management systems are designed. The following section describes several embodiments of a system and method that is well suited for the management of inventory and floor logistics for mass customization environments. In particular for environments which fabricate or embellish parts from a set of common raw goods (e.g., blank, undecorated parts) through a series of processes using a limited diversity of equipment which however are digitally controlled to perform customizations so that the parts coming out of the process are distinct (e.g., customized parts). In some forms, efficient mass customization and personalization uses such an environment and such an environment demand tightly coordinated factory logistics.

As an introduction, a production control system is a system which is responsible for determining what to produce, how much to produce, and when to produce. Production control systems can also coordinate the complex movement of material as it is matriculated through a production floor. Production control systems can be broadly classified into two categories: “push” and “pull”.

Push systems start with a production order typically based on some demand (e.g., forecast or sales order). The production order is then scheduled and material is pushed into the production line. As the material is processed, it is pushed to the next workstation until the production is complete and the finished goods are either placed into inventory or shipped to the customer. Most traditional ERP/MRP systems are push based. Push based systems are typically used where high levels of service are required (e.g., low lead times) and where there is a great variety in product models, however they can lead to over building, unnecessary activity and waste.

Pull systems, on the other hand, typically rely on finished goods inventory to satisfy immediate demand. Empty areas in inventory then serve as a signal of demand to manufacturing process. In this way, demand is communicated from finished goods inventory to the floor from end to beginning. For complex workflows a chain of demand signals may span many workstations. Examples of pull based production control systems include Kanban and CONWIP among others. Kanban is a term used for just-in-time (JIT) production and is a scheduling system that indicates what to produce, when to produce it, and how much to produce. Kanban systems have been implemented by Toyota Motor Corporation. CONWIP (CONstant Work In Process) systems are a variation of pull system that uses individual cards at workstations. Pull systems ensure parts aren't made until necessary and reduce work in progress (WIP) and waste, but they do so at the expense of the level of service. Product variety requires constant equipment setups and signal exchanges, as well as many deliveries of small lots of components. Pull, in its extreme form in order to achieve minimum WIP inventory, would also mandate that only one job be allowed at every stage. This however has a huge impact on service levels so the number of items in WIP at each station is typically considered as a tradeoff between throughput and WIP inventory.

Therefore while Kanban and Pull in general serve as a step toward JIT fulfillment, these methodologies are limited to stable processes and limited product variety. In any event, Push and Pull systems both have inherent advantages and disadvantages which make them more or less suitable for particular kinds of floor demands based on product variety, stability of process, stability of demand, and inventory risk.

For example, pull floor control may not be a suitable solution for mass customization environments for at least the following reasons: zero inventory, massive model variety and complex signaling.

Regarding zero inventory, pull systems are initiated by pulling parts from finished goods inventory which then serves as a signal to processes upstream that work needs to be done to refill inventory. As product variety increases, the so does the complexity of managing that inventory. Additionally, total inventory on a per model basis may need to be reduced to meet the niche demands of long tail product offerings. In one extreme case, thousands or millions of finished goods inventory locations with one part in each location. Even then, it is quite possible that even a single part is sitting in inventory. The logical conclusion of mass customization is the elimination of finished goods inventory.

Regarding massive model variety, pull systems assume a stable, repetitive production plan. Pull stipulates that the warehouse should deliver raw goods to the floor as they are needed. Thus, sharp changes in demand and rapid deployment of new products, particularly products with divergent work streams are not easily managed and Pull systems are less suited to industries where product volumes and mixes fluctuate. Additionally, product variety may lead to resource/station inefficiencies. For example, if a daily production schedule contains large product variety (thousands of distinct customizations or embellishments) but each product requires one of three finishing operations which are performed by a single finish station; controlling the order in which downstream parts are created and queuing parts into a batch can often be a more efficient use of resources and materials.

Regarding complex signaling, signaling complexity increases with product variety. In mass customization environments where product variety is counted in the millions (let alone true one-to-one personalization), traditional physical signals can't be used or are not practical because of the sheer volume of distinct physical signals necessary. Digital signaling systems can provide infinite variety, however signal interpretation (understanding which action to take based on the signal) is still an issue as operators need to understand how to interpret a variety of signals. Mass customization is made commercial by leveraging digital technologies to make several distinct parts at the same time using a single piece of equipment. So it is quite possible that thousands of distinct signals could be sent through the same work stream and to the same operator. Making sense of all this signaling is a challenge. Additionally if a distinct signal is used on the floor and model variety is high many costly digital tickets can be tied up.

One problem addressed by several embodiments is how can systems of mass customization which require very high service levels and large to infinite product variety be addressed. The following embodiments describe approaches that seeks to blend the push pull methodologies to reduce the inherent disadvantages of both. In some embodiments, these processes are referred to as Dynamic Filter Flow (DFF) and are variously described with reference to FIGS. 66-68.

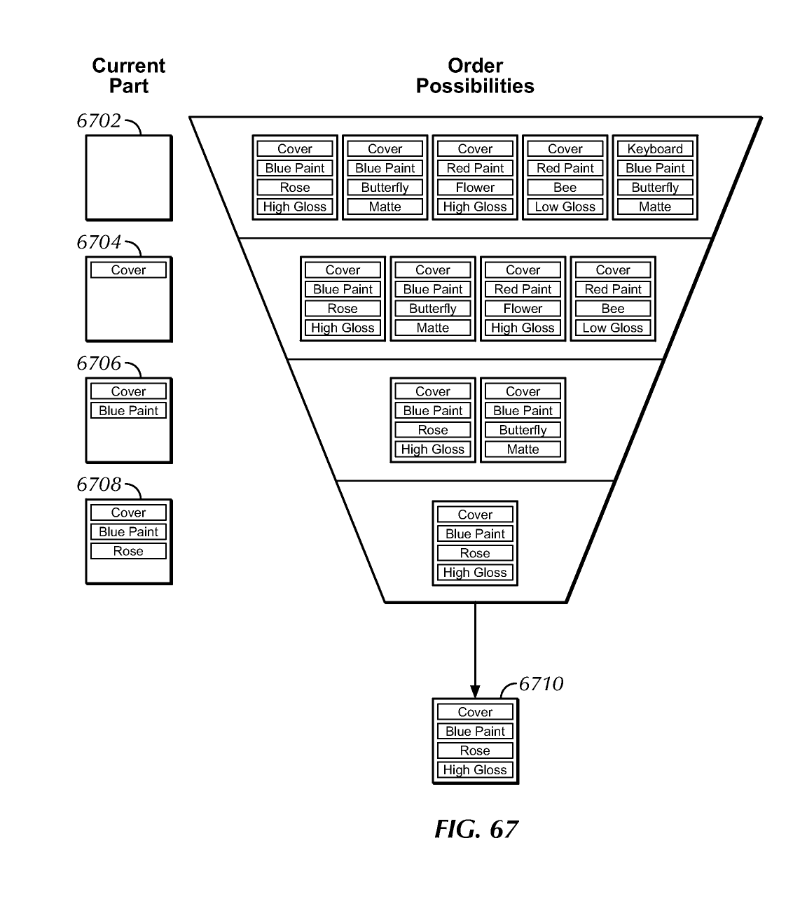

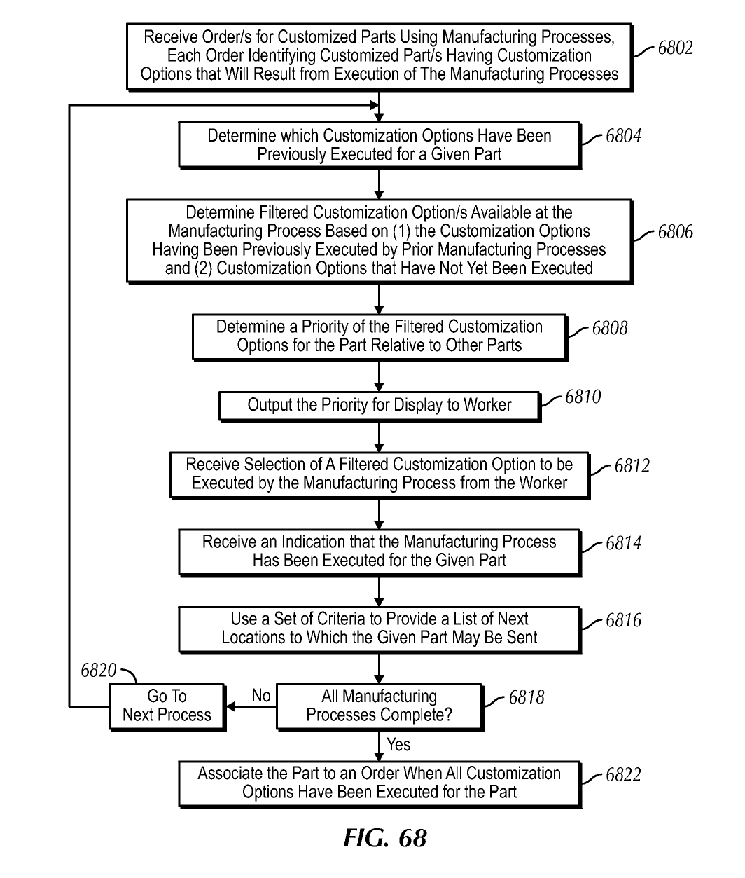

FIGS. 66 and 67 are diagrams illustrating methods of managing the manufacturing of customized products using dynamic flow filtering in accordance with some embodiments. FIG. 68 is a flowchart that illustrates one embodiment of the steps involved in managing the manufacturing of customized products using dynamic flow filtering such as that illustrated in FIGS. 66 and 67.

As discussed above, a Pushed based workflow is more suitable for mass customization. However, there still exist significant problems with traditional push methodologies which make mass customization difficult to perform economically. In some embodiments, finished goods inventory again, in particular, should be reduced or eliminated. This is contrary to traditional methods of in which large runs of units are produced and inventory is built up to gain operational efficiency. Therefore, in some embodiments, a new push based floor control and inventory system is provided which while push in nature is significantly different from the traditional push systems.

In accordance with some embodiments, a Dynamic Filter Flow (DFF) process starts with the acceptance of a demand signal. The demand signal can be forecast demand; however, due to the nature of long tail product offerings and mass customization, it is typically an order or series of orders. Production scheduling then performs an analysis of the demand and orders the production based on many factors, but at least including due date/priority and materials used. In one embodiment, a management system creates a production schedule as a stack ranked list of finished goods parts and quantities. In one embodiment, the stack ranking indicates the preferred order in which the parts are to be made. Once the schedule is committed, production operations are committed to produce the quantity of parts per the schedule but not necessarily in the order listed (described further below).

In accordance with several embodiments of a DFF process, individual parts are tracked during the manufacturing processes. When parts are released, before entering the production floor, the individual parts are marked with a tracking device, such as an optically readable code (e.g., 2D, 3D barcode), or other non-optically readable device (e.g., a radio frequency device such as an RFID tag or a near field communication (NFC) device). In some cases, the tracking device is a label with a barcode, etching a barcode directly onto the part, RFID, or other tracking system as appropriate for the manufacturing process. In this way, the part itself coupled with a digital system at the work station becomes the ticket or “kanban” to direct activities at each work station.

Marked parts are then moved from inventory to a work station that will be used to implement one or more manufacturing processes to affect one or more customization options. Rather than assign a predetermined finished good to the part as would be done with traditional push systems with job travelers, DFF presents all possible workstations and activities suitable for that part. Because no work has been done on the part, the initial list of possibilities is typically long. These possibilities are presented in a stack ranked list so that it is easy for an operator to select the highest priority action; however, based on minute to minute floor activities, operators can elect to perform lower priority activities should it be required or more efficient. Once an activity is completed it is recorded into the DFF database maintained by the management system. The part then becomes a new work in progress and the list of possible workstations and activities is then filtered down based on the new WIP status. A simple example of this filtering technique for a four step process is shown in FIG. 66.

Referring to FIG. 66, during each of build initiation 6602, RAW work in progress (WIP) 6604, Print WIP 6606, Finish WIP 6608, the system knows what customized or embellished parts are needed from the blank parts, shown as needed parts 6612 column. In this example, there has been an order identifying a number of 5 differently customized parts, each having a different combination of blank part (e.g., computer cover, keyboard), basecoat paint (e.g., red, blue), print design (e.g., rose, butterfly, flower, bee) and finish or topcoat (e.g., high gloss, matte)). It is noted that there may be any quantity of each of the 5 differently customized parts, which will be specified by the order/s received. Each of these variations may be referred to as customization options that are implemented through one or more manufacturing processes. During build initiation 6602 at the inventory station, there are no WIP parts, i.e., they are all un-customized. Based on the orders, a filtered view of the available customizations options at this stage are, according to the above example, either a cover or keyboard. The system may indicate a priority of which parts to select or prioritize first. In this case, whether it is the prioritized selection or the worker makes a different selection for other reasons, the worker selects a cover. Next, at the RAW WIP process 6604 at a basecoat paint station, the current WIP part is a cover and the filtered customization options needed to fulfill the order/s available are to paint red or blue. The system may indicate a priority of which colors should be painted or prioritized first. In this case, whether it is the prioritized selection or the worker makes a different selection for other reasons, the worker selects to paint the part/s blue. Next, at the Print WIP process 6606 at a print station, the current WIP part is a blue cover and the filtered customization options needed to fulfill the order/s available are to print a rose, butterfly, flower or bee. The system may indicate a priority of which design should be painted or prioritized first. In this case, whether it is the prioritized selection or the worker makes a different selection for other reasons, the worker selects to print the part/s with the rose. Next, at the Finish WIP process 6608 at a finish or topcoat station, the current WIP part is a blue cover with a rose and the filtered customization options needed to fulfill the order/s available are to add either a high gloss or matte finish. The system may indicate a priority of which finish to be applied or prioritized first. In this case, whether it is the prioritized selection or the worker makes a different selection for other reasons, the worker selects to apply a high gloss finish. Thus, resulting Finished Goods 6610 provides a blue cover with a rose and high gloss.

Through this example, it is clear that some embodiments of a DFF process exhibit a high level of flexibility in floor control. In other words, according to known systems, a given part is closely coupled to a given order when scheduling manufacturing processes from the first to the last process, i.e., this may be referred to as “build-to-order” process. In contrast, and according to some embodiments, a given part is decoupled to any particular order until near the completion of manufacturing, i.e., this may be referred to as “build-to-multiple-orders” process. Another view is that the customization possibilities for each part are multiple initially during manufacturing, and are reduced/filtered throughout the manufacturing processes until the part corresponds to a particular order at or near the end of the manufacturing processes. This is illustrated in the diagram of FIG. 67 which shows that for current part 6702 (un-customized), there are five possible orders that may be fulfilled by part 6702 depending on system and/or operator choice and production needs. For part 6704 (an un-customized cover), there are four possible orders that may be fulfilled by part 6704 depending on system and/or operator choice and production needs. For part 6706 (a blue cover), there are two possible orders that may be fulfilled by part 6706 depending on system and/or operator choice and production needs. And for part 6708 (a blue cover with a rose), there is now only one order that may be fulfilled by part 6708. This results in part 6710 which is then coupled to the order.

FIG. 66 also illustrates that once the scheduled quantity of finished parts or goods are produced per the production order, the finished good is removed from open demands and subsequent filtered views are likewise update to include only open demands.

It is understood that the filtering criteria in the simple example of FIG. 66 are not limited to those in FIG. 66, but can include nearly anything that is pertinent to the routing of WIP through the production floor. For example, if more than one paint line existed and each paint line was configured with a series of colors it was capable of spraying at any given time, the current capability could be used as a filtering criteria to determine which paint line(s) the part should be directed. Filtering options may also be a function of the part material or substrate and the machinery to effect the customization options. For example, if the part were plastic, glass, metal, fabric, etc., the filtering options will vary. By way of further example only, other filtering constraints could include: proximity to current location; change over time; machine specific quality characteristics; Takt time; Collation patterns; and Real-time Yield delta and the like.

Additionally, as mentioned above, in some embodiments, the management system may filter the customization or embellishment options and presents stacked priority list as a recommendation or constraint to the worker or equipment operator (or alternatively, robot or other computer controlled “worker”). Recommendations provide a series of options from which an operator, based on best judgment, or automated system, based on heuristics may select an action. Constraints present a single course of action which must be followed. Determining which criteria are used for filtering and how they are represented is a function of the process and is different for each process.

According to several embodiments, one or more consequences of one or more embodiments of a DFF system can include one or more of the following, by way of example only: highly flexible/loose floor logistics; suitable for high product variation/mixed model production; easy to add new work stations/work streams and new routings; may require part level tracking; and does not control intra-day tracking.

Referring next to FIG. 68, a flowchart is shown that illustrates one embodiment of the steps involved in managing the manufacturing of customized products using dynamic flow filtering such as that illustrated in FIGS. 66 and 67.

Initially, one or more orders are received for customized parts to be manufactured from blank parts through execution of a plurality of manufacturing processes (Step 6802). Each order identifies one or more customized parts each having a plurality of customization options to result from execution of one or more of the plurality of manufacturing processes. For example, an order is received for the five differently customized parts of FIGS. 66 and 67, which defines customization options (e.g., cover, keyboard, blue, red, rose, butterfly, flower, bee, high gloss, matte) to be implemented through several manufacturing processes (e.g., inventory selection, paint, print, finish). The order may be received in any of the ways described herein or otherwise. It is understood that the process applies to any order for any customized parts with any customization options and manufacturing processes, and are not limited to the specific examples provided herein.

For each manufacturing process, the following several steps are performed, e.g., Steps 6804, 6806, 6808, 6810, 6812, 6814, 6816, 6818, 6820, and 6822. In some embodiments, these steps are performed by a management system overseeing manufacturing such as any computer based and software controlled systems described herein or otherwise. In other embodiments, one or more of these steps may be performed by workers or managers working with such a management system.

Thus, for each manufacturing process, which of the customization options have been previously executed for a given part are determined (Step 6804). For example, at the print manufacturing process of FIGS. 66 and 67, the system determines that the following customization options have been performed: cover selection and blue paint.

Next, one or more filtered customization options available at the respective manufacturing process are determined for the given part based on the customization options having been previously executed by one or more prior manufacturing processes and based on customization options corresponding to the one or more orders that have not yet been executed (Step 6806). For example, at the print manufacturing process of FIGS. 66 and 67, the system determines that the following customization options are still needed to fulfill an order: printing a rose, butterfly, flower and bee.

Next, optionally, a priority of the one or more filtered customization options for execution by the respective manufacturing process for the part relative to other parts at the manufacturing process is determined (Step 6808). For example, at the print manufacturing process of FIGS. 66 and 67, the system determines that printing a rose should be prioritized over printing other designs. In different embodiments, the priority may be a strict priority to be adhered to, the priority may be a constraint, or the priority may be a recommended priority but the worker has the option of performing the action that best meets the production line conditions. Next, the priority is displayed to the worker or operator (Step 6810). This may be done by causing a local computer display at the station to display the priority.

Next, a selection of a filtered customization option to be executed by the respective manufacturing process is received from the worker (Step 6812). This may be the result of a displayed priority such as provided in Steps 6808 and 6810, or may be a worker determined option if a priority is not provided.

Next, an indication that the respective manufacturing process has been executed for the given part is received (Step 6814). For example, this occurs when the manufacturing process has been completed, e.g., the rose has been printed. The indication may be received through manual user enter or the user scanning the completed part when it leaves the particular manufacturing process area.

Next, a set of criteria is used to provide a list of next locations to which the given part may be sent (Step 6816). For example, if the part has left the print process, then the system can determine and direct that the part should be directed to a finish station for the designed topcoat or finish.

If all manufacturing processes are not complete (Step 6818), then go to the next manufacturing process (Step 6820) to implement additional customization options. In the example, a finish coat manufacturing process is still needed. For example, Steps 6804, 6806, 6808, 6810, 6812, 6814, 6816 and 6818 are performed at the next manufacturing process. If all manufacturing processes are complete (Step 6818), then the given part is associated to a corresponding order (Step 6822). For example, when part 6710 is complete, it is then coupled to the order by the system.

Re-Usable, Non-Optically Readable identification Devices During Manufacturing Process

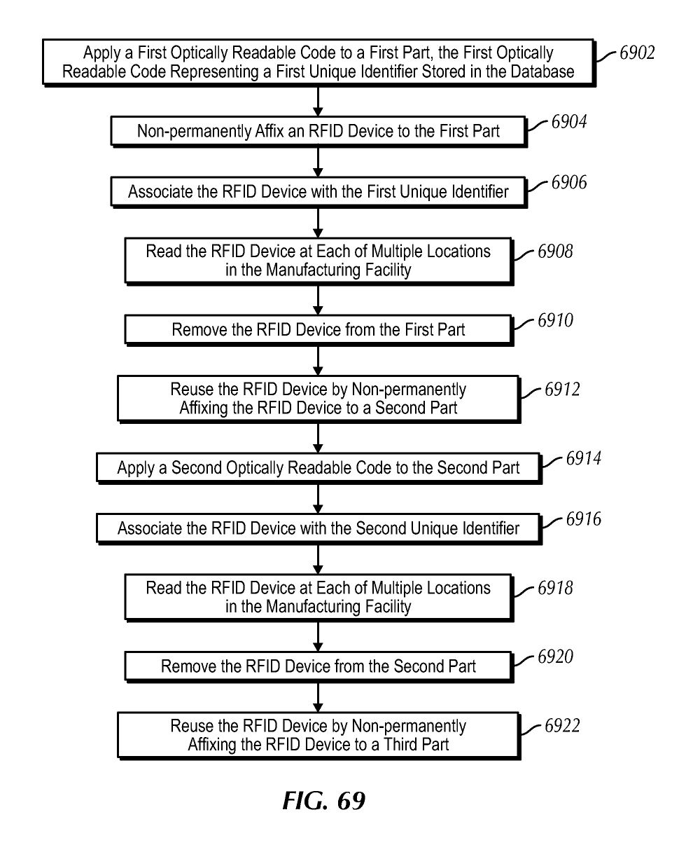

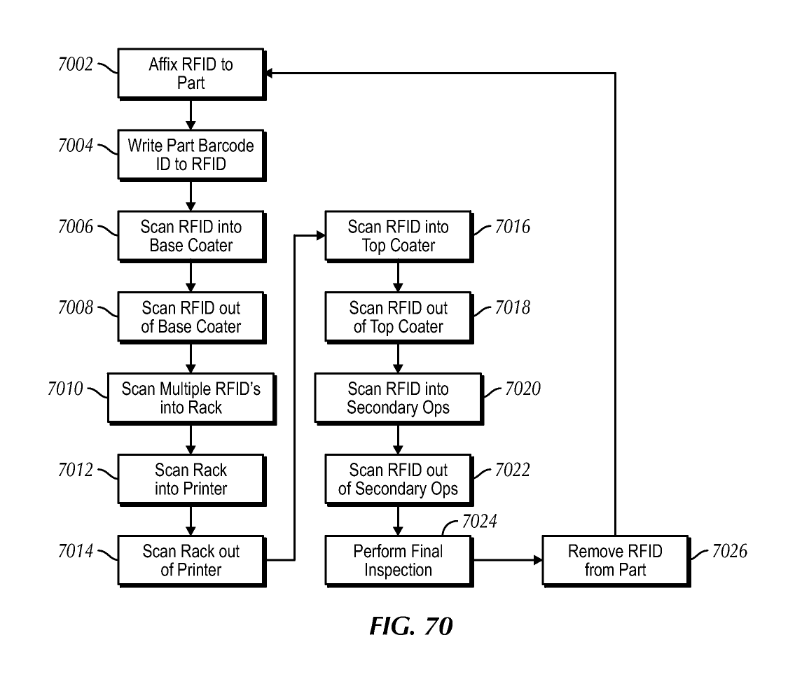

The following describes embodiments using part level tracking within a manufacturing facility or other portion of a manufacturing process where the tracking component is re-usable for additional parts in the manufacturing process. Referring next to FIGS. 69 and 70, embodiments are shown of methods of tracking parts within one or more manufacturing facilities, such as may be performed within the exemplary image application facility of FIG. 49 or any other system described herein or otherwise.

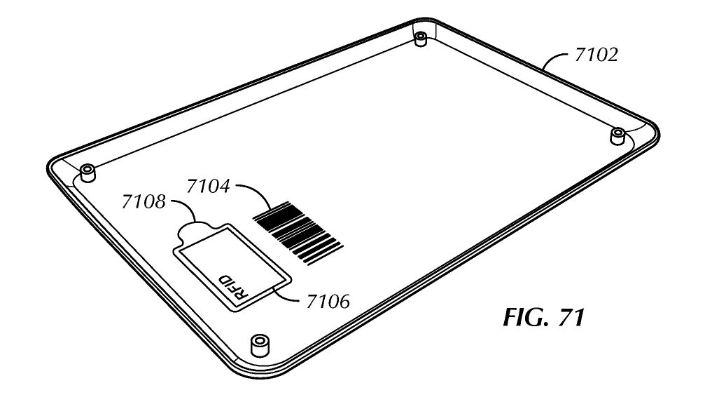

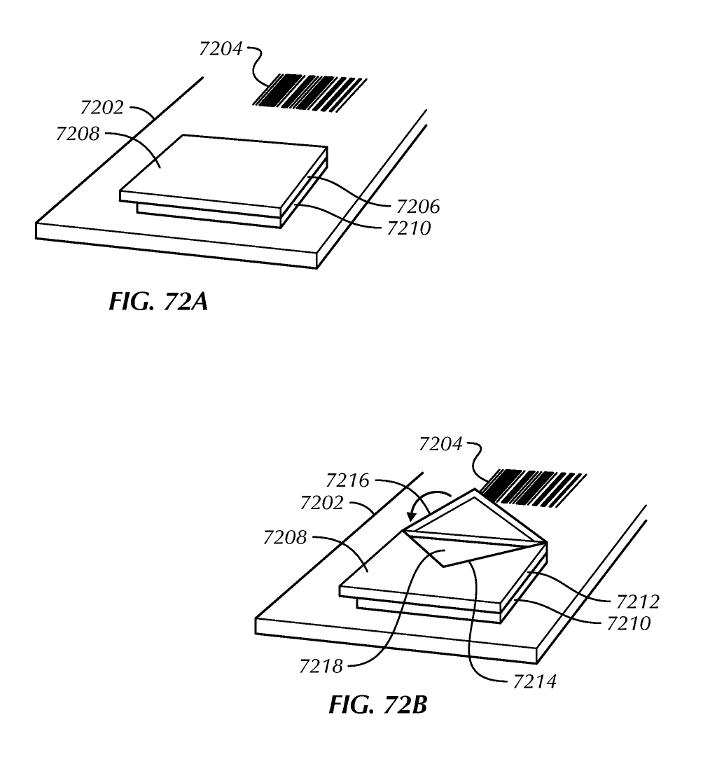

Referring first to FIG. 69, a first optically readable code is applied to a first part to be tracked through a plurality of manufacturing processes in a manufacturing facility, the first optically readable code representing a first unique identifier stored in a database (Step 6902). In some embodiments, the first optically readable code comprises a barcode, such as a 2D or 3D barcode. In some embodiments, the code is applied as an adhesive sticker or is laser etched (or otherwise etched or formed) on a surface of the first part. In some embodiments, the optically readable code is intended to remain on the part after manufacturing, e.g., to track and identify through distribution and/or retail and facilitate returns after delivery to customers. Thus, the optically readable code provides part traceability that may indicate who manufactured the part, when it was made, etc. Typically, the first optically readable code represents a serial number that corresponds to data relating to the manufacturer, product, etc. The serial number or identifier and the data may be managed in a database. FIGS. 71, 72A and 72B illustrate exemplary barcodes etched onto a surface of a part.

Next, a non-optically readable tracking device is non-permanently affixed to the first part (Step 6904). A non-optically readable tracking device does not require line of sight to read the data or identifier contained therein. For example, the non-optically readable tracking device may be a radio frequency identification (RFID) device such as a passive, semi-passive or active RFID tag or other near field communication (NFC) device. Such technologies are well understood in the art. In one embodiment, Step 6904 is implemented by non-permanently adhering the non-optically readable tracking device to the first part so that it may be later removed. In one embodiment, a spray non-permanent adhesive is used and in another embodiment, the optically readable tracking device includes a non-permanent adhesive layer. FIGS. 71 and 72A illustrate an RFID device adhered to the part. In another embodiment, Step 6904 is implemented by non-permanently adhering a disposable container to the first part, the disposable container containing the non-optically readable tracking device. FIG. 72B illustrates such a disposable container.

Next, the non-optically readable tracking device is associated with the first unique identifier (Step 6906). This step may be performed by the management system in that the system knows the first optically readable code and its unique identifier and the system can associate the identifier of the non-optically readable device to the first unique identifier. In another embodiment, the system writes the value of the first unique identifier to be stored in the non-optically readable tracking device. For example, it is known to write an identifier to RFID devices and/or other NFC devices, such that the device stores the identifier that is transmitted to reading devices to identify the RFID/NFC device.

Next, the non-optically readable tracking device (e.g., RFID device) is read at each of a plurality of locations in the manufacturing facility in order to track the first part as it progresses through the plurality of manufacturing processes (Step 6908). The specific reading technique will depend on the non-optically readable technology used. For example, with RFID devices (such as RFID tags), a reader transmits an interrogation signal that is received by the RFID tag, and reflected back to the reader with the data (identifier) modulated onto the reply signal. Depending on the frequencies and power levels used, different reading ranges may be implemented, e.g., near field and/or far field reading. In this way, the first part may be non-optically read (line of sight not required) at different processes. This may be helpful since the part may not be oriented in a way that is conducive to a line of sight reader. By using non-optically readable tracking devices, parts may be stored or oriented in any manner and still be read (assuming they are with range of the reader). Additionally, many non-optically reading tracking devices may be read with high accuracy, whereas many optically readable codes may be inaccurately read. In some embodiments, it is desired to use readers that can scan and read non-optically readable tracking devices (such as RFID tags and NFC devices) within a range of 12 inches to 7-10 feet. According to several embodiments herein, the plurality of locations of the manufacturing facility may include one or more of a base coat painting location, an image printing location, a top coat application location, an inventory location, an inspection location, and a work in progress location. It is noted that while FIG. 69 illustrates an RFID device, it is understood that one or more embodiments more generically use a non-optically readable tracking device such as an RFID device (e.g., including an RFID tag or other NFC device).

Next, once the manufacturing process is complete, the non-optically readable tracking device is removed from the first part (Step 6910). In embodiments using a non-permanent adhesive, the tracking device (or disposable container containing the tracking device) is simply peeled away from the part. FIGS. 71, 72A and 72B illustrated a tab to assist in removing the tracking device from the part.

Next, the non-optically readable tracking device is re-used by non-permanently affixing the non-optically readable tracking device to a second part to be tracked through the plurality of manufacturing processes in the manufacturing facility (Step 6912), such as described herein. A second optically readable code is applied (e.g., adhered, etched) to the second part, the second optically readable code representing a second unique identifier stored in the database (Step 6914). Then the non-optically readable tracking device is associated with the second unique identifier (Step 6916), such as described above. In one embodiment, the identifier previously written to the non-optically readable tracking device is re-written to include the second unique identifier. Then, the non-optically readable tracking device is read at each of the plurality of locations in the manufacturing facility in order to track the second part as it progresses through the plurality of manufacturing processes (Step 6918), such as described above. Once manufacturing is complete, the non-optically readable tracking device is removed from the second part (Step 6920) and is re-used by non-permanently affixing the non-optically readable tracking device to a third part to be tracked through the plurality of manufacturing processes in the manufacturing facility (Step 6922).

Accordingly, the optically readable remains on the parts after manufacturing for traceability. And advantageously, the non-optically readable tracking device is only used during the manufacturing process. Since several embodiments may require a great number of parts to be tracked with non-optically readable tracking devices, re-using such devices amortizes costs of such devices. As an example, RFID devices and NFC communications are used since they provide a high accuracy in readability and do not require line of sight. Their cost is spread over time since they can be repetitively used. Furthermore, in many embodiments, especially where the customized product or part may be part of an electronic device, it may be problematic that RFID devices remain on the part. Such devices radiate electromagnetic energy that may interfere with other RF components of the completed product. For example, it may be problematic to include an RFID device to track customized battery doors that will be assembled into customized mobile phones which also include RF devices.

Additionally, in embodiments using a non-permanent adhesive, high temperature manufacturing processes may result in degradation of the adhesive properties of the adhesive. In such embodiments, spray on adhesives or disposable containers (e.g., see FIG. 72B) may be useful and ensure continued re-usability of the non-optically readable tracking device.

It is noted that in some embodiments, the optically readable code is applied to the part (Step 6902) after the non-optically readable tracking device is non-permanently affixed to the part (Step 6904). For example, the first/second optically readable codes may be applied at or near the end of manufacturing, or even after the conclusion of manufacturing. In such embodiments, the non-optically readable tracking device is still associated with the first/second unique identifiers (which are maintained in a database or memory) so that they can be tracked throughout the manufacturing process. For example, with an RFID device, the stored unique identifier is written to the RFID device and then the unique identifier is implemented in the optically readable code at a later time. At the time the optically readable code is applied to the product, the optically readable code is configured to represent the unique identifier that was previously associated to the non-optically readable tracking device.

Referring next to FIG. 71, one embodiment is shown of a part having a barcode 7104 and a removably and non-permanently affixed RFID device 7106 in accordance with some embodiments, which may be generically and collectively referred to as a part assembly, the part assembly being tracked through a plurality of manufacturing processes in a manufacturing facility. The barcode 7104 is one embodiment of an optically readable code. The RFID device 7106 is one embodiment of a non-optically readable tracking device. In this case, the part comprises a notebook computer cover 7102 and the barcode 7104 and RFID device 7106 are applied to an under surface of the cover 7102. As can be seen, since barcode 7104 and the RFID device 7106 are on an under surface of the cover 7102, the barcode may be challenging to read during manufacturing whereas the RFID device 7106 is not limited by line of sight. The RFID device 7106 may be an RFID tag or other NFC device. To facilitate removal of the RFID device 7106 from the cover 7102 when manufacturing is complete, a tab 7108 is formed at or integral with the substrate of the RFID device. The user simply pulls the tab 7108 and removes the RFID device. The barcode may take the form of a sticker or may be more permanently affixed, for example, etched.

Referring next to FIG. 72A, one embodiment is shown of a mechanism to removably and non-permanently affix a non-optically readable tracking device 7206 to a generic part 7202. The part 7202 includes an optically readable code 7204 (e.g., an etched barcode or barcode sticker) and the non-optically readable tracking device 7206. Again, the non-optically readable tracking device 7206 may be an RFID device, such as an RFID tag or a NFC device. A non-permanent adhesive 7210 is included to non-permanently adhere the non-optically readable tracking device 7206 to the part 7202. The adhesive 7210 may be a spray adhesive applied to one or both of the part 7202 and the non-optically readable tracking device 7206. The adhesive 7210 may be an adhesive layer permanently affixed to the non-optically readable tracking device 7206 and with a non-permanent adhesive surface to adhere to the part 7202.

Referring next to FIG. 72B, another embodiment is shown of a mechanism to removably and non-permanently affix a non-optically readable tracking device 7218 to a generic part 7202 also having an optically readable code 7204. In this embodiment, a disposable container 7212 is non-permanently affixed to the part using the adhesive 7210. In the illustrated embodiment, the container 7212 functions as an envelope or sleeve to contain a non-optically readable tracking device 7218. For example, the container 7212 has an opening 7214 that allows the non-optically readable tracking device 7218 to be received and includes a flap 7216 to close over the opening 7214. In some instances the container 7212 may have a lid or other device that snaps, slides or otherwise engages the container. In yet other embodiments, the non-optically readable tracking device 7218 may snap, slide or otherwise engage the container 7212. The container 7108 also includes a tab 7108 to facilitate easy removal. The adhesive 7210 may be as described above. In this case, the envelope is discarded when the part leaves manufacturing and the non-optically readable tracking device 7218 is placed in another disposable container 7212 affixed to another part. This embodiment reduces problems that may occur with adhesives that degrade with repeated exposure to heat (or other processing) in the event manufacturing processes involve heat usage since the adhesive is discarded after manufacture.

Referring next to the flowchart of FIG. 70, an example manufacturing process is described as it may apply to one of more of the manufacturing processes described herein, e.g., such as might be implemented in the system of FIG. 49. This process is specific to RFID devices but also applies generally to non-optically readable tracking devices. First, an RFID device is affixed to a given part (Step 7002). Then, a part barcode ID is written to the RFID device (Step 7004). Then, the RFID device is scanned into the Base Coater (Step 7006). The part is then base coated. Then, the coated part is scanned out of the Base Coater (Step 7008). In one embodiment, by scanning the part, the RFID device is interrogated and read by a reader and the system stores the part's location and/or status. Next, multiple painted parts (multiple RFID devices) are scanned into a rack (Step 7010). In one embodiment, the Rack is a holding device that positions the parts in an orientation suitable for printing. The Rack is then scanned into the Printer (Step 7012). The Printer then prints the intended images to the painted parts. The rack of parts with RFID devices is then scanned out of the Printer (Step 7014). Next, the RFID devices are scanned into the Top Coater (Step 7016). The parts are appropriately topcoated. The RFID devices are then scanned out of the Top Coater (Step 7018). Next, the RFID devices are scanned into secondary operations (Step 7020). Any secondary operations or keyboard testing is performed. The RFID devices are then scanned out of the secondary operations (step 7022). Then, final inspections are performed (Step 7024) and the RFID device is removed from the part (Step 7026). Once removed, the RFID is reused on another part, i.e., Step 7002 is performed for a new part.

On Demand Customization Manufacturing Processes

The following description provides several embodiments of systems and methods that manage an on-demand manufacturing supply chain personalization process. The steps and functions performed as described may be performed in accordance with any of the variations and details discussed throughout this specification and may apply to many of examples not specifically described in this specification.

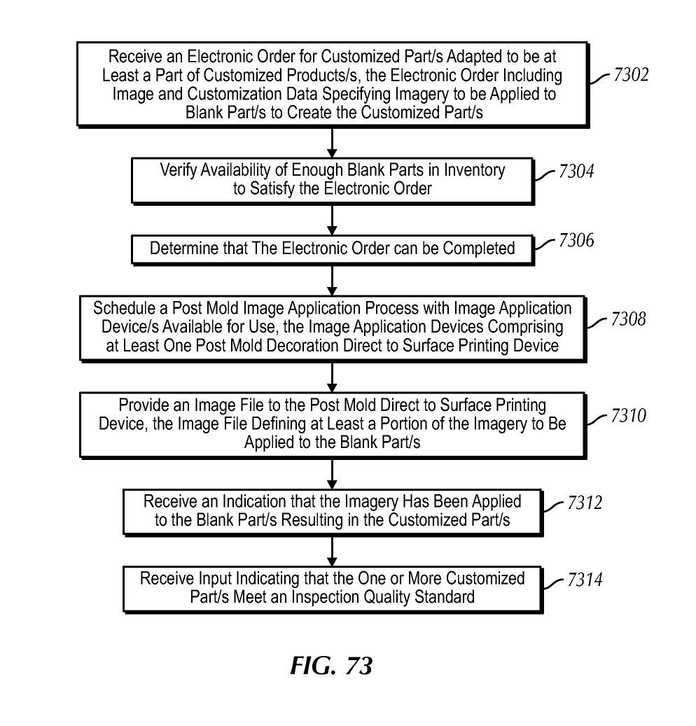

Referring next to FIG. 73, a flowchart is shown that illustrates the steps performed in managing an on-demand manufacturing supply chain personalization process in accordance with some embodiments.

Generally, the process of FIG. 73 may be performed by a computer system having one or more processors and one or more memory devices including executable program code configured to be executed by the one or more processors. When the code is executed the steps of the process may be executed. In some embodiments, the computer system functions as a management system such as those described herein. It is understood that the computer system may be implemented local to the manufacturing facility, remote of the manufacturing facility, or partially local and partially remote of the manufacturing facility, such as described herein.

Initially, an electronic order is received for one or more customized parts adapted to be at least a part of one or more customized products, the electronic order including image and customization data specifying imagery to be applied to one or more blank parts to create the one or more customized parts (Step 7302). In some cases, the order specifies the part, quantity of customized parts, and due date. The order may define a quantity of the customized parts/products, or may define quantities of multiple customized parts/products each having different image and customization data. Additionally, the customized parts ordered may be a customized part that will be assembled into a customized product (e.g., an “A cover” for a later assembled notebook style computer), or the customized part may be the customized product itself (e.g., a customized shell that would be separately sold to cooperate with a separately purchase phone, computer, etc.). Generally, the blank parts and customized parts/products may be any of the examples described herein or otherwise. It is not practical to provide examples of all types of parts for which embodiments of the process would apply, so Applicants have not attempted to do so.

In some embodiments, the image and customization data defines one or more of: color, text, text language, text region, text font, text size, a graphic image, a photographic image, image transparency, a pattern, artwork, an identification element, a coating, a surface treatment, surface texture, and a logo, such as any of those techniques described herein. Again, this is not meant to be an exhaustive listing of possible parameters defined by the image and customization data. In some embodiments, while the types of customization may greatly vary, the image and customization data minimally specifies one or more of the following: color, a graphic image, a photographic image, a pattern, artwork, and a coating. In another embodiment, the image and customization data minimally defines color, an image and a coating technique. In one embodiment, the image and customization data is defined by a configuration file. In some embodiments, the configuration file may be a PSD file, an AI file, an EPS file, a PDF file, a TIFF file, a WMF file, an SVG file, a markup language file or other known file print or paint file format. In some embodiments, the configuration file further includes or refers to an image file. In other embodiments, the image and customization data is defined by an image file comprising a plurality of layers.

Next, availability of enough blank parts in inventory to satisfy the electronic order is verified (Step 7304). This may be done, for example, by the management system, since it maintains database records of all parts in inventory. In some cases, the system maintains a min/max inventory of blank parts. Next, it is determined that the electronic order can be completed (Step 7306). Optionally, the order is accepted. The acceptance may be communicated back to the ordering entity, for example, through an EDI interface or other order interface.

Next, a post mold image application process is scheduled with one or more image application devices available for use, the image application devices comprising at least one post mold decoration direct to surface printing device (Step 7308). This may be done in accordance with any of the techniques described herein, such as a build-to-order technique, a build-to-multiple-order technique (see FIGS. 66-68). In one embodiment, a post mold image application process includes any process that applies an image or imagery to prefabricated or post production base material or substrate, such as post mold materials, post extruded materials, post cast materials, thus at least covers substrates or blank parts made of plastic, cloth, fabric, metallic, glass. The substrates of the blank parts may be opaque or at least partially light transmissive. Available image application devices may be selected from an array of image application devices, or there may be dedicated image application devices depending on the type of post mold image application process. Furthermore, a high speed, linear post mold application device may also be utilized in which parts are processed in a linear sequence (and conveyed between processing steps). Image application devices may be any devices as described herein or otherwise, at least including any painting devices, printing devices, coating devices, etching devices, described herein or otherwise, by way of example. Post mold decoration direct to surface printing devices may be any printing devices as described herein (e.g., inkjet printers, etc.) or otherwise known.

Next, an image file is provided to the at least one post mold direct to surface printing device, the image file defining at least a portion of the imagery to be applied to the one or more blank parts (Step 7310). In one embodiment, the image file is in a format that is compatible with or expected by the post mold direct to surface printing device. For example, the image file is a RIP (raster image processor) file that will be used by the raster image processor of the post mold direct to surface printing device. If the image file does not exist, the system converts at least a portion of the received image and customization data to the image file. It is noted that image and customization data, as well as the image file may be stored and managed by the management system at the manufacturing facility or at a location remote from the manufacturing facility, but accessible through a network connection (such as variously described herein, e.g., see FIGS. 6A, 6B and 6C).

At this point, imagery is applied to the parts. Optionally, the system monitors the image application process as the imagery is applied to the blank parts to provide the customized parts, e.g., device feedback, sensors and user input can assist in the monitoring in particular where more than one image application process is used. Next, an indication is received that the imagery has been applied to the one or more blank parts resulting in the one or more customized parts (Step 7312). In some embodiments, the system becomes aware of this through the devices communicating back to the system and/or by an operator who enters information into a computer or who scans the customized products at completion of the image application.

Once the blank parts are customized, at least some are inspected to ensure inspection standards are met. Next, input is received that indicates that the one or more customized parts meets an inspection quality standard (Step 7314).

Although not specifically listed in the process of FIG. 73, the order may be received in several ways, such as those described herein. In some embodiments, an electronic order is received through an EDI interface or other web or network interface. It is noted that in some embodiment, an order may be placed by telephone, facsimile or other manual method; however, in order to interface with the management of several embodiments, the order is then converted into an electronic format suitable or readable by the management system. In some embodiments, the management system provides a user interface that allows a customer to select and define the image and customization data. In some embodiments, the image and customization data may be designed or created by the orderer or may be selected from a database or library of preconfigured customization options including for example, licensed imagery, such as is variously described herein. In further embodiments, the system provides a user interface that allows a customer/user to virtualize the imagery to a representation of a customized part such as described herein. For example, this would allow the orderer to visualize the customized parts and/or products prior to confirming the order. Further details of these listed steps, additional and optional steps and variations thereof are possible such as those described throughout this specification.

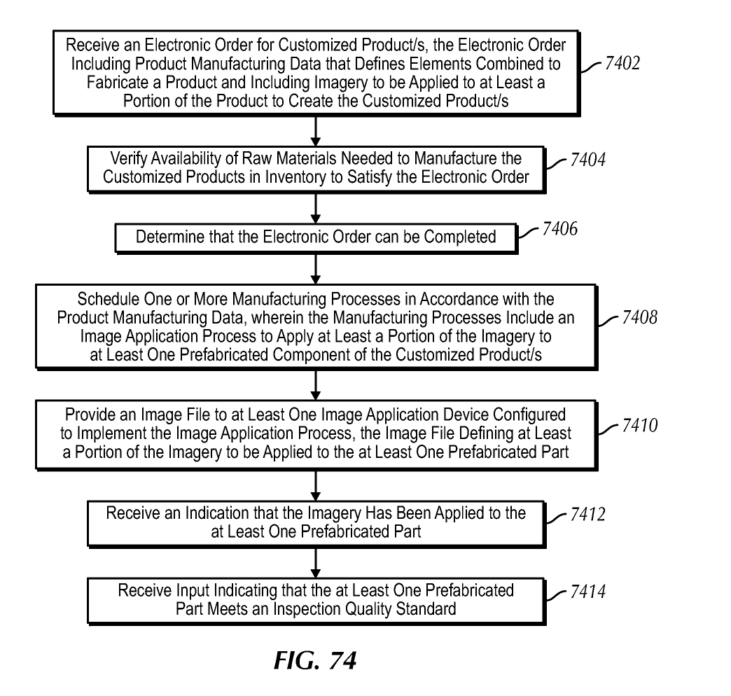

Referring next to FIG. 74 a flowchart is shown that illustrates the steps performed in managing an on-demand manufacturing supply chain personalization process in accordance with some embodiments.

Generally, the process of FIG. 74 may be performed by a computer system having one or more processors and one or more memory devices including executable program code configured to be executed by the one or more processors. When the code is executed the steps of the process may be executed. In some embodiments, the computer system functions as a management system such as those described herein. It is understood that the computer system may be implemented local to the manufacturing facility, remote of the manufacturing facility, or partially local and partially remote of the manufacturing facility, such as described herein.

Initially, an electronic order is received for one or more customized products, the electronic order including product manufacturing data that defines elements combined to fabricate a product and including to be applied to at least a portion of the product to create the one or more customized products (Step 7402). In some cases, the order specifies the part, quantity of customized parts, and due date. The order may define a quantity of the customized parts/products, or may define quantities of multiple customized parts/products each having different product manufacturing data. Additionally, the customized parts ordered may be a customized part that will be assembled into a customized product, or the customized part may be the customized product itself.

In general terms, the blank parts and customized may apply to parts/products that are manufactured according to widely varying components, materials and processes. For example, in some embodiments, product manufacturing data defines elements including, by way of example, materials, size, color, pre-treatment, imagery or embellishments to be applied to the product, post treatment, fabrication sequence, assembly instructions, assembly components, component attachment technique (e.g., gluing, stitching, fastening, etc.), order data information, product label data, attachment technique for product labels, packaging methods, and so on. Image data have any of the variables described herein, such as color, text, font, images, and so on. As such, embodiments of this process may apply to the custom manufacturing of apparel, footwear, luggage, denim, just to name a few possibilities. The product manufacturing data may also define a bundle or package of elements.

For example, in the case of footwear for example, the product manufacturing may define one or more of: size, width, panels, panel color, sole dimensions, sole material sole color, tread pattern, eyelet data, tongue data and imagery and/or other embellishments to be applied to one or more of the different portions of the footwear. It is contemplated that one or more elements of this product manufacturing data is not needed to be supplied by the orderer and may be a function of a given selected element, e.g., a tennis shoe selection may correspond to certain sole materials, widths, and manufacturing processes without requiring that the order specify such variables.

In another example, the customized part/product may include denim jeans, such that the product manufacturing data that defines elements such as denim material, denim weight, size, length, panel dimensions, style, fit (e.g., loose or tight), color, pre-treatments (softening, dying, antiquing, fraying, etc.), imagery or embellishments to be applied to the product (customized image applied to portions, custom stitching in a selectable pattern on a pocket or other panel), post treatment (dying, fraying, softening, sand blasting, etc.), zipper fly, button fly, button/snap characteristics, stitching color and weight, for example. The product manufacturing data may also define a bundle or package of elements, such as “antique” that may define a combination of color, softness and surface treatment. The product manufacturing data may also define certain fabrication sequences. e.g., how panels and labeling are attached, etc. Again, it is contemplated that one or more elements of this product manufacturing data is not needed to be supplied by the orderer and may be a function of a given selected element, e.g., a selection of a zipper fly corresponds to manufacturing processes specific to manufacturing denim jeans with a zipper as opposed to a button fly.

In yet another example, the customized part/product may include customized shirts, such that the product manufacturing data that defines elements such as fabric material, weight, size, length, neck style, panel dimensions, style, fit (e.g., slim, wide, long), color, pre-treatments (softening, dying, etc.), collar, sleeve length, chest pocket, imagery or embellishments to be applied to the product (customized image applied to portions, custom stitching in a selectable pattern on a pocket, sleeve or other portion), post treatment (dying, fraying, softening, etc.), stitching color and weight, for example. The product manufacturing data may also define a bundle or package of elements, such as “weathered” that may define a combination of color, softness and surface treatment. The product manufacturing data may also define certain fabrication sequences. e.g., how panels, pockets and labeling are attached, etc. Again, it is contemplated that one or more elements of this product manufacturing data is not needed to be supplied by the orderer and may be a function of a given selected element, e.g., a selection of a collar corresponds to manufacturing processes specific to manufacturing a shirt with a collar as opposed to a crew or V-neck.

Depending on the customized parts/products, the manufacturing products will vary. For example, with apparel, manufacturing processes may include cutting bulk material, dying or coloring bulk material, treatment devices that will result in a certain look, stitching or sewing equipment, gluing equipment, washing and heating equipment, etc. Depending on the parts/products to be customized, the blank parts may take many forms. For example, blank, un-customized parts may be apparel pre-cut and uncolored panels (or they may be pre-colored). According to the models described herein, in some embodiments, the blank parts are obtained from an ODM or the ODM's supplier and a min/max inventory is maintained. As with other embodiments described herein, a management system manages receipt of the order and manufacturing of the customized parts/products.

Generally, the blank parts and customized parts/products may be any of the examples described herein or otherwise. It is not practical to provide examples of all types of parts for which embodiments of the process would apply, so Applicants have not attempted to do so. It is noted that while these examples are further varied from the majority of the examples provided herein, any of the exemplary parts and products described herein may be manufactured using the process of FIG. 74.

It is noted that the manufacturing product data defined by the order defines imagery to be applied to at least a portion of the product. In some embodiments, the imagery defines one or more of: color, text, text language, text region, text font, text size, a graphic image, a photographic image, image transparency, a pattern, artwork, an identification element, a coating, a surface treatment, surface texture, and a logo, such as any of those techniques described herein. Again, this is not meant to be an exhaustive listing of possible parameters defined by the imagery. In some embodiments, while the types of customization may greatly vary, the imagery defined by the product manufacturing data minimally specifies one or more of the following: color, a graphic image, a photographic image, a pattern, artwork, and a coating. In another embodiment, the imagery minimally defines color, an image and a coating technique. In one embodiment, the imagery and customization data is defined by a configuration file. In some embodiments, the configuration file may be a PSD file, an AI file, an EPS file, a PDF file, a TIFF file, a WMF file, an SVG file, a markup language file or other known file print, paint file, image transfer format. In some embodiments, the configuration file further includes or refers to an image file. In other embodiments, the imagery is defined by an image file comprising a plurality of layers.

Next, availability of raw materials needed to manufacture the one or more customized products in inventory to satisfy the electronic order is verified (Step 7404). This may be done, for example, by the management system, since it maintains database records of all parts in inventory. In some cases, the system maintains a min/max inventory of raw materials (e.g., blank parts or components). Next, it is determined that the electronic order can be completed (Step 7406). Optionally, the order is accepted. The acceptance may be communicated back to the ordering entity, for example, through an EDI interface or other order interface.

Next, one or more manufacturing processes are scheduled in accordance with the product manufacturing data, wherein one or more manufacturing processes includes an image application process configured to apply at least a portion of the imagery to at least one prefabricated component of the customized product (Step 7408). This may be done in accordance with any of the techniques described herein, such as a build-to-order technique, a build-to-multiple-order technique (see FIGS. 66-68). Manufacturing processes will be varied and depend on the processes needed to manufacture the particular customized product. An image application process can include one or more of any post mold/post extruded, post cast direct to substrate printing process, painting process, print to glass process, etching process, printing/transferring process to apparel/cloth/substrate (e.g., dye sublimation via a transfer media, pad printing or silk screening), coating process, such as those described herein for otherwise known, for example. Additional image application processes may be implemented using stitching processes, jewel/bead adding processes, by way of example.

Next, an image file is provided to at least one image application device configured to implement the image application process, the image file defining at least a portion of the imagery to be applied to the at least one prefabricated part (Step 7410). In one embodiment, the image file is in a format that is compatible with or expected by the image application devices discussed above, e.g., in one embodiment, the image file is a RIP (raster image processor) file that will be used by the raster image processor of the post mold direct to surface printing device. If the image file does not exist, the system converts at least a portion of the imagery defined by the product manufacturing data to the image file. It is noted that imagery, the product manufacturing data, as well as the image file may be stored and managed by the management system at the manufacturing facility or at a location remote from the manufacturing facility, but accessible through a network connection (such as variously described herein, e.g., see FIGS. 6A, 6B and 6C).

At this point, imagery is applied to the prefabricated part/s. Optionally, the system monitors the image application process as the imagery is applied to the prefabricated parts to provide the customized parts, e.g., device feedback, sensors and user input can assist in the monitoring in particular where more than one image application process is used.

Next, an indication is received that the imagery has been applied to the at least one prefabricated part (Step 7412). In some embodiments, the system becomes aware of this through the devices communicating back to the system and/or by an operator who enters information into a computer or who scans the customized products at completion of the image application.

Once the prefabricated parts are customized, at least some are inspected to ensure inspection standards are met. Next, input is received that indicates that the one or more prefabricated parts having been customized meets an inspection quality standard (Step 7414).

Although not specifically listed in the process of FIG. 74, the order may be received in several ways, such as those described herein. In some embodiments, an electronic order is received through an EDI interface or other web or network interface. It is noted that in some embodiment, an order may be placed by telephone, facsimile or other manual method; however, in order to interface with the management of several embodiments, the order is then converted into an electronic format suitable or readable by the management system. In some embodiments, the management system provides a user interface that allows a customer to select and define the product manufacturing data. In some embodiments, the product manufacturing data may be designed or created by the orderer or may be selected from a database or library of preconfigured customization options including for example, licensed imagery, such as is variously described herein. In further embodiments, the system provides a user interface that allows a customer/user to virtualize the imagery to a representation of a customized part or product such as described herein. For example, this would allow the orderer to visualize the customized parts and/or products prior to confirming the order. Further details of these listed steps, additional and optional steps and variations thereof are possible such as those described throughout this specification.

It is noted that several embodiments are described herein. In one embodiment, a customized keyboard for a computer device comprises: a key receiving structure; a plurality of keys coupled to the key receiving structure, each key having at least one key label corresponding to at least one function of the key; and an image superimposed on and spanning at least a portion of two or more of the plurality of keys. In one variation, the image comprises one or more of stylistic text, a logo, artwork, a photograph, and a pattern. In another variation, the image is configured such that each of the two or more of the plurality of keys has a unique appearance. In another variation, the image comprises image portions on at least two adjacent keys, wherein the image portions are configured to cooperate with each other to form the image or a portion of the image.

In another embodiment, a customized computer device comprises: a keyboard comprising a plurality of keys, each key having at least one key label corresponding to at least one function of the key; a tray cover portion peripherally surrounding at least a portion of the plurality of keys; and an image superimposed on and spanning at least a portion of at least one of the plurality of keys and at least a portion of the tray cover portion. In one variation, the image comprises one or more of stylistic text, a logo, artwork, a photograph, and a pattern. In another variation, the image comprises image portions on at least one key and on at least a portion of the tray cover portion, wherein the image portions are configured to cooperate with each other to form the image or a portion of the image. In another variation, the tray cover portion is substantially in a plane defined by the keyboard. In one embodiment, the tray cover portion comprises a c-cover of a notebook style computer. In a further embodiment, the tray cover portion is rigid and an integral portion of the computer device.

In another embodiment, a method for use during manufacturing comprises: applying a first optically readable code to a first part to be tracked through a plurality of manufacturing processes in a manufacturing facility, the first optically readable code representing a first unique identifier stored in a database; non-permanently affixing a non-optically readable tracking device to the first part; associating the non-optically readable tracking device with the first unique identifier; reading the non-optically readable tracking device at each of a plurality of locations in the manufacturing facility in order to track the first part as it progresses through the plurality of manufacturing processes; removing the non-optically readable tracking device from the first part; and reusing the non-optically readable tracking device by non-permanently affixing the non-optically readable tracking device to a second part to be tracked through the plurality of manufacturing processes in the manufacturing facility. In one embodiment, the method further comprises: applying a second optically readable code to the second part, the second optically readable code representing a second unique identifier stored in the database; associating the non-optically readable tracking device with the second unique identifier; reading the non-optically readable tracking device at each of the plurality of locations in the manufacturing facility in order to track the second part as it progresses through the plurality of manufacturing processes. In another embodiment, the method further comprises removing the non-optically readable tracking device from the second part; and reusing the non-optically readable tracking device by non-permanently affixing the non-optically readable tracking device to a third part to be tracked through the plurality of manufacturing processes in the manufacturing facility. In one variation, the first optically readable code comprises a barcode. In another variation, the non-permanently affixing step comprises non-permanently adhering the non-optically readable tracking device to the first part so that it may be removed. In a further variation, the non-permanently affixing step comprises non-permanently adhering a disposable container to the first part, the disposable container containing the non-optically readable tracking device. In another variation, the plurality of locations includes one or more of a base coat painting location, an image printing location, a top coat application location, an inventory location, an inspection location, and a work in progress location. In another variation, the non-optically readable tracking device comprises a radio frequency identification (RFID) device. In another variation, the RFID device comprises a near field communication device. In another variation, the RFID device comprises an RFID tag.

In another embodiment, a part assembly to be tracked through a plurality of manufacturing processes in a manufacturing facility, the part assembly comprising: a part to which the plurality of manufacturing processes will be performed; an optically readable code affixed to a portion of the part, the optically readable code representing a unique identifier stored in a database; and a non-optically readable tracking device non-permanently affixed to another portion of the part, wherein the unique identifier is written to the non-optically readable tracking device such that when non-optically read, the non-optically readable tracking device provides the unique identifier, wherein the non-optically readable tracking device is configured to be removal from the part when the plurality of manufacturing processes are completed. In one embodiment, the non-optically readable tracking device comprises a radio frequency identification (RFID) device.

In another embodiment, a system and corresponding automated method for managing manufacturing of customized products are provided, the system comprising: a computer system having one or more processors and one or more memory devices including executable program code configured to be executed by the one or more processors, wherein upon execution by the one or more processors, the executable program code being configured to: receive one or more orders for customized parts to be manufactured from blank parts through execution of a plurality of manufacturing processes, wherein each order identifies one or more customized parts each having a plurality of customization options to result from execution of one or more of the plurality of manufacturing processes; and for each respective manufacturing process, the executable program code is configured to: determine which of the customization options have been previously executed for a given part; determine one or more filtered customization options available at the respective manufacturing process for the given part based on the customization options having been previously executed by one or more prior manufacturing processes and based on customization options corresponding to the one or more orders that have not yet been executed; receive a selection of a filtered customization option to be executed by the respective manufacturing process from the worker; receive an indication that the respective manufacturing process has been executed for the given part; and use a set of criteria to provide a list of next locations to which the given part may be sent. In one embodiment, the plurality of customization options at least define imagery to be applied to the blank parts to create the customized parts. In another embodiment, the system can additionally determine a priority of the one or more filtered customization options for execution by the respective manufacturing process for the part relative to other parts at the manufacturing process; and output the priority for display to a worker. In another embodiment, the system further can associate the given part to a corresponding order when all customization options specified by the corresponding order have been executed for the given part.

In another embodiment, a system and corresponding automated method for managing an on-demand manufacturing supply chain personalization process are provided, and system comprising: a computer system having one or more processors and one or more memory devices including executable program code configured to be executed by the one or more processors, wherein upon execution by the one or more processors, the executable program code being configured to: receive an electronic order for one or more customized products, the electronic order including product manufacturing data that defines elements combined to fabricate a product and including imagery to be applied to at least a portion of the product to create the one or more customized products; verify availability of raw materials needed to manufacture the one or more customized products in inventory to satisfy the electronic order; determine that the electronic order can be completed; schedule one or more manufacturing processes in accordance with the product manufacturing data, wherein one or more manufacturing processes includes an image application process configured to apply at least a portion of the imagery to at least one prefabricated component of the customized product; provide an image file to at least one image application device configured to implement the image application process, the image file defining at least a portion of the imagery to be applied to the at least one prefabricated part; receive an indication that the imagery has been applied to the at least one prefabricated part; and receive input indicating that the at least one prefabricated part meets an inspection quality standard.

In one embodiment, the executable program code is further configured to perform the following step when executed: provide a user interface to allow a customer to select and define at least a portion of the product manufacturing data. In another embodiment, the imagery comprises one or more of: color, text, text language, text region, text font, text size, a graphic image, a photographic image, image transparency, a pattern, artwork, an identification element, a coating, a surface treatment, surface texture, and a logo. In another embodiment, the customized products comprises one or more of an electronic device, a computer and a keyboards. In another embodiment, the customized products comprise one or more of an apparel product, footwear, luggage.

While various embodiments have been described above, it should be understood that they have been presented by way of example only, and not of limitation. Likewise, the various diagrams may depict an example architectural or other configuration for an embodiment, which is done to aid in understanding the features and functionality that can be included in the embodiments. The invention is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described, but instead can be applied, alone or in some combination, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

What is claimed is:

1. A system for managing an on-demand manufacturing supply chain personalization process comprising:
a computer system having one or more processors and one or more memory devices including executable program code configured to be executed by the one or more processors, wherein upon execution by the one or more processors, the executable program code being configured to:
receive an electronic order for one or more customized parts configured to be at least a part of one or more customized products, the electronic order including image and customization data specifying imagery to be applied to one or more blank parts to create the one or more customized parts;
verify availability of enough blank parts in inventory to satisfy the electronic order;
determine that the electronic order can be completed;
schedule a post mold image application process with one or more image application devices available for use, the image application devices comprising at least one post mold decoration direct to surface printing device;
provide an image file to the at least one post mold direct to surface printing device, the image file defining at least a portion of the imagery to be applied to the one or more blank parts;
receive an indication that the imagery has been applied to the one or more blank parts resulting in the one or more customized parts; and
receive input indicating that the one or more customized parts meet an inspection quality standard.

2. The system of claim 1 wherein the executable program code is further configured to perform the following step when executed:
provide a user interface to allow a customer to select and define the image and customization data.

3. The system of claim 1 wherein the executable program code is further configured to perform the following step when executed:
provide a user interface to allow a customer to virtualize the imagery to a representation of a customized part.

4. The system of claim 1, wherein the order specifies the part, quantity of customized parts, and due date.

5. The system of claim 1, wherein the image and customization data defines one or more of: color, text, text language, text region, text font, text size, a graphic image, a photographic image, image transparency, a pattern, artwork, an identification element, a coating, a surface treatment, surface texture, and a logo.

6. The system of claim 1 wherein the image and customization data is defined by a configuration file.

7. The system of claim 6 wherein the configuration file comprises a PSD file, an AI file, an EPS file, a PDF file, a TIFF file, a WMF file, an SVG file, a markup language file. (what file formats for paint files)

8. The system of claim 7 wherein the configuration file further includes or refers to an image file.

9. The system of claim 1 wherein the image and customization data is defined by an image file comprising a plurality of layers.

10. The system of claim 1 wherein the executable program code is further configured to perform the following step when executed:
convert at least a portion of the received image and customization data to a file for use by a raster image processor.

11. The system of claim 1 wherein the customized parts comprise keyboards for computers.

12. The system of claim 1 wherein the customized parts comprises covers for notebook and netbook computers, desktop computers, tablets, handheld computers, and personal data assistants.

13. The system of claim 1, wherein the executable computer code is further configured to:
store unique identifiers in a database, the unique identifiers corresponding to optically readable codes applied to the blank parts;
associate, in the database, the unique identifiers to corresponding non-optically readable tracking devices also applied to the blanks parts; and
receive data corresponding to a non-optical reading of the non-optically readable tracking devices to determine location of the blank parts and take next actions based on the non-optical reading.

14. The system of claim 1, wherein the electronic order is completed through execution of a plurality of manufacturing processes, and the electronic order identifies the one or more customized parts each having a plurality of customization options to result from execution of one or more of the plurality of manufacturing processes,
wherein the executable computer code is further configured, for each manufacturing process to be performed on the blank parts, to:
determine one or more filtered customization options available at the respective manufacturing process for a given part based on the customization options having been previously executed by one or more prior manufacturing processes and based on the customization options corresponding to the electronic order that have not yet been executed.

15. An automated method for managing an on-demand manufacturing supply chain personalization process implemented using at least one processor and at least one memory stored executable program code, the automated method comprising:
receiving an electronic order for one or more customized parts configured to be at least a part of one or more customized products, the electronic order including image and customization data specifying imagery to be applied to one or more blank parts to create the one or more customized parts;
verifying availability of enough blank parts in inventory to satisfy the electronic order;
determining that the electronic order can be completed;
scheduling a post mold image application process with one or more image application devices available for use, the image application devices comprising at least one post mold decoration direct to surface printing device;
providing an image file to the at least one post mold direct to surface printing device, the image file defining at least a portion of the imagery to be applied to the one or more blank parts;
receiving an indication that the imagery has been applied to the one or more blank parts resulting in the one or more customized parts; and
receiving input indicating that the one or more customized parts meet an inspection quality standard.

16. A method of manufacturing products comprising:
receiving, at an original design manufacturer (ODM), an electronic order from an original equipment manufacturer (OEM) for one or more customized products forecast to have commercial demand, the customized products having imagery applied thereto to create a custom appearance of the customized products, wherein the ODM assembles the customized products for the OEM;
receiving, at an on demand customizer (ODC), the electronic order;
maintaining at the ODC an inventory of blank parts received by direction of the ODM;
applying the imagery to one or more blank parts using a post mold image application process to create one or more customized parts, the one or more customized parts configured to be at least a part of the one or more customized products;
delivering the one or more customized parts to the ODM;
assembling, by the ODM, the one or more customized products from the one or more customized parts; and
delivering the one or more customized products to fulfill the electronic order.
